(19) United States
(12) Patent Application Publication
(10) Pub. No.: US 2017/0263141 A1
(43) Pub. Date: Sep. 14, 2017

(54) CHEATING AND FRAUD PREVENTION METHOD AND SYSTEM

(71) Applicant: Arnold Possick, Lakewood, NJ (US)

(72) Inventor: Arnold Possick, Lakewood, NJ (US)

(21) Appl. No.: 15/064,725

(22) Filed: Mar. 9, 2016

(51) Int. Cl. G09B 7/00; G06K 9/00; G09B 5/00

(52) U.S. Cl. CPC G09B 7/00; G09B 5/00; G06K 9/00087

(57) ABSTRACT

A system and method for cheating and fraud prevention is provided for use in academia, government, not-for-profit organizations, and private industry. Various technology platforms are utilized to promote compliance resulting in a fairer application of institutional rules and as a result, greater institutional integrity. A list of user inputted punishments is compiled associated with user-defined severity rating to each of the punishments, along with a user-defined frequency rating to each of the punishments, that are the basis for a matrix based look up table. By comparing data by addressing the institutional challenges of impartially codifying and meting out punishments for cheating or other infractions by not only establishing definitions of offenses and punishments, but also noting the frequency of actual events, a previously subjective system is codified. By creating a record of when the objective offense-punishment correlation is not followed per the matrix, deviations are rendered uniformly transparent.

### FIELD OF THE INVENTION

The present invention in general relates to a system and method for cheating and fraud prevention; and in particular to an automated system and method for affirmation, verification, and adjudication to promote compliance and prevent cheating, fraudulent activity, and dishonest conduct in various institutional settings including academia, government, not-for-profit organizations, and private industry.

### BACKGROUND OF THE INVENTION

Cheating in various segments of society including education is increasing at an alarming rate, and threatening the integrity of granted degrees, lowering the level of professional competence of graduates from academic institutions, and causing harm to the reputations of the academic institutions themselves. While about 20 percent of college students admitted to cheating in high school during the 1940's, today between 75 and 98 percent of college students surveyed each year report having cheated in high school. In the past, it was the struggling student who was more likely to cheat just to get by; however today cheating students also include high achieving college-bound students seeking an unfair advantage in an academic world perceived to be ever more competitive. Furthermore, there has been an increase in cheating, through generational succession due to increasingly not knowing what constitutes cheating. Current research shows that students increasingly believe it is acceptable to cheat, which partially stems from the general feeling that everyone is cheating and the need to keep pace with their peers, as well as increased competition for admission into universities and graduate schools. The larger societal implications are that students who succeed through dishonesty are likely to perpectual such behavior in their professional lives, leading to a generally increasing level of corruption, scandal and distrust of institutions.

Students are not the only parties to cheating and fraudulent activity in academic institutions. Teachers and instructors have been shown to encourage or allow cheating in their classrooms for personal advancement. In fact, teachers themselves have been involved in cheating and fraud. Examples of fraudulent activity by teachers include: grade inflation, where teachers inflate the student's grade to raise the class average and improve the teachers image, student feedback, and job review; changing a student's answer; encouraging low performance students to be absent on the day of the test; giving students answers; practicing items from the test itself beforehand; reading questions to students during test; rephrasing a question during the test; answering questions from the test; changing a student's answer; giving students grades without the student taking a test; nodding yes or no as the teacher checks a student's answer; providing hints on correct answers; excluding scores from low performing students; falsely raising student's grades; grading students in phony classes; giving students extra time; and giving students special accommodations including special education placement. Faculty and institutional complicity in cheating comes from the onerous proceedings associated with disciplining a student accused of cheating and the possibility that both the faculty member and the institution fear liability exposure from being such an allegation, as well as the burden such proceedings place on their resources.

Cheating and fraudulent activity also occurs in corporations and businesses, trade and professional organizations, and in government. Furthermore, governments administer licensing exams illustratively including for lawyers, stock brokers, contractors, inspectors, and medical personnel. Trade and professional organizations have education programs ranging from apprentice programs to production and inventory management certification. All of these licensing and certification exams are susceptible to cheating and fraudulent activity for many of the same reasons as they occur in academics: difficult subject matter, high personal stakes, and a perception that proctors have neither that the ability nor desire to detect and prosecute cheaters.

The ability of students to cheat has increased as well. Information systems can make cheating easier than ever before. For example, students can download term papers from the world-wide-web, or share information via social networking. Portable communication and texting devices, recording devices, cameras, and miniaturized computing devices allow students to bring information with them or share information during exams. Furthermore, there are numerous companies with websites offering cheating services that has become an industry on to itself. The services range from taking an exam to taking a complete course, from writing an application essay to writing a doctoral dissertation. There is even a website that reviews and ranks cheating providers, so the student does not even have to research cheating providers.

In addition, while it is known that face-to-face contact with teachers in small project oriented classes can reduce cheating, because of simple economics and consumer demand, education is moving in the opposite direction toward impersonal mass courses and on-line instruction, with no teacher contact and little, if any, project work. Online schools are growing and online class enrollment is increasing 10% per year in campus based schools. Large classes and online classes make student verification and monitoring difficult.

Government related efforts to legislate with regards to cheating and fraud prevention in academia include the Family Educational Rights and Privacy Act (FERPA) which specifies what student information can be released and to whom it can be released, and the Higher Education Opportunity Act—2008, which is an act that renews the Higher Education Act of 1968. This act also includes a provision requiring online colleges to have a method of ascertaining that the student taking the tests is the student that enrolled. However, this provision has been largely ignored and furthermore, there has not been a viable technological solution for doing so, as the technology of remote teaching has outpaced legal developments.

Typically, the institutional response to cheating and academic fraud is weak as most institutions are using obsolete cheating prevention methods. In most cases, cheaters are simply not identified, and if caught, the cheaters are seldom punished severely, if at all, which results in a lack of accountability. Furthermore, after a random review of many institutions' disciplinary systems it became apparent that the vast majority had no definition of what constitutes cheating and no designated punishment given for any specific cheating case. In fact, the majority of institutions lack a list of punishments for specific adjudicated acts of cheating. Even the once vaunted Cadet Code of Honor of the West Point Military Academy has been discredited as allowing for widespread cheating scandals.

The cost to society as a whole is immense as students who cheat go on to staff corporations and government and once there perpetuate behaviors that are at best dishonest and can extend to illegal and corrupt. Society bears the costs of such behavior in terms of both financial costs and a lack of trust in the integrity of various institutions.

Thus, there exists a need for a system and method that promotes compliance with rules and regulations and prevents cheating, fraudulent activity, and dishonest conduct in academia, government, and public and private industry.

### SUMMARY OF THE INVENTION

A non-transitory computer-readable medium for the prevention of cheating and fraudulent activity in an institutional setting is provided that has instructions stored thereon, that when executed on a processor compiles a stored list of user inputted cheating definitions via a graphical user interface. A user-defined severity rating is associated with each of the cheating definitions. A frequency of occurrence is assigned to the cheating definitions along with compiling a stored list of user inputted punishments for the institution. A user-defined severity rating is also assigned to each of the punishments along with a user-defined frequency rating to each of the punishments. A matrix based look up table is created to objectively correlate a cheating event or infraction per the definitions with a punishment. When receiving a report of a cheating infraction the non-transitory computer-readable medium generates a notification of the infraction and sends the notification to a subscribing official. Upon receiving a recommended punishment assigned by the subscribing official in response to the notification, the non-transitory computer-readable medium compares the recommended punishment to the matrix based look up table, and when the recommended punishment does not conform to the punishment of the matrix, then a request to the subscribing official is generated asking for an explanation for the recommended punishment on a standard form input. In this way a level of transparency and objectively are applied to various cheating events. A process for operating such a system is also provided.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIGS. 1A-1J are a series of screenshots of the graphical user interface for implementing features of the adjudication system according to an embodiment of the invention;

FIGS. 2A-2V are a series of screenshots of the graphical user interface used by an overall system administrator for implementing the system and method for cheating and fraud prevention for various academic institutions and organizations according to an embodiment of the invention;

FIGS. 3A-3H are a series of screenshots available to a teacher to manage their classes and monitor for cheating and fraud in accordance with embodiments of the invention;

FIGS. 4A-4K are a series of screenshots available to a student to execute the affirmations and verifications required by the academic institution or organization they attend or are a member of according to an embodiment of the invention;

FIGS. 5A-5S are a series of screenshots for a school or organization that subscribes and uses the cheating and fraud prevention system software according to an embodiment of the invention; and

FIG. 6 is a schematic diagram illustrating an overall view of communication devices, computing devices, and mediums for implementing embodiments of the invention.

### DESCRIPTION OF THE INVENTION

The present invention has utility as an automated system and method for cheating and fraud prevention in academia, government, not-for-profit organizations, and private industry. Embodiments of the invention utilize various technology platforms to implement cheating and fraud prevention measures and promote compliance. Embodiments of the invention also act to foster a sense of ethics and accountability among users. Users of embodiments of the invention may illustratively include an administrator, instructor, trainee, student, manager, and employee and will be referred to hereinafter as a user. Major components implemented by the inventive system and method include affirmation, verification, adjudication, submission analysis, and generation of records and reports. While the present invention is detailed hereafter in the context of an academic institutional setting of a college or university, where an individual assigned various assignment and/or examinations is termed a “student” and where a proctor of such assignments and/or examinations is termed a “teacher” or an “instructor” synonymously, it is appreciated that these roles have functional equivalents in the other institutional settings. It should be understood that these other settings likewise benefit from the present invention with little more than changes to labels assigned to individuals asks to complete assignments and/or examinations, the individual reviewing and administering the completion of assignments and/or examinations, and those officiating the system also retain the same equivalent functions regardless of the organizational context.

Affirmation may take the form of an honor code that a user signs when joining an organization or enrolling in a school, as well as follow-up affirmation documents/forms that the user signs that they are not cheating or committing fraudulent activities, before a given graded assignment, test, entrance exam, college placement exam, compliance, licensing, or certifying activity. The affirmation's contents may be selected, by the school, department, classroom or other organizational subunit, from an extensive set of optional statements provided by the inventive system. No assignment will be accepted or exam started until the affirmation is signed. Signatures are required for affirmations, so the signature image for each affirmation will be stored and may be used in the process of verification. Research in education has shown that proper reinforced compliance methods reduce levels of cheating and dishonest conduct. Affirmation serves as a very important deterrent. Affirmation is a term used, inside and outside of court, and conveys the concept of perjury and ensuing legal penalties. The affirmation raises the seriousness of cheating by making the act of cheating into a lie, which is associated with legal consequences.

While several steps performed by an inventive process and a non-transitory system involve one or more abstract ideas, the present invention as a whole includes aspects that amount to significantly more than the abstract idea. Indeed, aspects of the present invention have never been previously performed in manual or digital form prior to the present invention. As recitations of using a non-transitory computer medium to compile a stored list of user inputted cheating definitions via a graphical user interface, and associate user-defined severity rating to each of the cheating definitions along with a frequency of occurrence to the cheating definitions, a basis is created for an objective default punishment and in some embodiments, a transparent form of documentation as to why standard punishments are not meted out. This is premised on a complied list of user inputted punishments associated with user-defined severity rating to each of the punishments, along with a user-defined frequency rating to each of the punishments, that are the basis for a matrix based look up table. These aspects of the present invention as an ordered combination, amount to significantly more than simply organizing and comparing data by addressing the institutional challenges of impartially codifying and meting out punishments for cheating or other infractions. This is addressed by not only establishing definitions of offenses and punishments, but also noting the frequency of actual events. By creating a record of when the objective offense-punishment correlation is not followed per the matrix, deviations are rendered uniformly transparent. It is note, that many of the apparently discriminatory practices in punishment based on improper criteria such as student gender or ethnicity are addressed by the present invention. As a result, the present invention specifically links the idea of addressing institutional cheating to a digital system in the context of institution that administer assignments and/or tests and in particular to colleges and universities. The present invention has the effect of creating a fairer application of institutional rules and as a result, greater institutional integrity.

Embodiments of the affirmation form may have different levels of compliance, from slight to moderate, which reflect on a philosophy of a school or organization with regards to cheating and fraud prevention. Affirmations occur in at least two different points at initial sign up or enrollment, and prior to an examination or assignment. In all cases of use of an affirmation statement, a student is asked to read a series of statements and then affirm that they agree with the statements. In a specific embodiment a registration packet may contain a document whereby the school may define their version of the definition of cheating and plagiarism. The criteria for cheating and plagiarism may be set by the individual institution, or may be set based on selections from a list provided by the inventive software. The list may have an extensive selection of cheating instances to choose from that result in a spectrum of very lenient to very strict cheating definitions. The list may be generated based on a data repository of cheating instances compiled over time by the various users of the inventive software, other ported to solutions, and entries made by schools and organizations.

A non-limiting illustrative example of an affirmation form used at enrollment/registration, or an initial in-person meeting with a school may have some or all of the following statements as follows:
a. I reside at (address filled in by program).
b. I am a student at (school filled in by program).
c. I have reviewed the school's code of ethics.
d. I have reviewed the school's definition of cheating and plagiarism.
e. I know and understand that the school has a “zero tolerance” policy for cheating and plagiarism and that these are against the school's code of ethics.
f. I know and understand that the school uses diagnostic tools to catch cheaters.
g. I know that cheating and plagiarism are punishable by expulsion from school or other penalties.
h. I affirm that I will not cheat, plagiarize, or commit any other dishonest act while a student at this school.

Subsequent affirmations may omit the first two statements regarding address and identity.

Because some of the language in the exemplary affirmation form described above may be considered quite strong, in a specific embodiment the school may choose to customize two of the statements used in the form. Each statement has 3 options which lead to a total of 3×3=9 possibilities as follows:
a. The statement about diagnostic tools has three options:
   i. Keep as written
   ii. Switch the phrase “uses” to “may use”
   iii. Remove entirely
b. The statement about expulsion:
   i. Keep as written
   ii. Remove reference to expulsion but mention penalties
   iii. Remove entirely

A second non-limiting illustrative example of an affirmation form used for registration may have some or all of the following statements as follows:
1. I am the student listed above and signing below.
2. I reside at.
3. I am a student at
4. I have reviewed the school's code of ethics.
5. I have reviewed the school's definition of cheating and plagiarism.
6. I know and understand that the school has a “zero tolerance” policy for cheating and plagiarizing and is against (name of school). Code of ethics.
7. I know and understand that the school may use diagnostic tools to catch cheaters.
8. I know and understand that cheating and plagiarizing are punishable by expulsion from school or other penalties.
9. I affirm that I will not cheat, plagiarize, or commit any other dishonest act while being a student at this school.
BY AFFIXING MY SIGNATURE BELOW I AFFIRM THE TRUTH OF EVERYTHING ABOVE.

DATED: Month/Day/Year

As will be discussed next the signature on the affirmation forms may serve as a baseline for signature verification.

Verification, especially in online education is critical for verifying the identity of a user. Embodiments of the invention illustratively employ forms of biometrics, signature recognition, typing style, keystroke pattern analysis, and proctoring among other techniques. Biometrics may include finger prints, thumb prints, facial recognition, iris scans, and speech pattern recognition. Embodiments of the inventive system support and integrate various biometric readers, cameras, and software products, as well as third party matching systems that match a captured print to the student's print. For example, during a student's registration the student may sign a pledge on the affirmation form to adhere and uphold the school's code of ethics. This signature may be used to establish a baseline for signature verification. In a specific embodiment, signatures for verification need more processing than signatures for affirmations. When signing the affirmation with each submission and exam, the student's signature may be used for verification using a static (verifying the appearance of the signature) and dynamic process (using tension, speed, and pressure). A human who proctors an exam may also serve as a source of verification by checking identification cards and interacting with and watching the student. The proctor monitoring the students while taking tests may report cheating instances that the school will enter into the data repository. Proctoring by webcam may also be utilized in embodiments of the invention.

Adjudication systems employed in embodiments of the invention clearly define fraudulent activities and what constitutes forms of cheating, and the consequences to the user for any violations that may occur thereby providing a sense of accountability to the user. A school or organization may have their own definition of cheating and their own disciplinary program. Embodiments of the invention include a cheating and fraud adjudication program for developing a custom cheating and anti-fraud policy. In specific embodiments a list of possible cheating cases is provided along with a list of possible punishments, and a process for matching the cases of cheating to specified punishments. Embodiments of the invention provide a system that enables the school to choose cheating definitions and use punishments from a master list. Cheating cases and punishments are rated and aligned to each other. A chart is formed that serves as a guide for adjudication. Embodiments of the adjudication system promote sentencing guidelines that mitigate prejudicial sentencing. The risk of prejudicial sentencing, is even more prevalent in the adjudication system of education for the following reasons: there is no system for a judge to be recused due to a familiarity with the defendant that may result in impartiality; in the event, a judge decides to recuse himself or herself, there may not be a replacement (The defendant is known by all and the case can't be tried in another jurisprudence); a cheating case may be publicized and become a public scandal, in which case the committee may give a harsher sentence to protect the school's image; and the defendant may be an asset to the school's image as a noted scholar or an athlete and the school may not be impartial.

Furthermore it has been found the schools and organizations that lack an adjudication system, based on embodiments of the inventive system and process, are prone to the following: lengthy committee meetings with divergent views that have great difficulty in giving any punishment; a decision backlog, whereby certain punishments may be too late to enforce. (i.e., lowering a grade that is adjudicated after the semester); inconsistent levels of punishment indicating that the adjudication process is flawed and arbitrary that leads to a lack of confidence of the entire system that may discourage the bringing of cases to judgment.

In a specific embodiment of a method for cheating and fraud adjudication, a school chooses their cheating definitions from a master list, and each accepted or verified occurrence of a cheating offense or fraudulent activity is designated with a letter A, B, or C which correspond to a first offense, second offense, or habitual offender, respectively. The school then rates the severity of each cheating definition and its cases' ABC designation from 0-5, where 0 is for the least severe to 5 for the most severe cheating or fraudulent occurrence. A chart that aligns punishments or penalties based on the severity and number of occurrences is provided by the system and as a database look up table. An organization or academic institution may require their members or students to read the punishment chart as part of the affirmation process, which in a specific embodiment may be at the time of registration. The punishment or penalty chart may be prominently linked to student, member, teacher, school or organization administration, and disciplinary committee. The school or organization may choose their designated punishments from the master list provided by the inventive system. A list of considerations or mitigating factors may also be available in the inventive system. In a specific embodiment, any punishment that is not conforming to the pre-chosen alignment to the severity of the cheating case requires an explanation on a standard form that is entered into the adjudication system.

It some inventive embodiments, an additional module or separate adjudication system may also be established to deal with legal issues related to crimes and unethical behavior that lie outside academic matters of cheating and plagiarism that occur on a campus or in an institutional context. Embodiments of the campus legal adjudication system may provide a list of consequences, guidance, listings of support groups, and facilitation for enlisting in substance abuse programs, hazing, or sexually inappropriate behavior. A separate affirmation to cover these legal issues may be required at the time of registration which may read as follows: I know the (name of school/organization) policy on non-acceptable behavior and crime and its associated punishment. In specific embodiments the definition of what constitutes a crime is not chosen but provided by a policing organization illustratively including a crime list issued by the Federal bureau of Investigation (FBI). A specific inventive application is applied campus legal issues that involve crime occurrences and personal conduct issues that occur on a college campus. The inventive embodiments related to campus legal adjudication are not part of the Clery Act. The Clery Act is a consumer protection law passed in 1990, and requires all colleges and universities who receive federal funding to share information about crime on campus and their efforts to improve campus safety as well as inform the public of crime in or around campus

Issues addressed by the campus legal adjudication system illustratively may include alcohol and drug abuse, property damage, and theft. More serious crimes such as bodily assault, rape, and murder are a matter for the police and city/state legal system. The campus legal adjudication system provides a delineation of crimes to be reported to police. Repeat offenses and amount of alcohol above legal limit, drugs (amount of and possession), intoxication, hazing, and cases handled by both campus and outside authorities. Group leader, hazing, Greek life, damage of property, physical harm, or death of member of group related to intoxicated driving.

An illustrative example of an important variable that is monitored by the campus legal adjudication system is where the reported criminal incident took place, whether on campus, a residence (subset of campus), non-campus property, and public property. The location variable is important as the location may serve as an indicator that may be prejudicial. A second important variable to consider is to whom the crime was reported to. For example, a dean may be stricter and influence a committee. A coach, counselor, or a pastor may encourage leniency. An additional feature provided is an analysis of those authorities who were notified or present but did not respond.

Schools and organizations using embodiments of the adjudication system have experienced less cheating as the cheating policies combined with student affirmation serves as a deterrent. Furthermore, the documented cheating policy serves as a guide for school administrations or organizations when dealing with a cheating incident, thereby eliminating weak ad hoc decisions. In addition, proctors know their responsibilities, and more importantly, the proctors know what the administration will do, if they report a cheating incident.

Forms of submission analysis may include a plagiarism detection system that evaluates assignments submitted by a user for originality. Records and reports generated by embodiments of the invention track and record instances of cheating and fraudulent activities of users. In specific embodiments suspected cheating instances or fraudulent activity should be either confirmed or removed, based on the disciplinary and administrative process of the school or organization. The records, which are stored in a database, may be used to generate reports to determine the severity of specific problems and the effectiveness of prevention measures. The reports and events database may be kept on a central server that may be offered as a service on demand in the cloud for separate schools and organizations, as well as on a local server belonging to the user.

Various standard reports are available, as well as customized reports based on user needs and requirements. Illustrative non-limiting examples of available reports and statistical analysis may include: the effectiveness of each solution; cheating comparison between individual schools under same subscriber; cheating comparison between different programs of same subscriber; cheating comparison between individual proctors; cheating level fluctuation; student record (available only to institution); the rate of increase or decrease of cheating of previous violators; age, gender, and race as factors in cheating.

The reports provided by embodiments of the invention are generally password protected and only available to authorized people. Authorized people may illustratively include: school officials with legitimate educational interest; other schools to which a student is transferring; specific officials for audit and evaluation purposes; appropriate parties in connection to financial aid to a student; organizations conducting certain studies for, or on behalf of schools; accrediting organizations; to comply with a judicial order or lawfully issued subpoena; and appropriate individuals in cases of health emergencies; and state and local authorities, within a juvenile justice system, pursuant to a specific state law.

The analysis reports are FERPA (Family Educational Rights and Privacy Act) compliant and do not identify individual students (i.e., disaggregated data). In specific inventive embodiments, reports are available that identify cheating events by specific teachers, so the school is made aware of which teachers need to redesign their course to minimize cheating. The individualized teacher reports will also act to discourage teachers from enabling cheating, encourage them to monitor cheating, and will deter cheating by teachers themselves.

Embodiments of the inventive fraud and cheating prevention method and system do not rule on specific cases of whether the case should be deemed as cheating or a fraudulent activity. All cases that may possibly be construed as cheating (suspicious incidences) are reported to the school or organization. The incidence is only listed in a data depository in the form of the reports and events database after the school confirms that there is a case of cheating. The received cheating incidence/infraction is recorded in a database with searchable variables to facilitate report generation and statistical analysis.

Embodiments of the invention provide a cheating and fraud prevention strategy that relies on ethics, prevention, integration, flexibility, and accountability. Through use of an ethical approach and fostering compliance the user's urge to cheat may be prevented. Flexibility in the inventive fraud and cheating prevention method and system allows different schools and organizations to define cheating and fraudulent offenses and activities in different ways, and to have differing policies on how to deal with offenses based on what is best suited for the academic institution or organization. Embodiments of the cheating and fraud prevention solution integrate several user configurable and flexible approaches that schools and organizations may use to combat cheating and fraudulent activity. Embodiments of the cheating and fraud prevention solution are easily ported with “plug and play” capabilities to utilize and integrate available cheating reduction and plagiarism detection systems. The inventive cheating and fraud prevention solution is also Learning Tools Interoperability (LTI) compliant to allow for easy product integration with other educational software solutions. The primary purpose of LTI is to connect learning systems with external service tools in a standard way across learning systems.

In instances where prevention has failed, the reporting and recording of cheating and fraudulent activity will make academic institutions and organizations accountable and further drive their resolve to combat the cheating and fraudulent activity. Embodiments of the inventive system may also interface to forms of the Learning Management System (LMS) and other academic integrity systems used by schools. A learning management system (LMS) is a software application for the administration, documentation, tracking, reporting and delivery of electronic educational technology (also called e-learning) courses or training programs. In specific embodiments, exams with student lists may be downloaded from the LMS, and the tests are administered by the inventive system. Completed assignments may be submitted to the inventive system, which may then perform integrity functions on the assignments and then upload the assignment to the LMS.

Embodiments of the invention may interface with web browsers used on devices by students and other users in a testing or in a certifying environment. The inventive software interfaces with browser lock down features in the testing environment within the Learning Management System (LMS). During browser lockdown, students are unable to print, copy, go to another universal resource locator (URL), or access other applications. When an assignment or exam is started, students are locked into the assignment or exam until the student submits the assignment/exam for grading. Typically, a school or organization would have its own license with a selected supplier for the browser lockdown software within their local network.

In specific inventive embodiments student names with their associated personal identification (id) number as well as proctor's names with their personal id number are uploaded to a server. Embodiments of the inventive software assign and attach a unique barcode to each student and teacher. Assignments and examination papers are also assigned a unique barcode which are associated with a given student and teacher administering the student. The tests will be labeled with a unique barcode for the test, student and teacher. The test may be taken on the Internet or on paper. In both cases, this test will have three barcodes. One barcode will serve to identify the test and a second will identify the proctor, both will be uniformly put on all copies of test. Each individual student will have their assigned and unique barcode on their test. In the case where the questions and answers are on two separate pages, all three barcodes will only be put on the answer sheet. Paper tests will be scanned and uploaded to the server.

Furthermore in specific inventive embodiments, tasks that illustratively include assignments, papers, labs, and collaborative assignments, each, will have a separate affirmation form available at the time the assignment is approved or given. Upon uploading, the completed task work will be labeled with three unique barcodes, student, task, and teacher. In addition, none of these required tasks may be accepted until the affirmation is signed by the student.

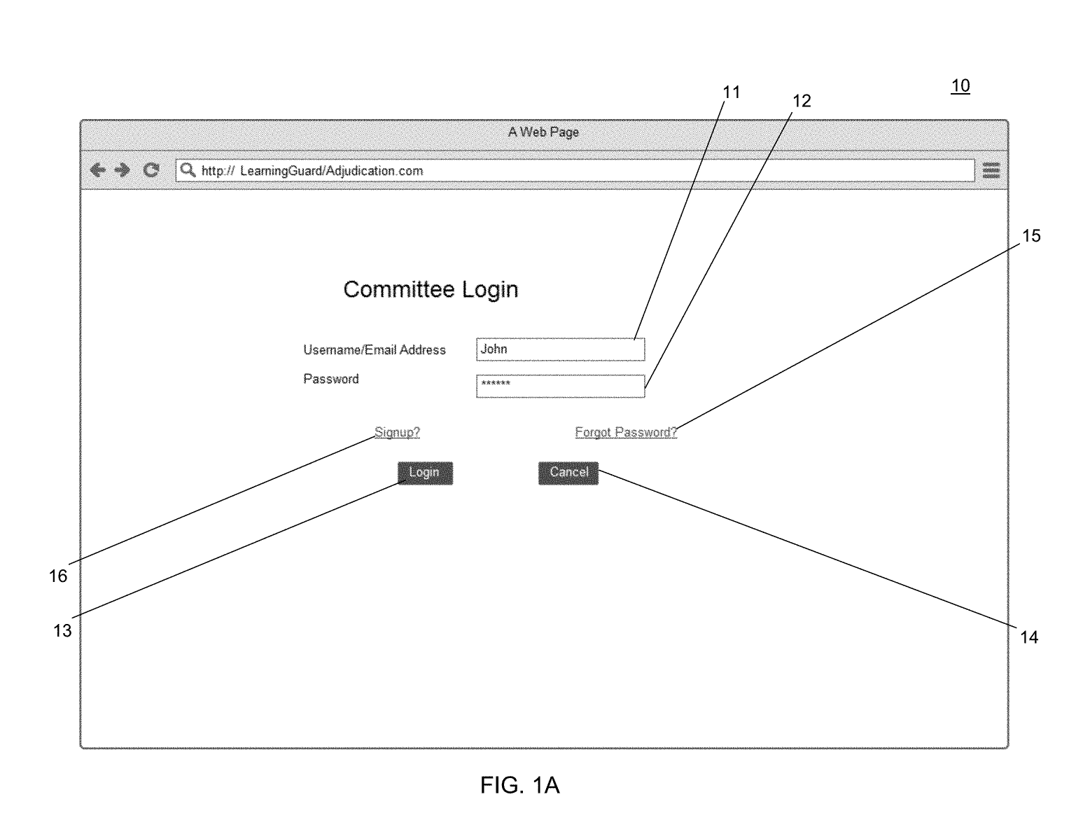

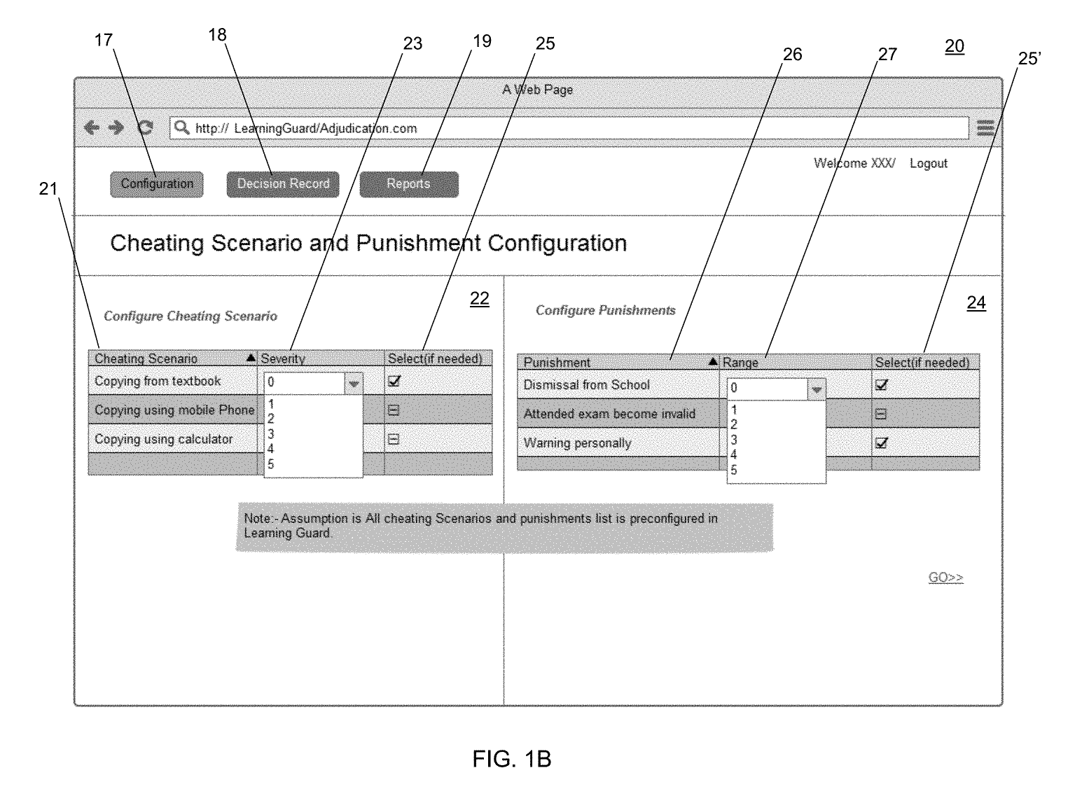

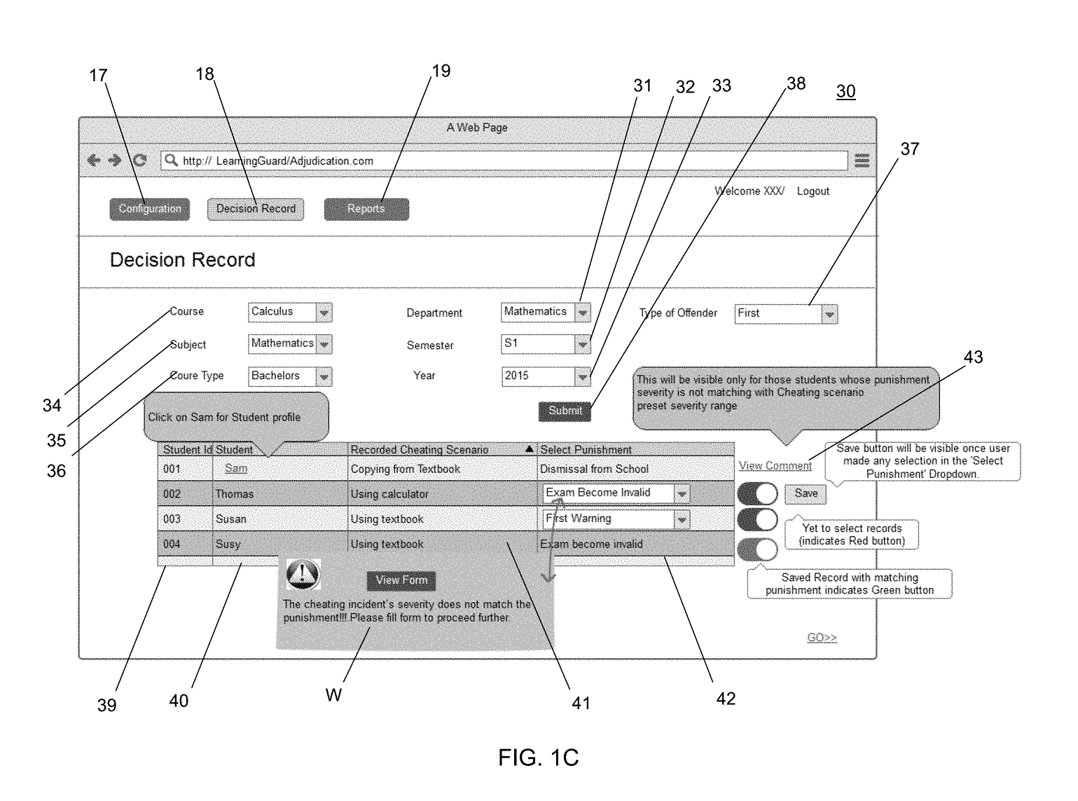

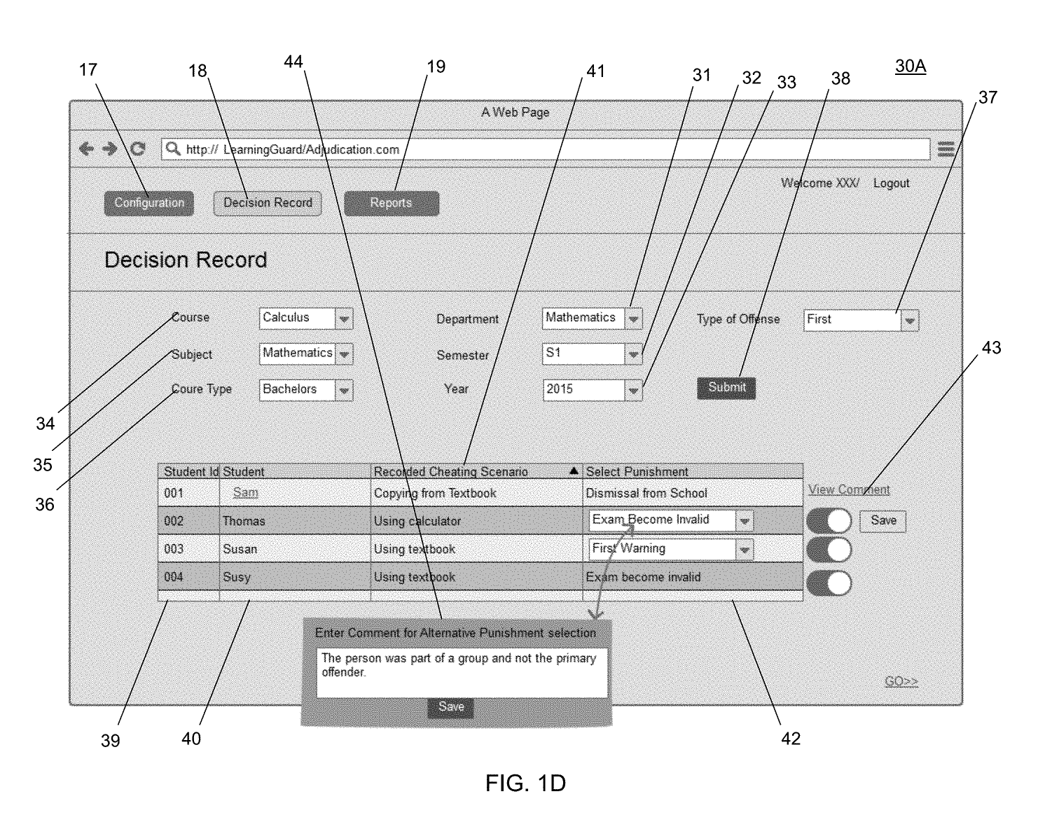

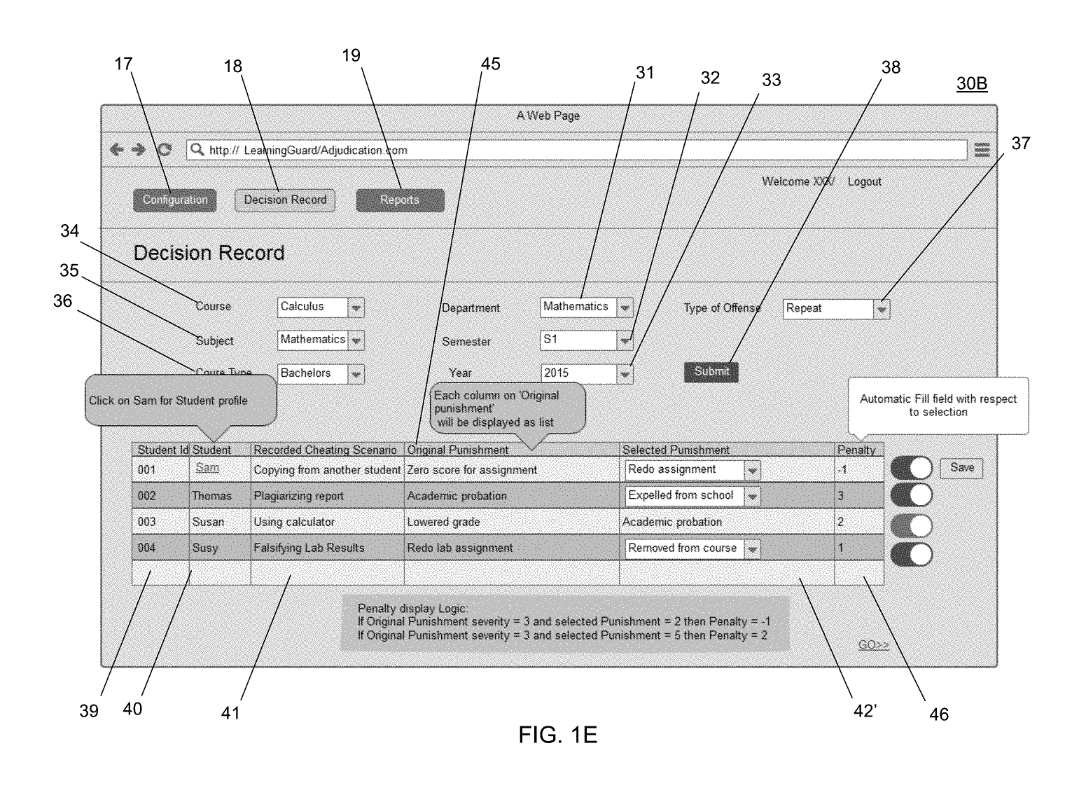

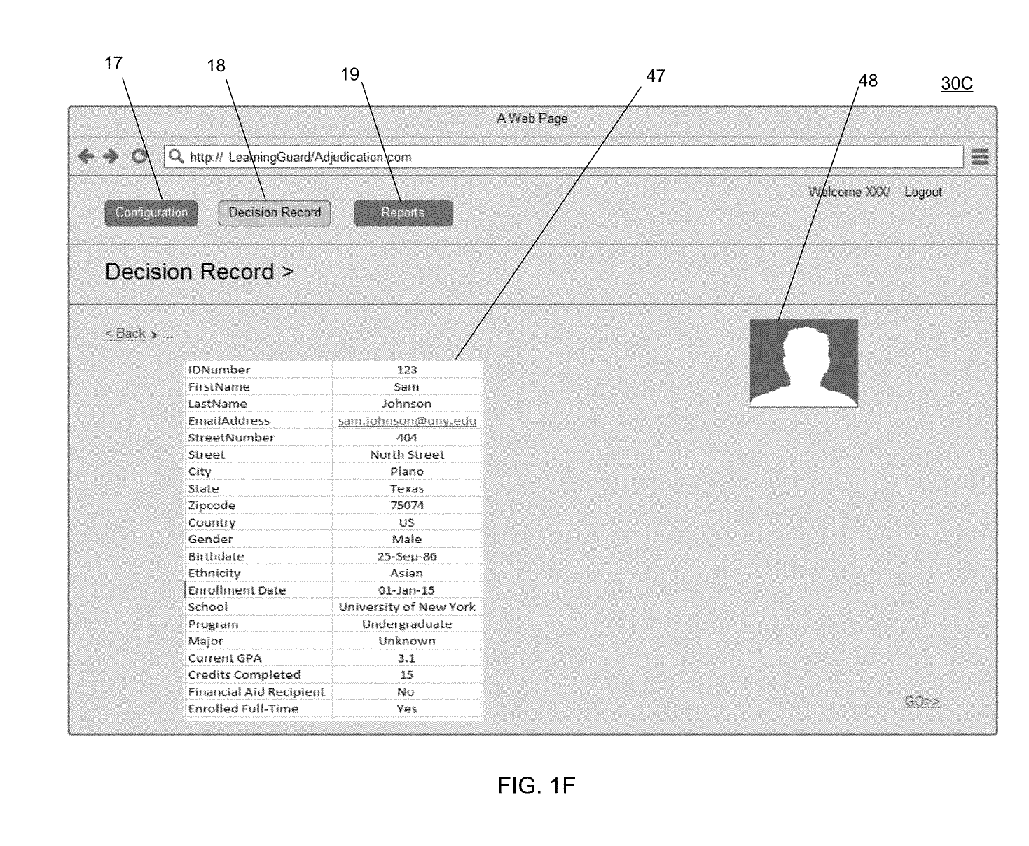

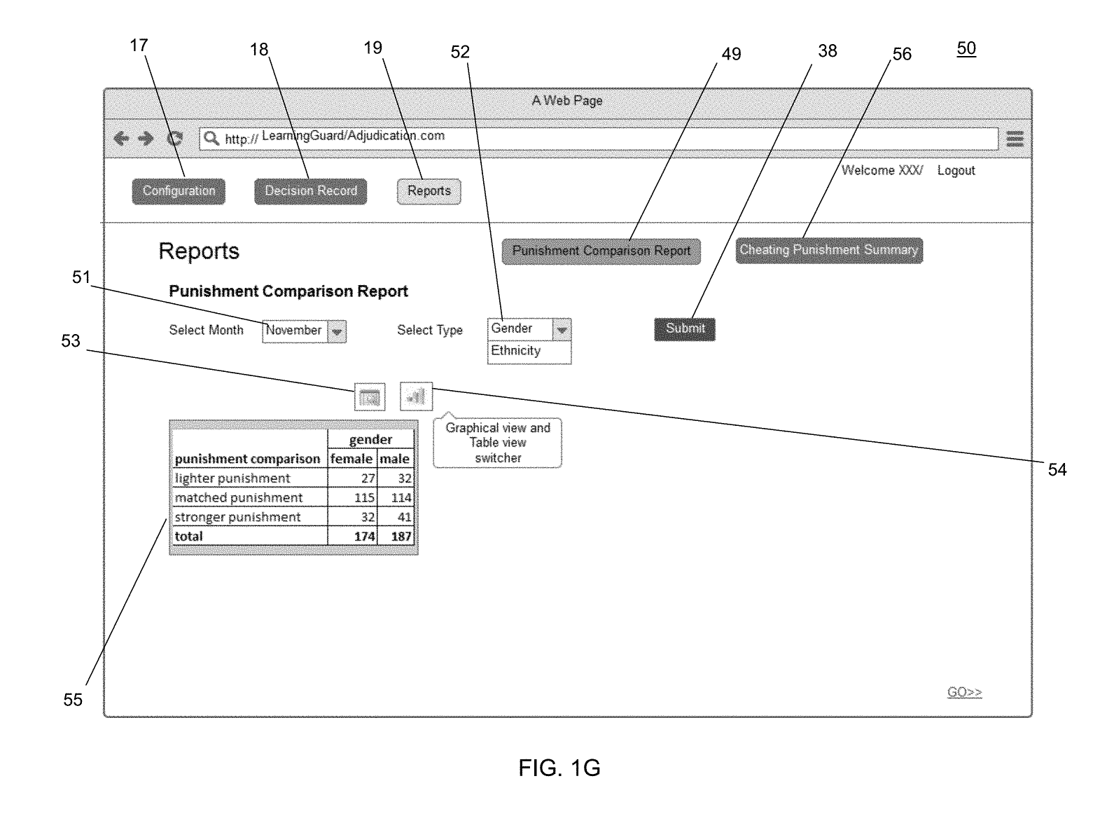

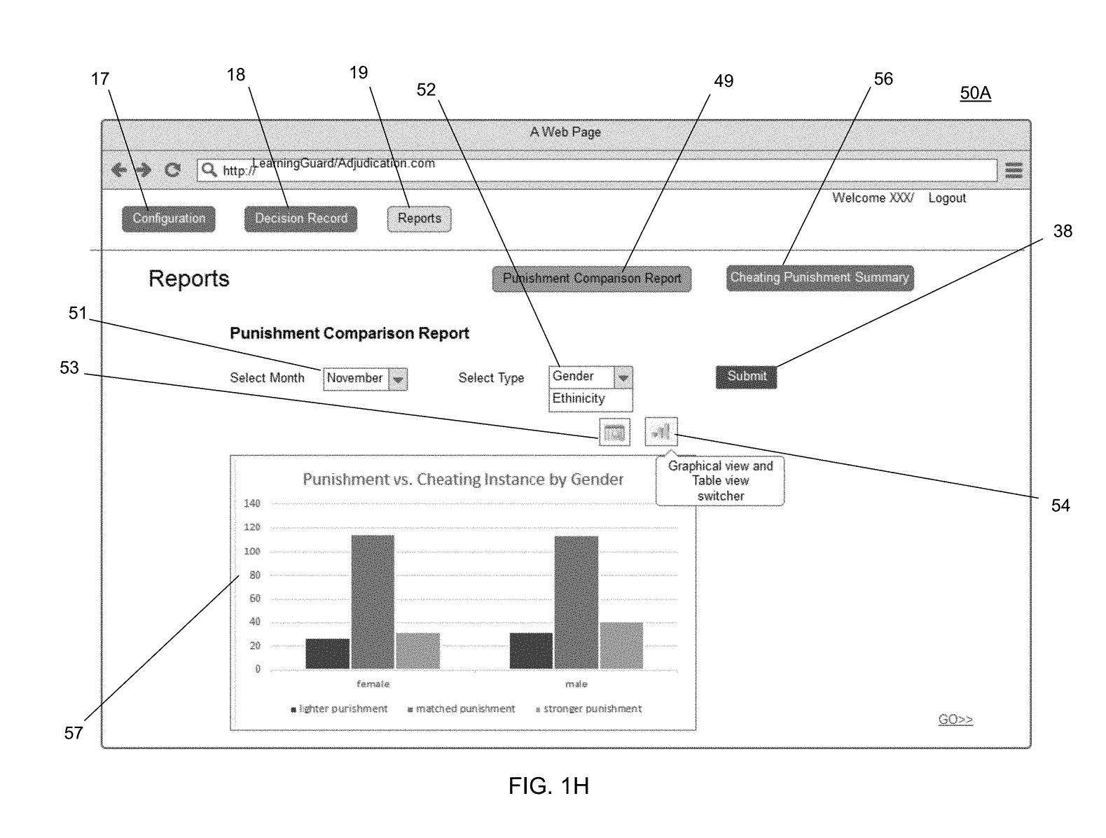

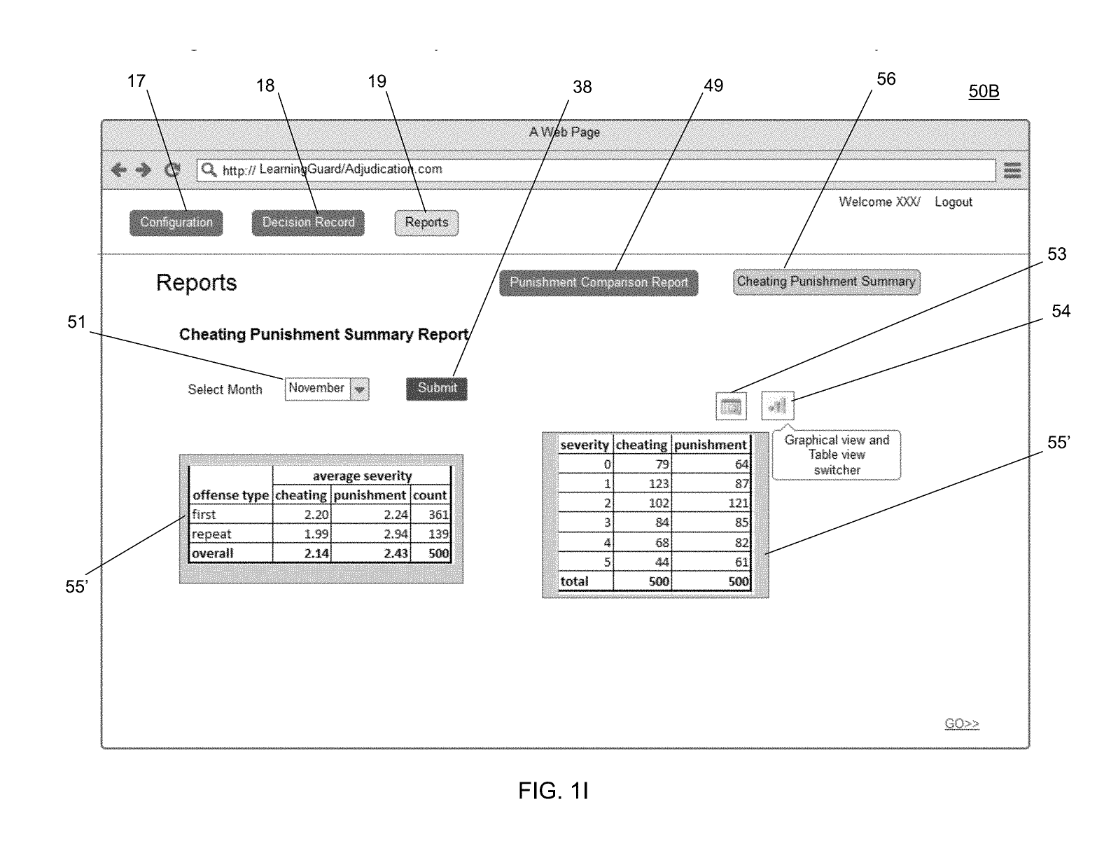

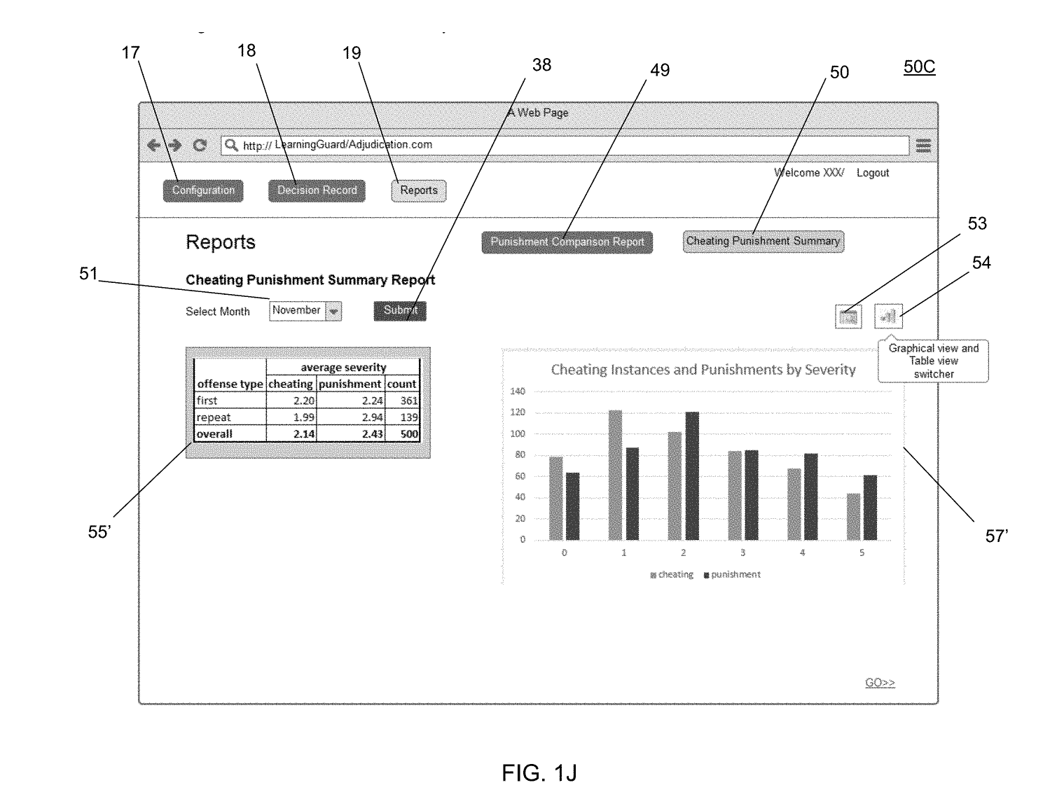

Referring now to the figures, FIGS. 1A-1J are a series of screenshots of the graphical user interface (GUI) for implementing features of the adjudication system. FIG. 1A is a login screen 10 to allow access to the adjudication system by entering a username or email address in input field 11 with a corresponding entry of a password in password input field 12. In order to gain first time access an authorized user must initially use the signup link 16 to input identifying information as well as their username and password that will be used for future logins. If the user forgets their password, a forgot password link 15 is provided that allows the user to enter an email address associated with their account to obtain a temporary password in order to login and establish a new password. After providing their username/email a user selects login via login selection button 13 or may cancel the login process via selection of the cancel button 14. It is noted that depending on the operating system (OS) of the device as well as the display screen of the device these selections may be done with mouse based commands or via touch commands.

FIG. 1B is a screenshot of a cheating scenario and punishment configuration page 20 which the user arrives at by selecting the configuration button 17. In a configure cheating scenario section 22, a user is presented with a list of cheating scenarios 21 in a table. A severity 23 may be assigned to each of the cheating scenarios 21 via pull down selection. The user may then select if the cheating scenario is applicable to the school or organization by selecting boxes in the select column 25. In the specific embodiment shown the user may assign a numerical range of zero to five to each of the cheating scenarios 21. In a configure punishment section 24 a list of punishments 26 is provided, where each punishment is assigned a range of severity 27 via pull down menus. In the specific embodiment shown the user may assign a numerical range of zero to five to each of the punishments in the listing of punishments 26. The user may then select if the cheating scenario is applicable to the school or organization by selecting boxes in the select column 25′.

FIGS. 1C-1F are graphical user interface screens for decision recording in the adjudication system. FIG. 1C is a screenshot of a decision recording screen 30, which is used to record individual students and the cheating or fraudulent act that they have been caught doing, and is reached by selecting the decision record button 18. Students are listed in a columnar table by student identifier (id) 39 and name 40. The students and their corresponding profile have already been entered into the system when the students register for entry into the academic institution or organization. Associated with each student in the decision record table is the recorded cheating scenario 41 that they have been found guilty of. A user may assign a punishment to a student via the pull down menu in the select punishment column 42. If the severity of the cheating incident does not match the punishment selected, the user will see a pop up warning W, and the user will be asked to fill out a form explaining the deviation before they may proceed further. A view comment link 43 also appears when there is a disparity between the offense and the punishment assigned. With the selection of a specific student in the student column 40, the student's profile information appears on the screen as shown in FIG. 1F. Additional information that is entered to explain the detail of when and in what course the infraction occurred is entered in the pull down menus for department 31, semester 32, year 33, course 34, subject 35, course type (bachelors, masters, doctorate) 36, and type of offender (first, second, repeating) 37. In a specific embodiment the system allows the user to save the information only after the required information has been entered into the system including the explanation of any disparities between an infraction and a designated punishment. FIG. 1D is a screenshot 30A that shows a comment pop up window 44 for the entry of a comment to explain the reasoning for an alternative punishment, and which is visible with the selection of the view comment link 43.

FIG. 1E is a screenshot 30B of the decision record that shows the deviation of severity between an originally assigned punishment 45 and a selected punishment 42′ for a specific recorded infraction 41. The penalty column 46 records the disparity in punishment severity as a number as follows:

If original assigned punishment severity=3 and user selected punishment=2 then penalty=−1
If original assigned punishment severity=3 and user selected punishment=5 then penalty=+2

An exemplary embodiment of a student profile appears in screenshot 30C in FIG. 1F. The student profile page may have their picture 48 and a table 47 with their personal information, as well as academic and financial aid information.

FIGS. 1G-1J are report generating screens within the adjudication system. FIG. 1G is a screenshot 50 of a report screen for punishment comparison, which is used to compare punishments between groups of students that may be based on gender, race, ethnicity, age, or combinations thereof, and is reached by selecting the punishment comparison report button 49. The period of time covered by the report may be selected via pull down menu 51, as well as the types of groups to be compared with the select type button 52. The reports may be generated in tabular or graphical formats that the user selects via switchers 53 and 54, respectively. FIG. 1H is a screenshot 50A of a report screen for punishment comparison in graphical form 57 as selected with the graphical format selection 54. FIG. 1I is a screenshot of a cheating summary report for a particular period of time based on the selection of the cheating punishment summary button 56. FIG. 1J illustrates a screenshot 50C that show both a tabular and graphical representation of a cheating summary report.

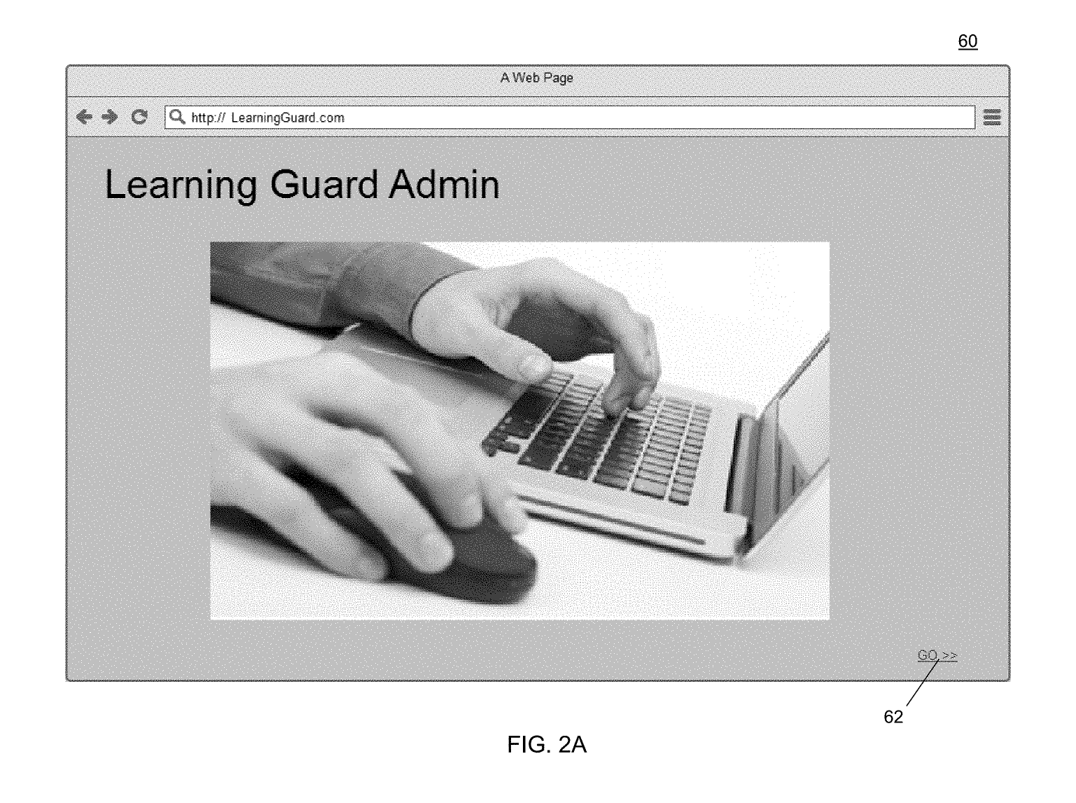

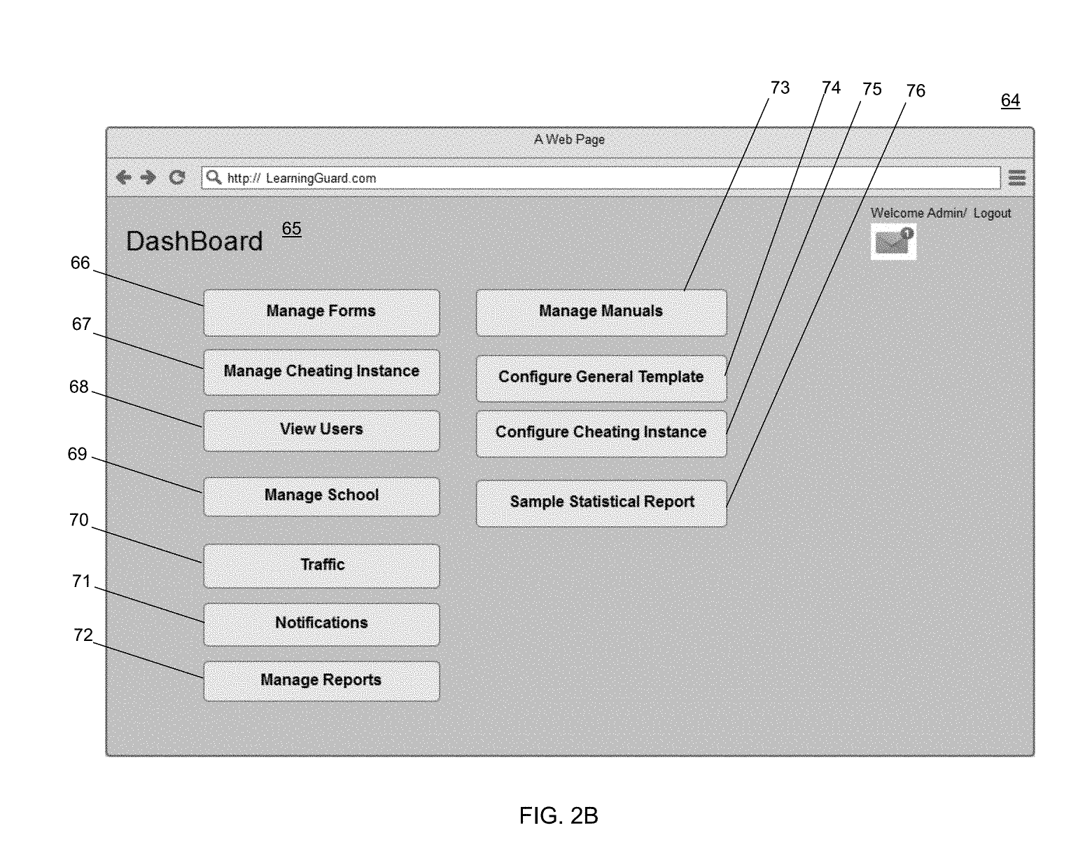

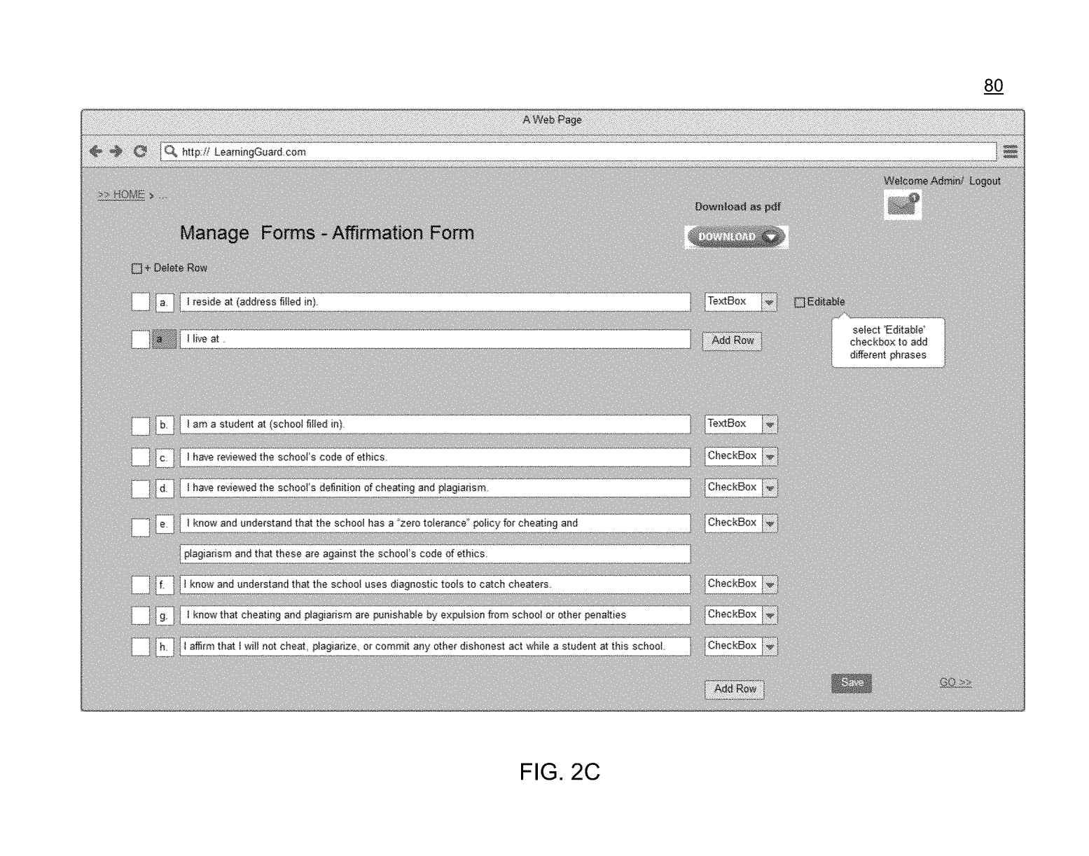

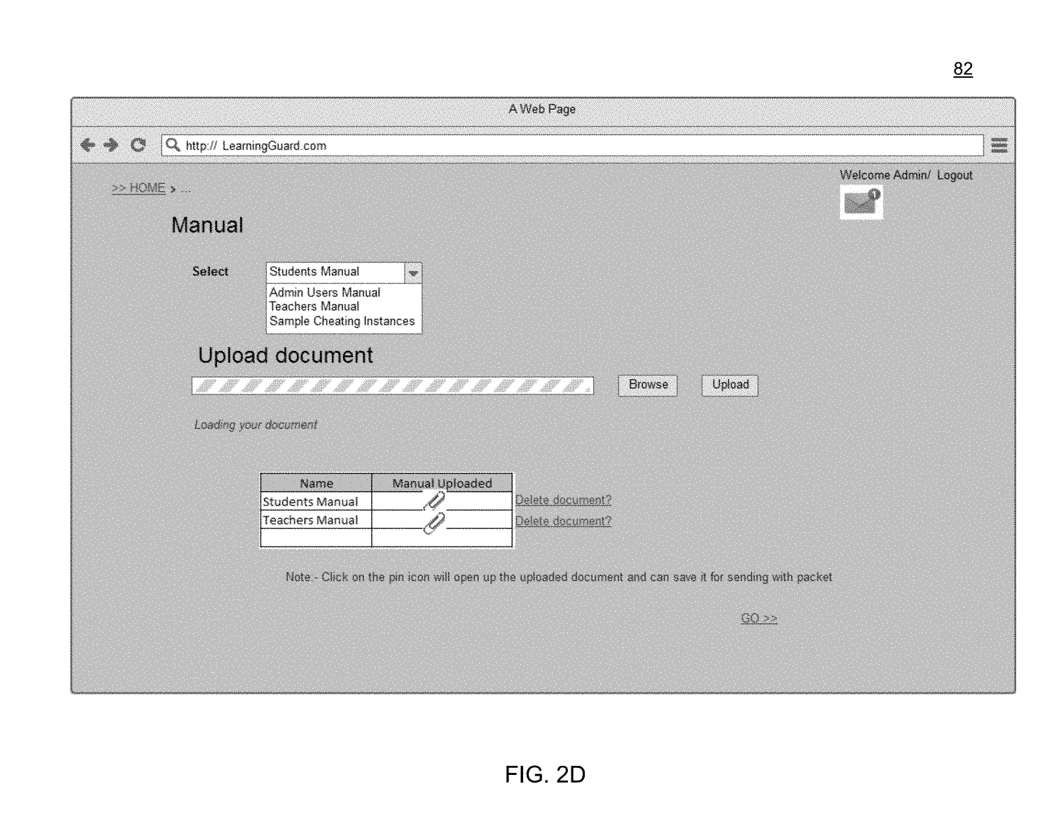

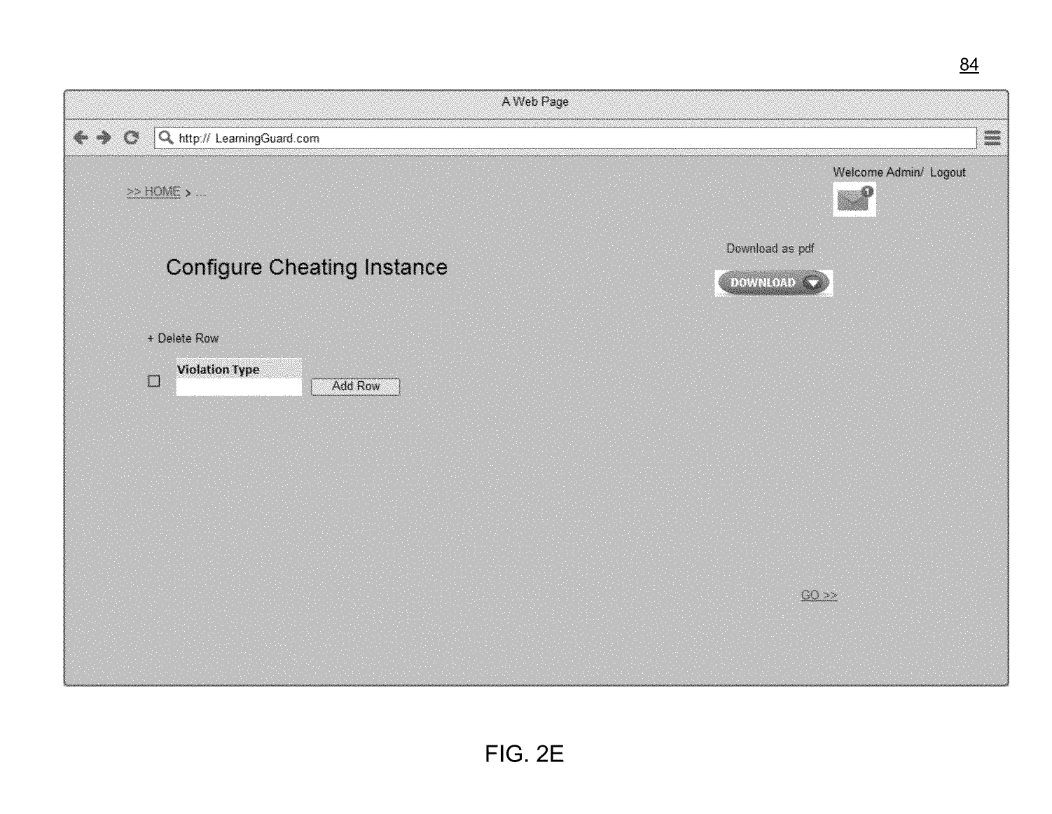

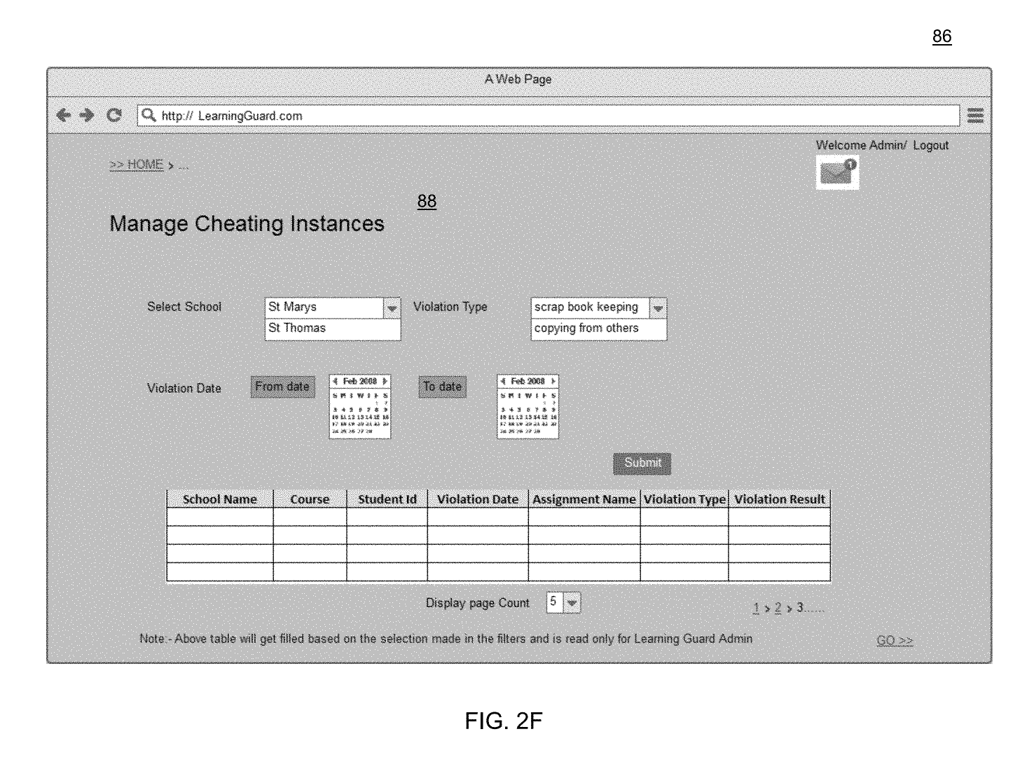

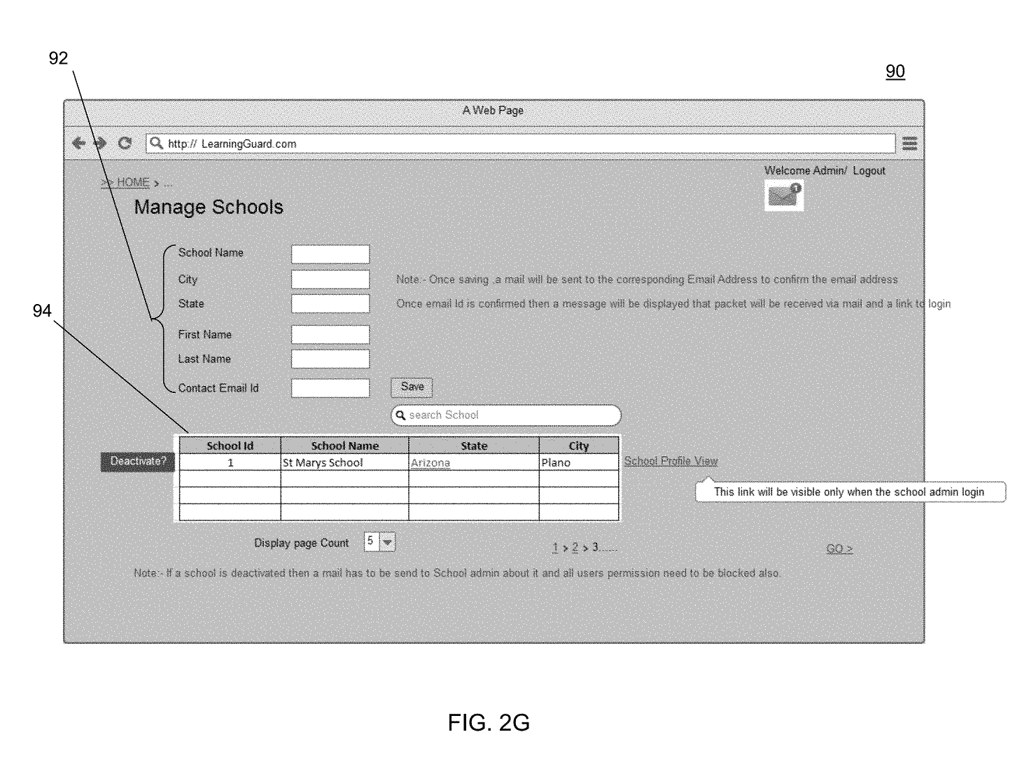

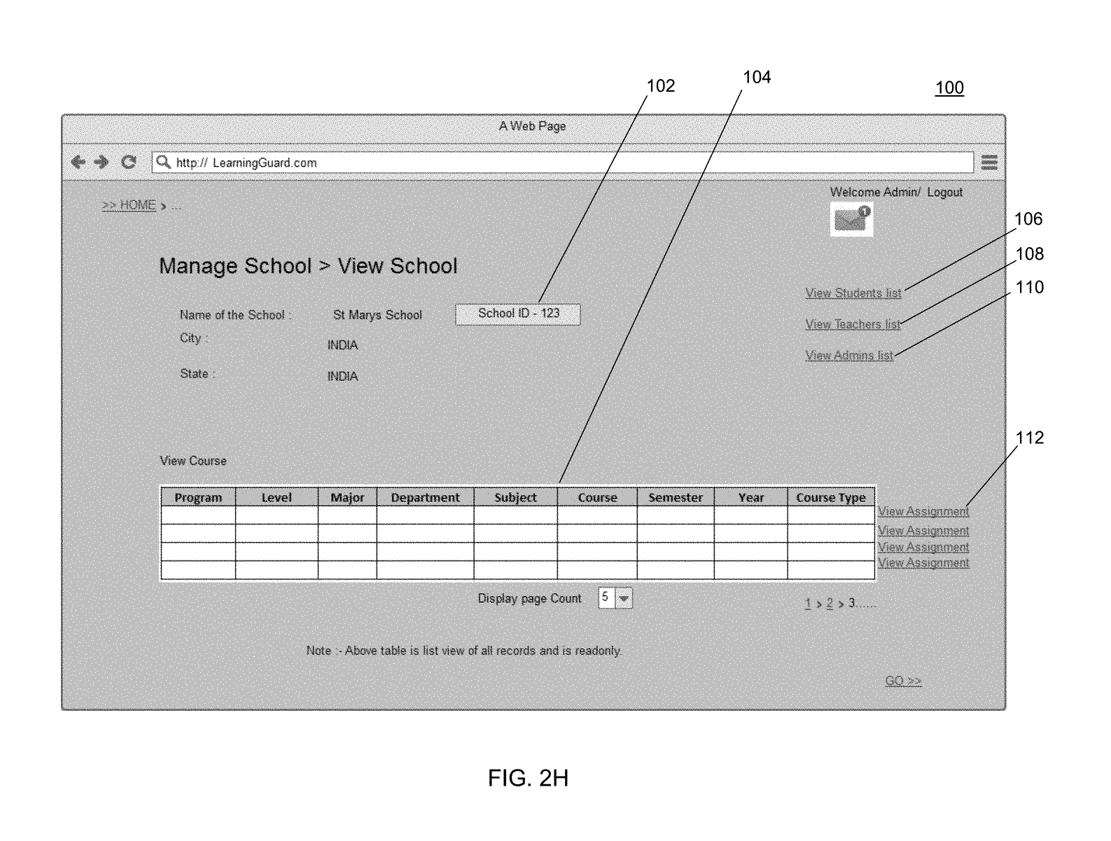

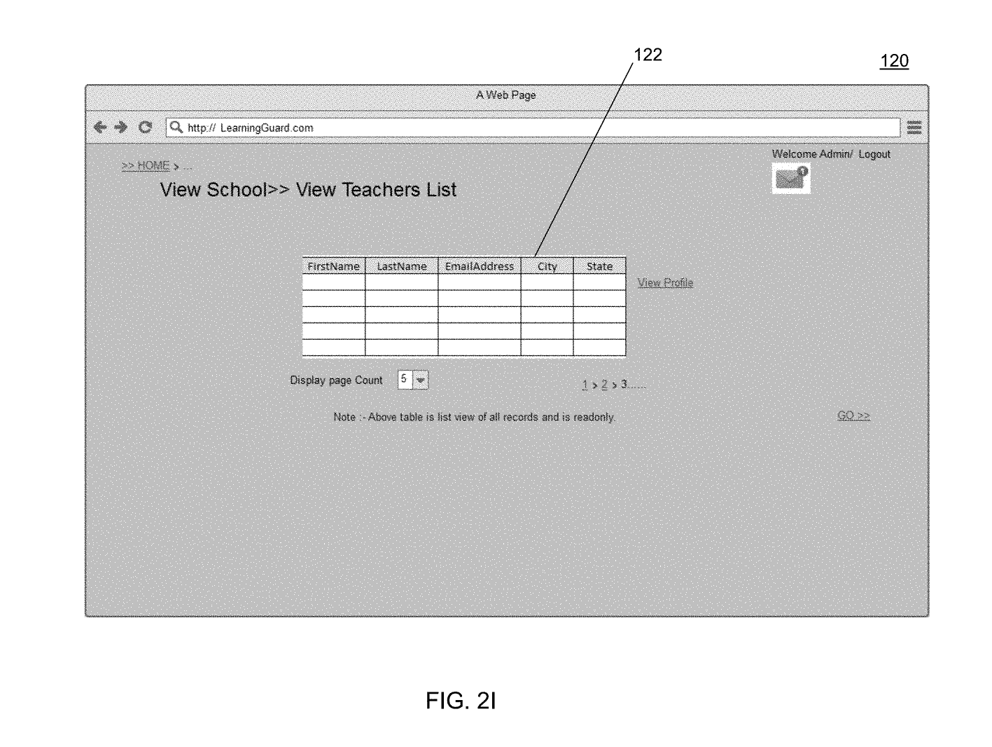

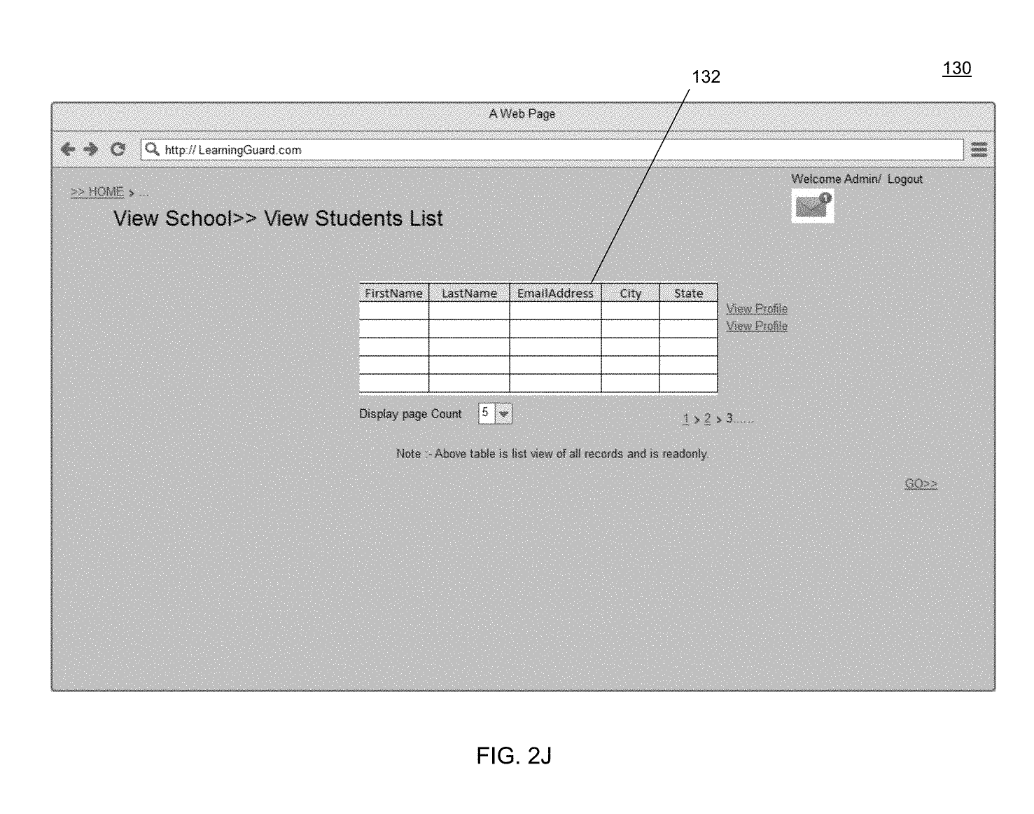

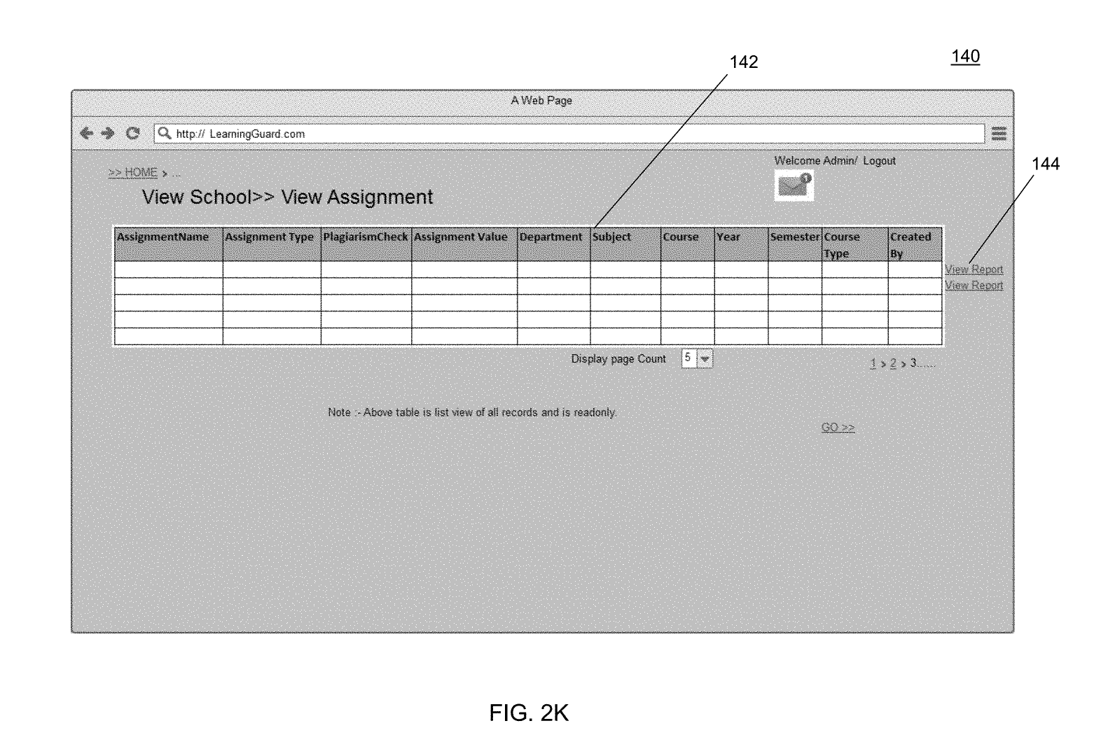

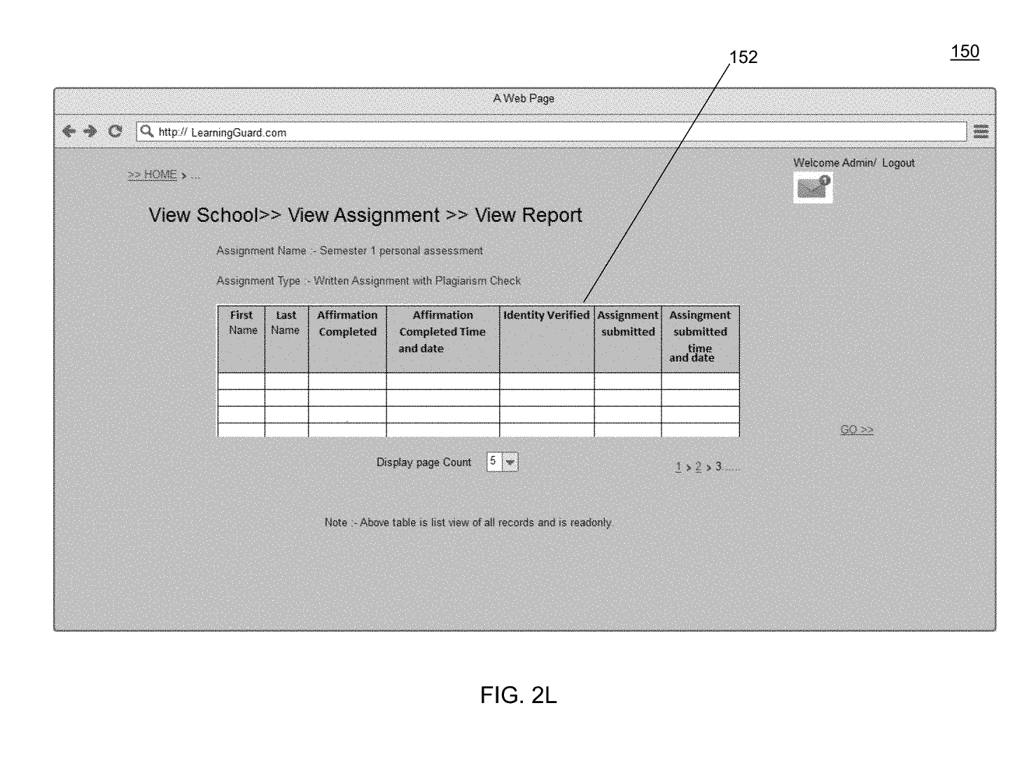

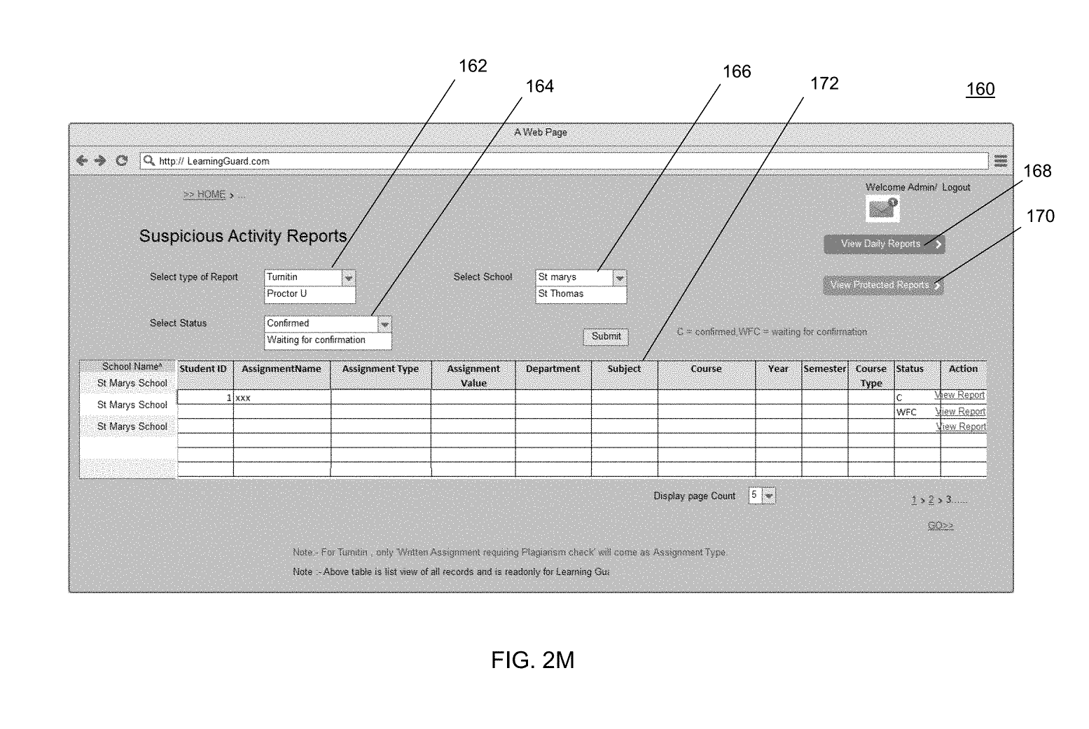

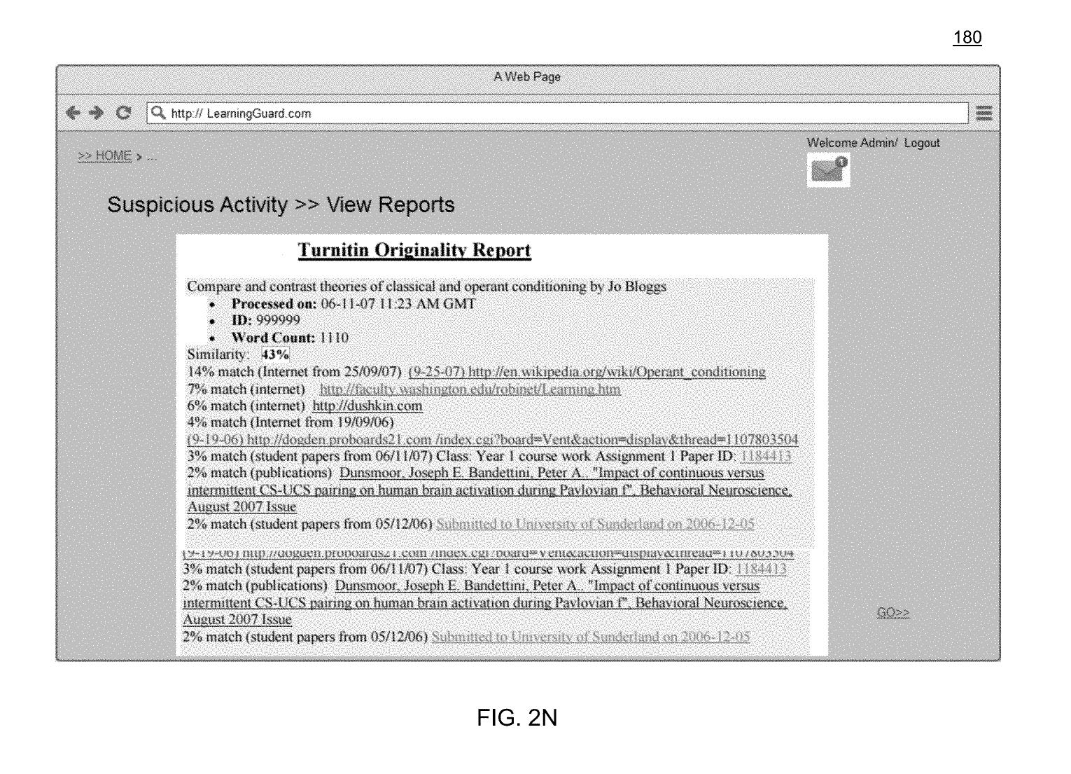

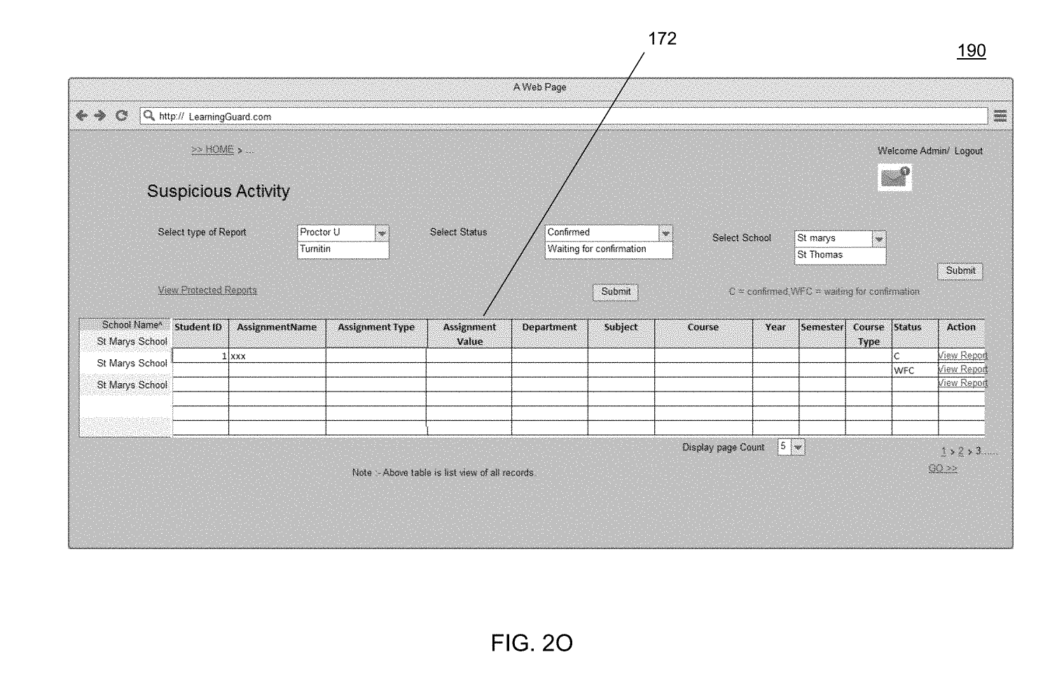

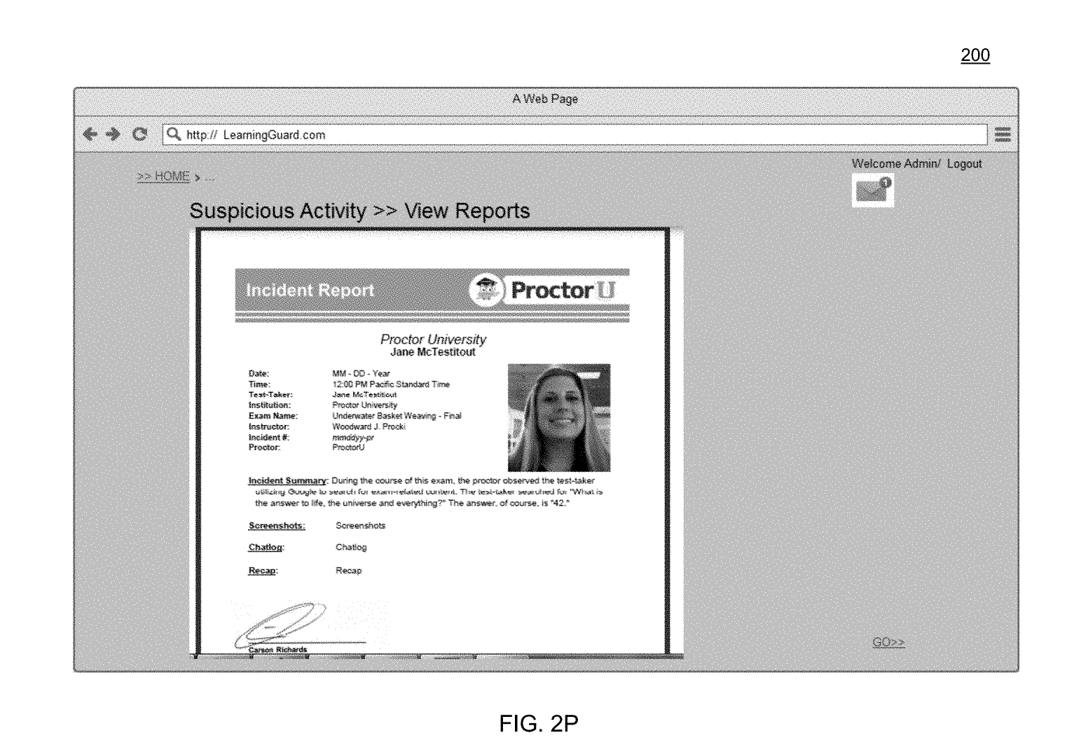

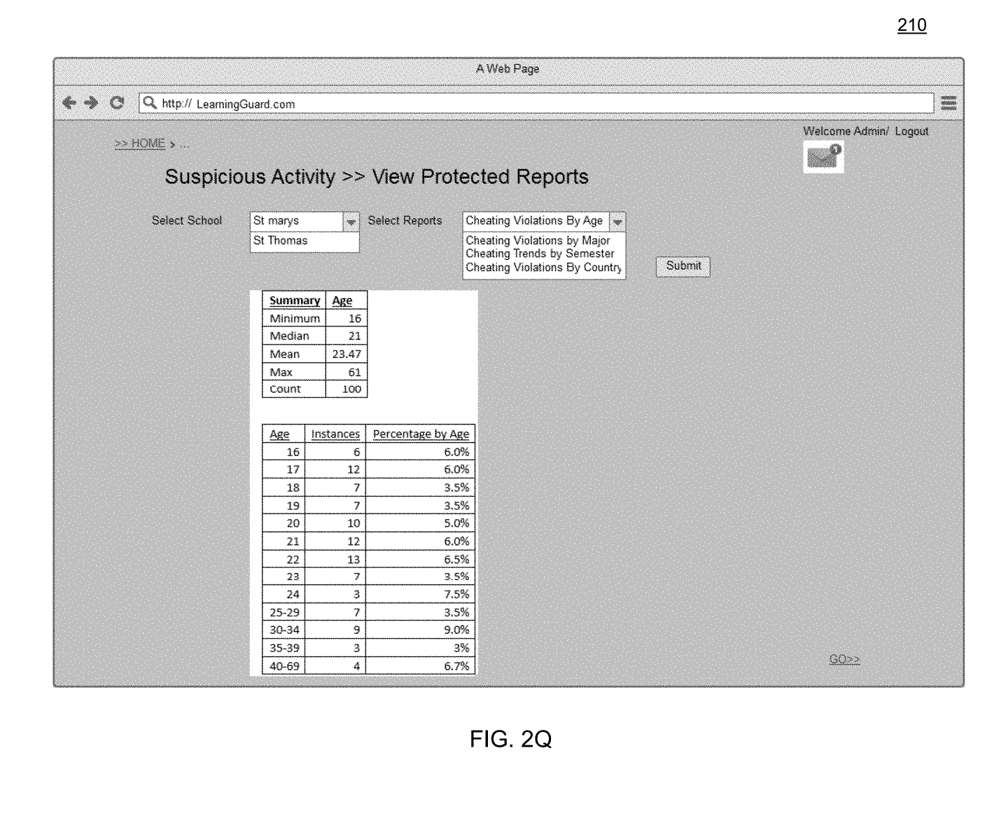

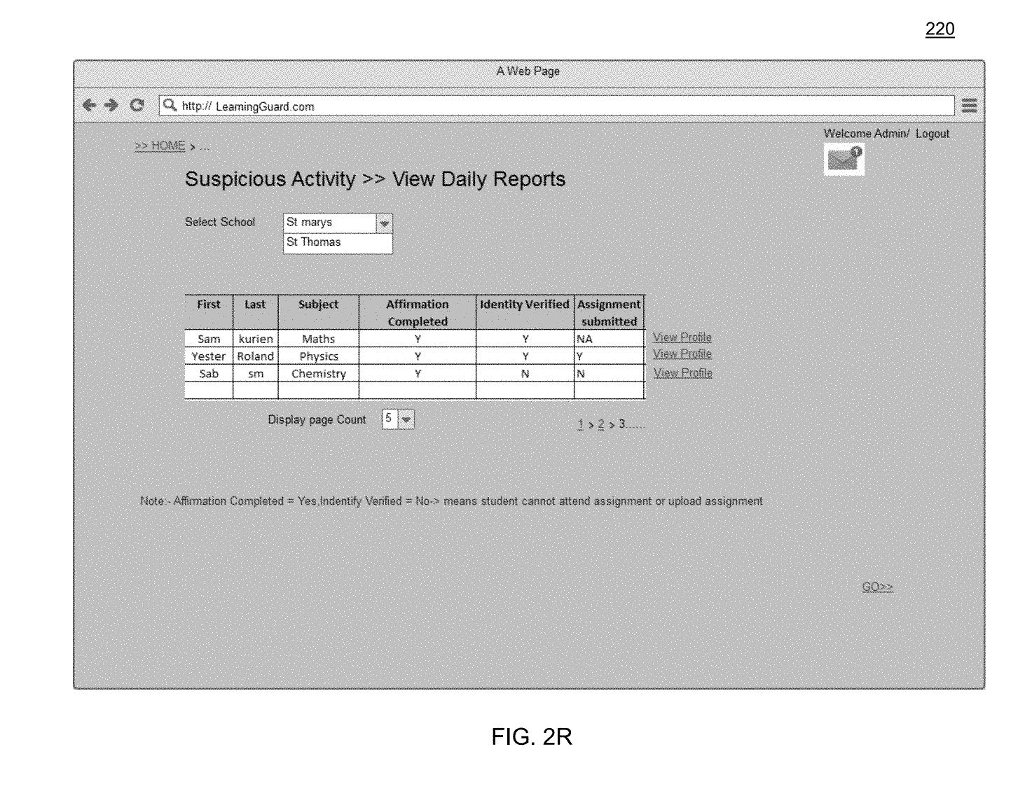

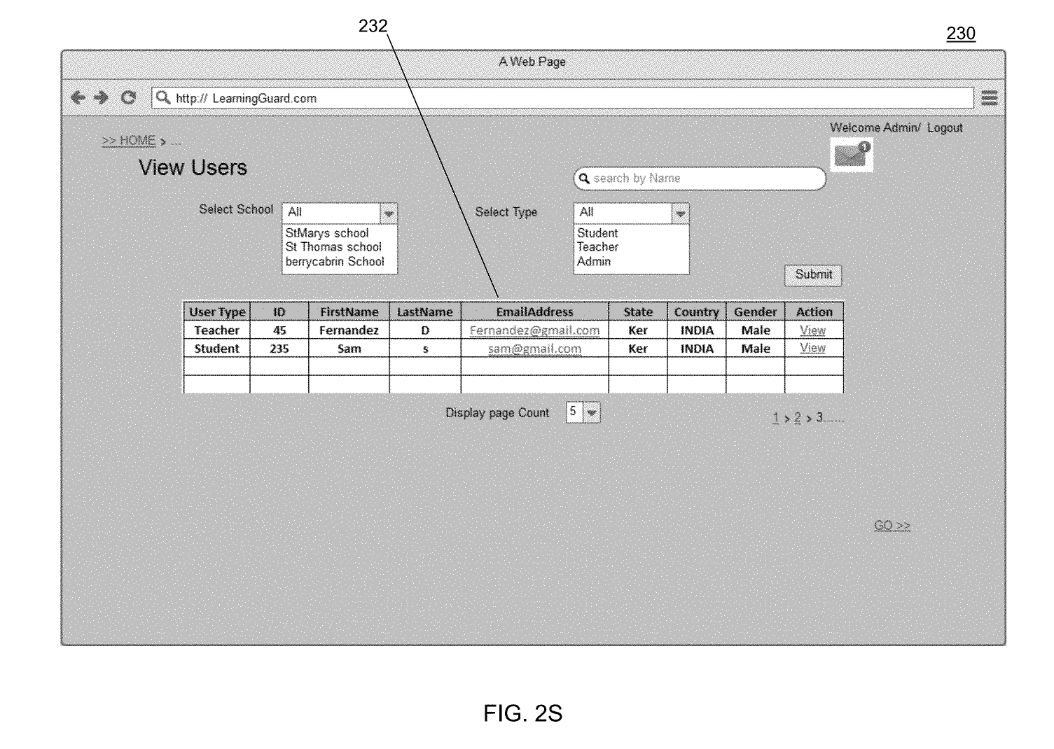

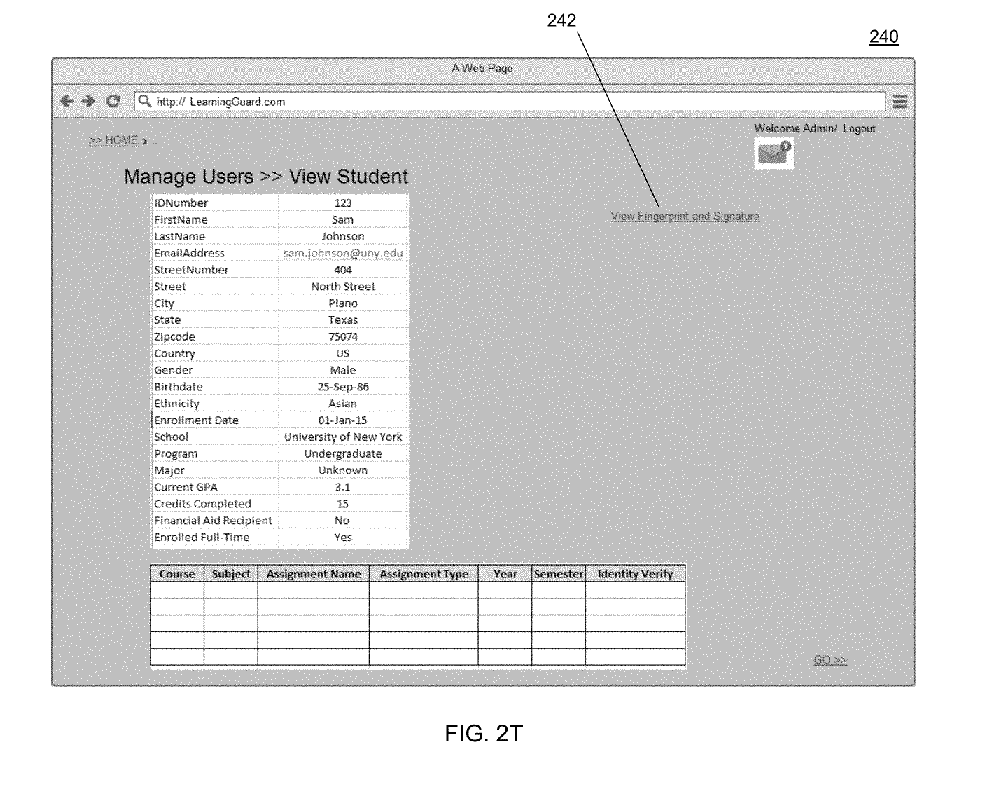

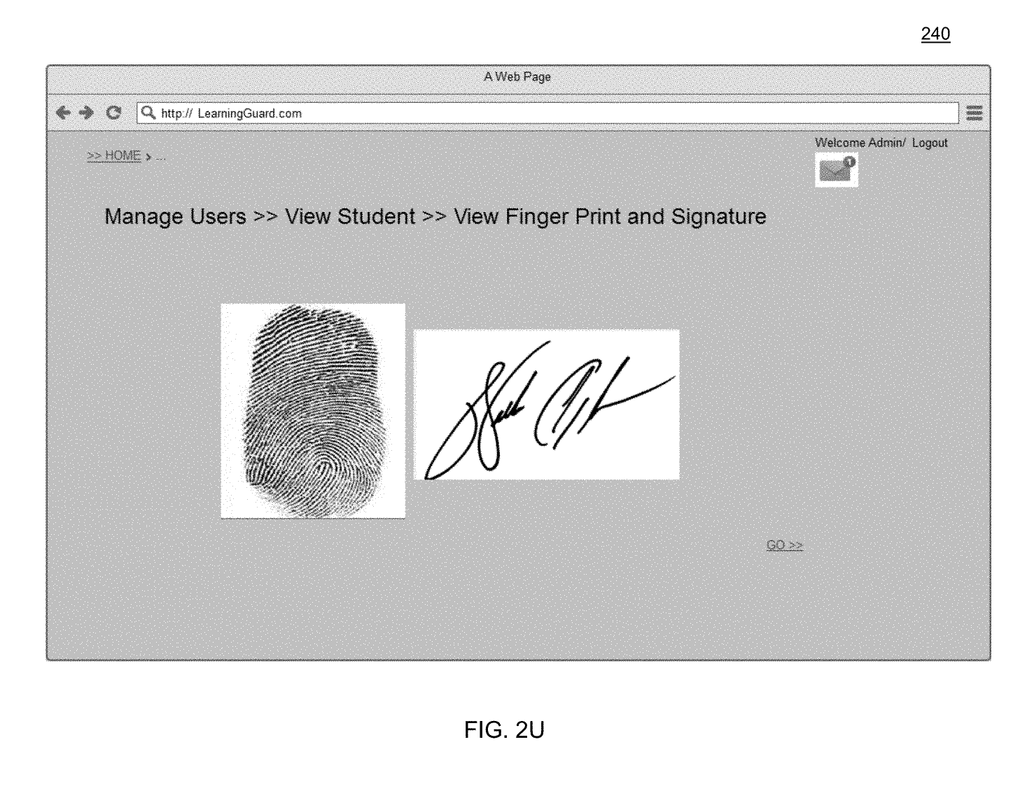

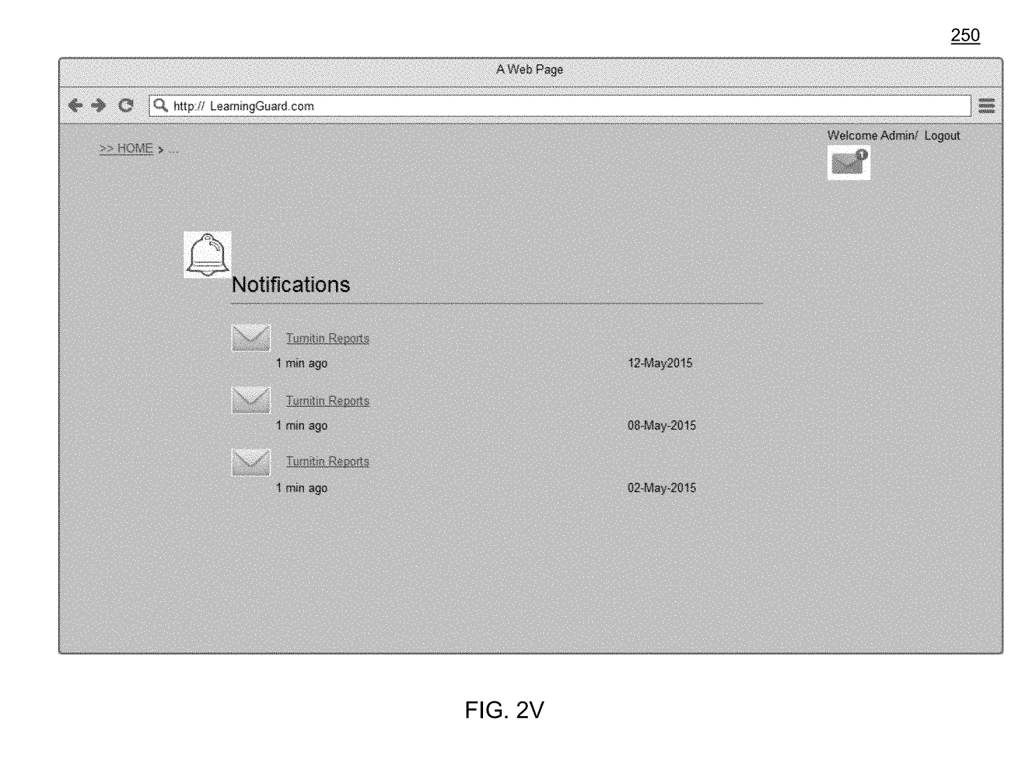

FIGS. 2A-2V are a series of screenshots of the graphical user interface used by an overall system administrator for implementing the system and method for cheating and fraud prevention for various academic institutions and organizations. FIG. 2A is the welcome screen 60 for administrative staff that manage and control the overall system software and functions for client academic institutions and various other organizations and businesses. Clicking on the go link 62 brings up a login screen and process which is similar to that shown in FIG. 1A. Upon a successful login the dashboard 65 of screenshot 64 appears on a user device. The dashboard 65 has selection links to the following functions: manage forms 66, manage cheating instances 67, view users 68, manage schools and organizations 69, view traffic using the website and cloud resources 70, notifications 71, manage reports 72, manage manuals 73, configure general templates 74, configure cheating instances 75, sample statistical reports 76.

FIG. 2C is a screenshot 80 of a page for managing and editing of forms used by the administrative staff to provide affirmation forms to schools and organizations that subscribe or use the inventive software. The affirmation form in the illustrative example is for a student that is registering at a school. FIG. 2D is a screenshot 82 that shows the uploading of documents and manuals to a sever that may be accessed by or sent to client schools or organizations, as well as students and members of the schools or organizations. FIG. 2E is a screenshot 84 for generating the cheating instance list with entry of violation types into a table or list held in a server database. The manage cheating instances screen 88 shown in screenshot 86 of FIG. 2F allows administrative personnel to study and form a table of instances of cheating and fraud at subscribing schools and organizations by date and violation type. The manage schools screen 90 in FIG. 2G is a screen to add or delete schools from using the inventive software services. Information for the school may be entered in fields 92, and is formatted into a lookup table 94 with a school ID assigned. The view school screen 100 in FIG. 2H allows an administrator to view academic information including courses for a selected school or organization identified by name and with a school ID 102 in a table 104. Selection of the view student list link 106 sends the user to the student list screen 130 shown in FIG. 2J with a table of students 132, and the selection of the view teachers list link 108 sends the user to view teachers list screen shown in FIG. 2I that provides a listing of teachers in a table 122. The view administrator link 110 allows the user to view who the administrators are at the school. The view assignment link sends the user the view assignment page 140 of FIG. 2K with a table 142 that provides detailed information on an assignment including assignment name, assignment type, plagiarism check, assignment value, department, subject, course, year, semester, course type, and who created the assignment. The view report link 144 allows the user to view a report about the assignment as shown in view report screen 150 of FIG. 2L. The table 152 provides the name of the student, when and if the affirmation was completed, whether their identity was verified, and when and if the assignment was submitted.

FIG. 2M and FIG. 2O illustrate a suspicious activity report page 160 and 190, respectively. The user may select the type of report 162 (the example shown is for a plagiarism checking package shown in FIG. 2N), select status 164 (confirmed or waiting for confirmation), select school 166. The table 172 provides detailed information student ID, assignment name, assignment type, assignment value, department, subject, course, year, semester course type, status (confirmed or waiting for confirmation) and action (view report). The view daily reports link 168 sends the user to the daily reports page 220 shown in FIG. 2R. The view protected reports link 170 sends the user to the view protected reports page 210 that is shown in FIG. 2Q. FIG. 2P shows a filed incident report 200 initiated by a proctor who observed an infraction during an exam. FIG. 2S shows a screenshot 230 with a table 232 showing student users, while FIG. 2T shows information on screenshot 240 of a specific selected student from the student table 232. The view fingerprint and signature link 242 sends the user to FIG. 2U where a student's fingerprint and signature are available for verification. FIG. 2V is a screenshot of a listing of notifications 250 that new reports have become available.

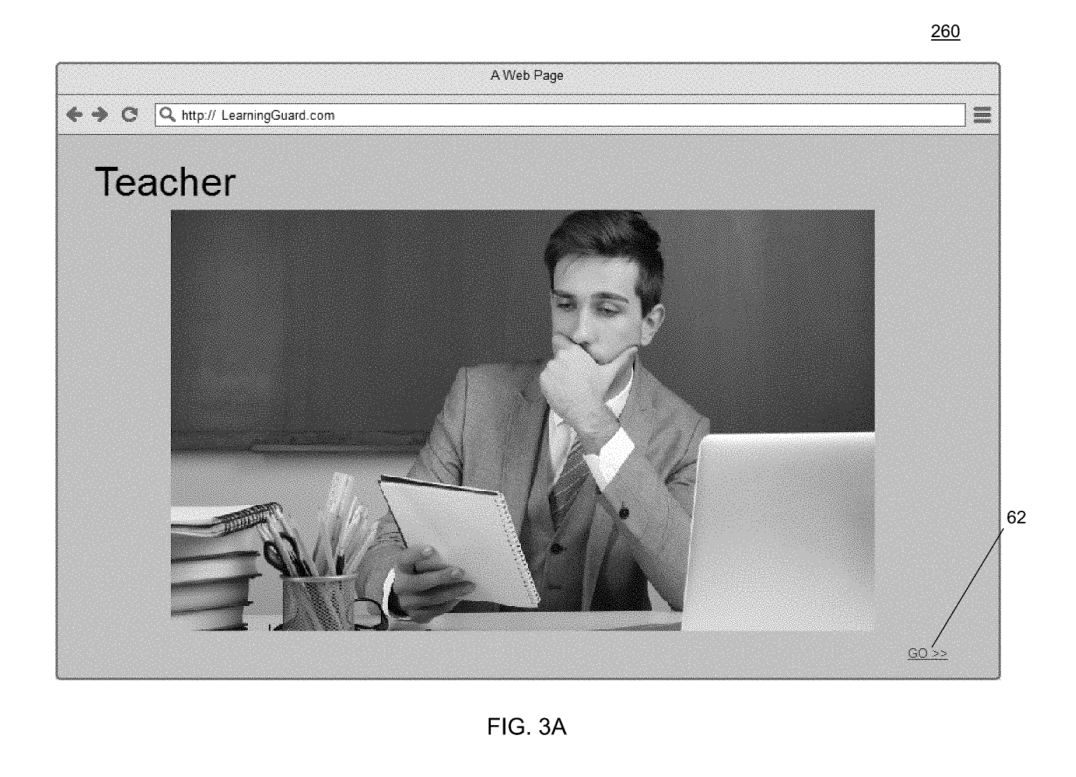

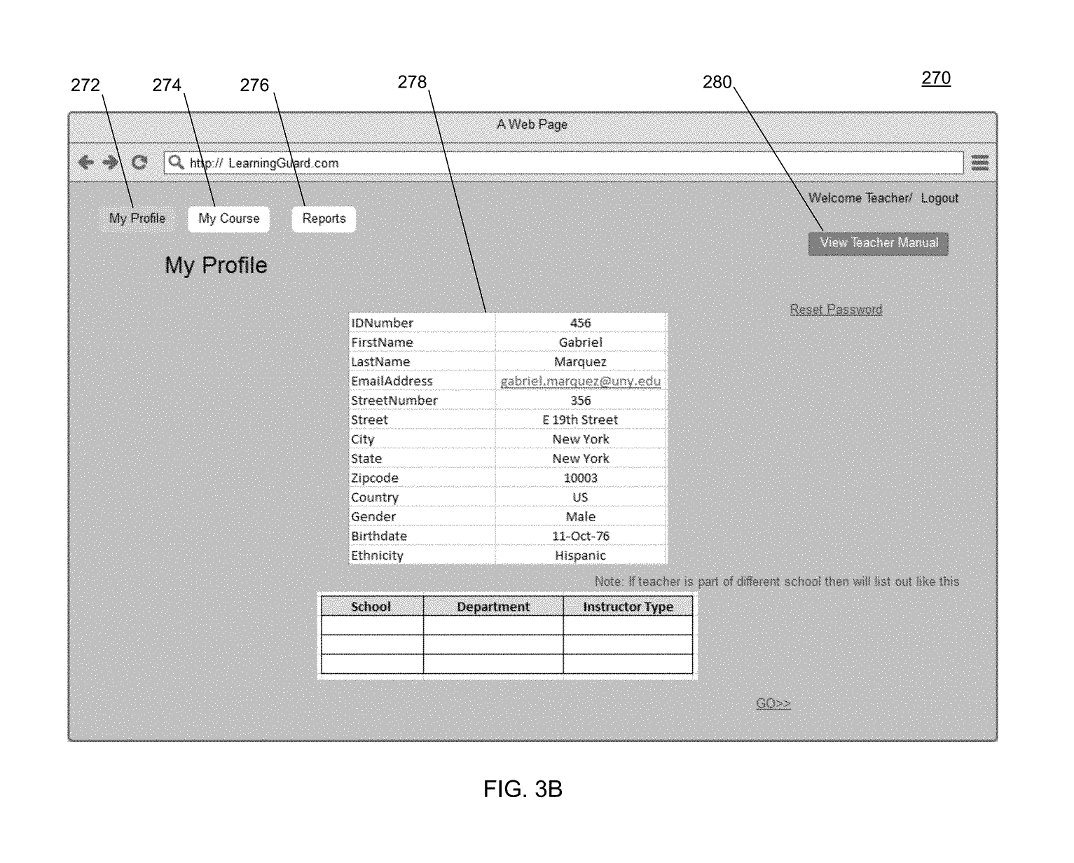

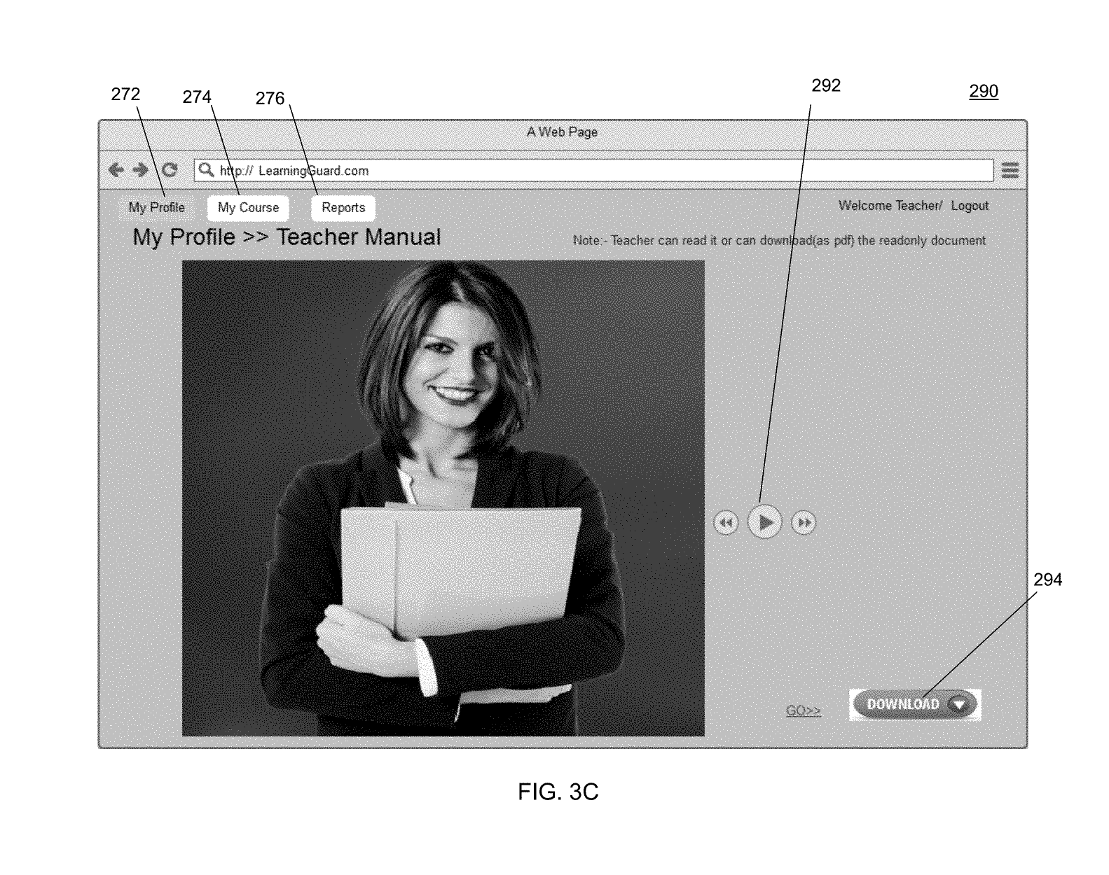

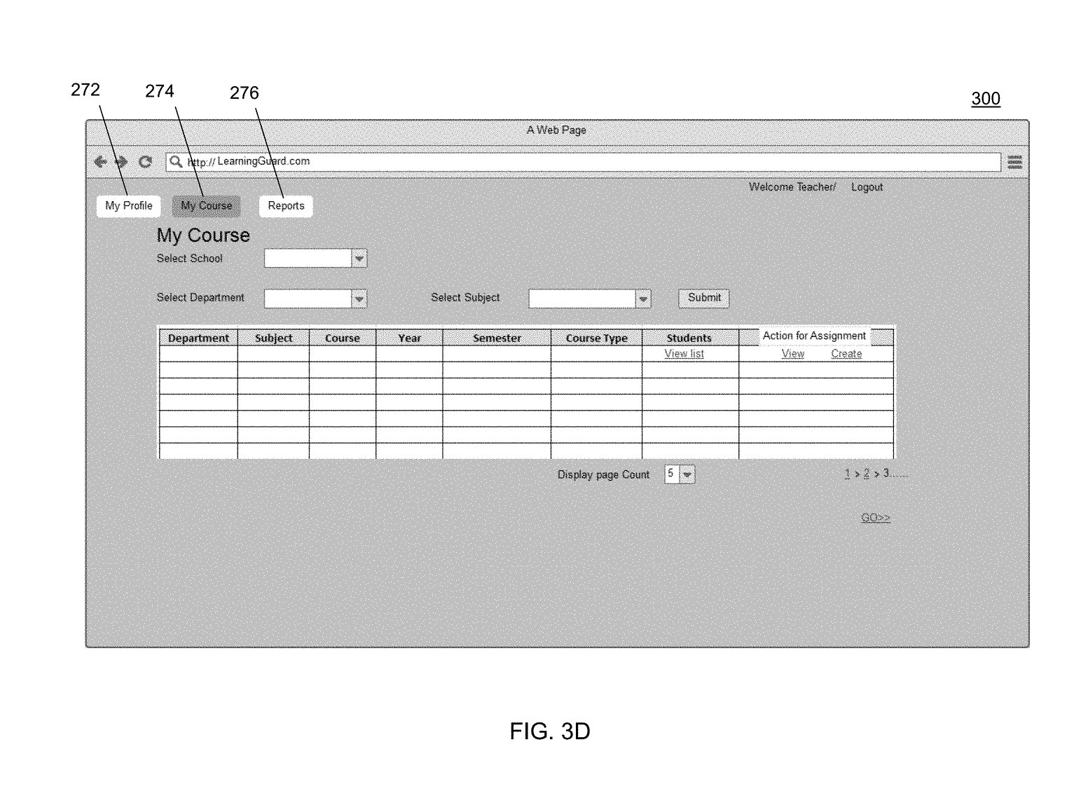

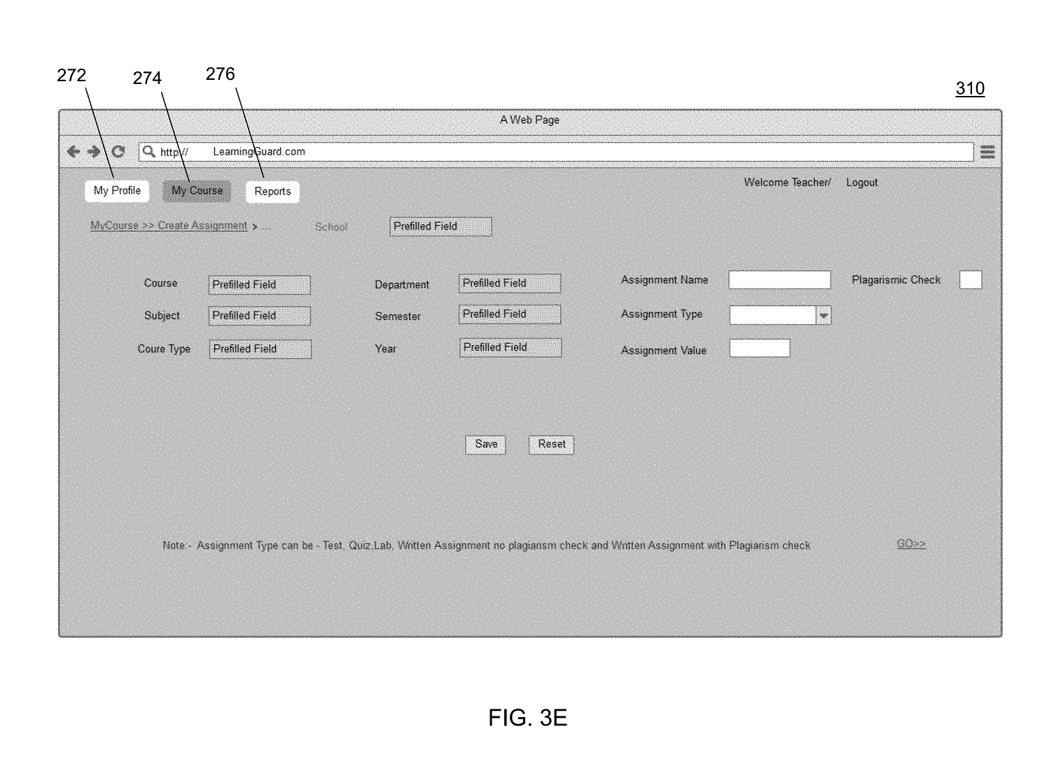

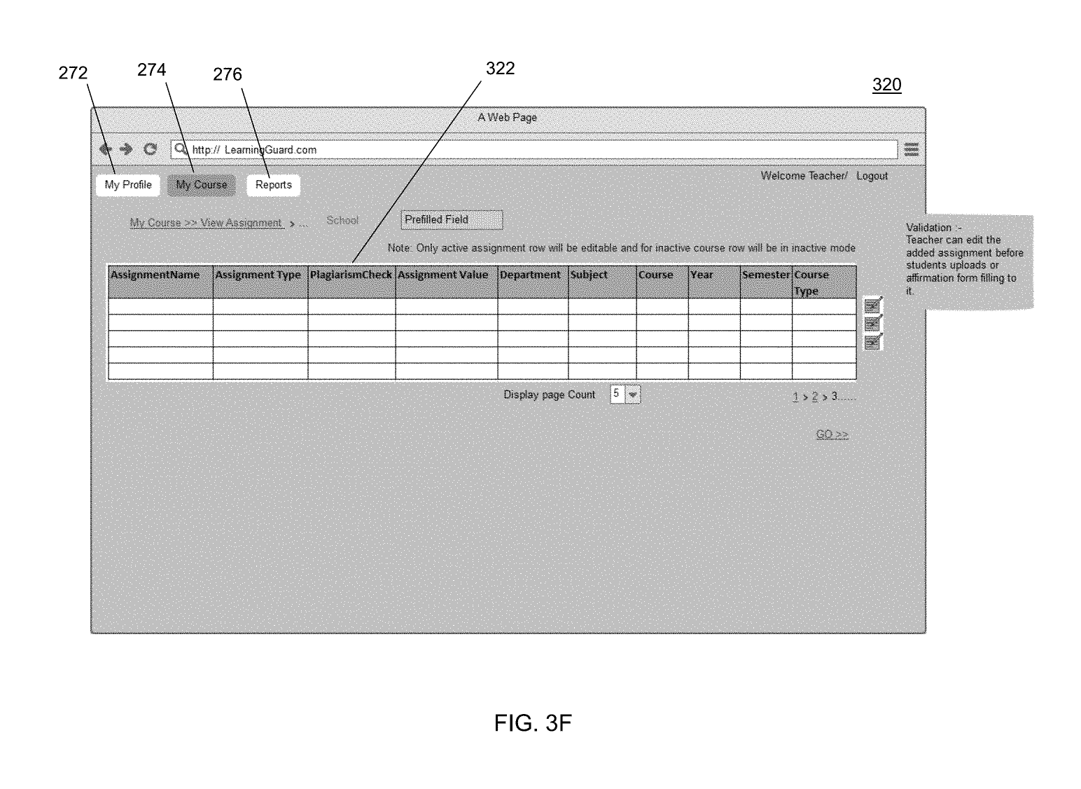

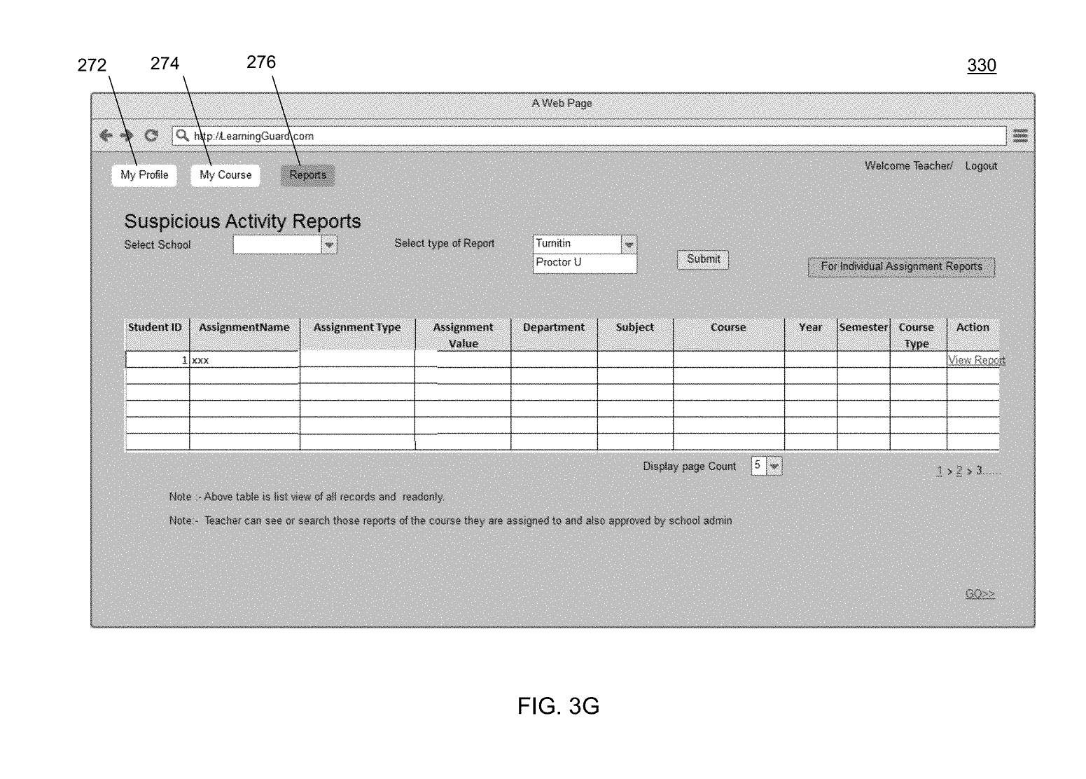

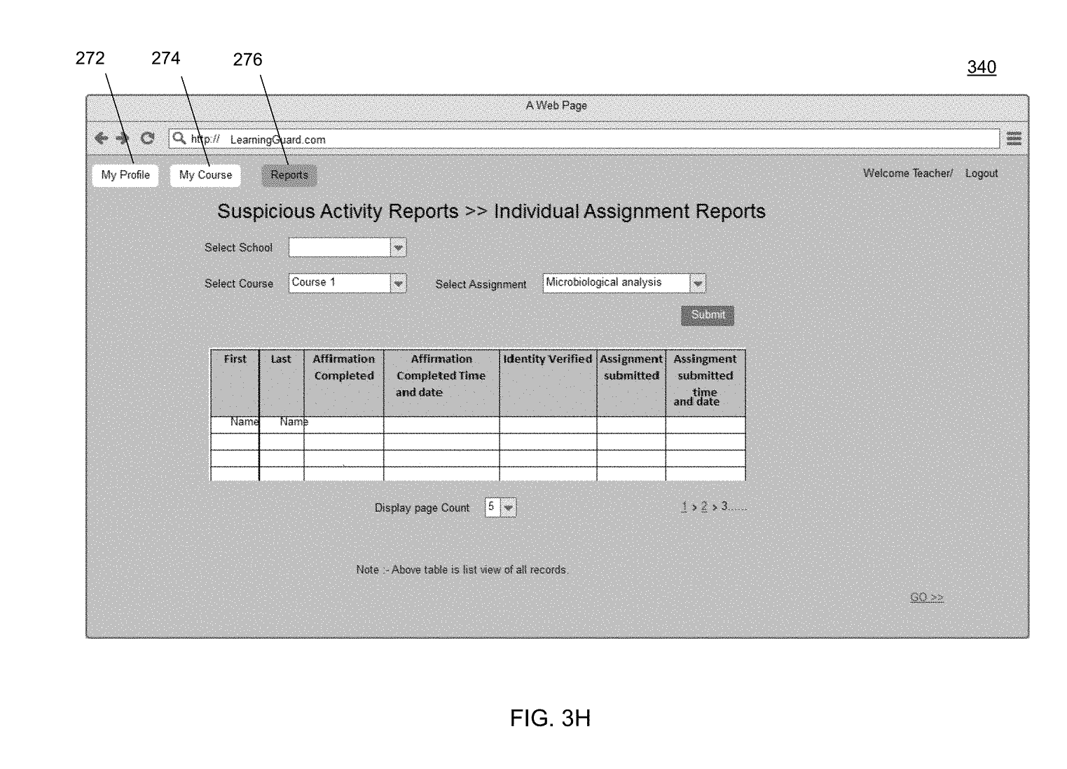

FIGS. 3A-3H are a series of screenshots available to a teacher to manage their classes and monitor for cheating and fraud. FIG. 3A is the welcome screen 260 for teachers. Clicking on the go link 62 brings up a teacher login screen and process which is similar to that shown in FIG. 1A. Upon a successful login the teacher begins at their profile page 270 as shown in FIG. 3B. with the my profile tab 272 selected. Profile table 278 has information on the teacher. The view teacher manual button 280, when selected, sends the user to the teacher manual page 290 as shown in FIG. 3C. a video may be played with button 292, and the teacher manual may be obtained with download button 924. FIG. 3D shows page 300 with the course(s) taught by the teacher. FIG. 3E shows an assignment creation page 310. FIG. 3F provides a table 322 with additional details about the assignment on page 320. FIG. 3G shows a reports page 330 with suspicious activity. FIG. 3H is an individualized report 340 with additional information on the student involved in the suspicious activity.

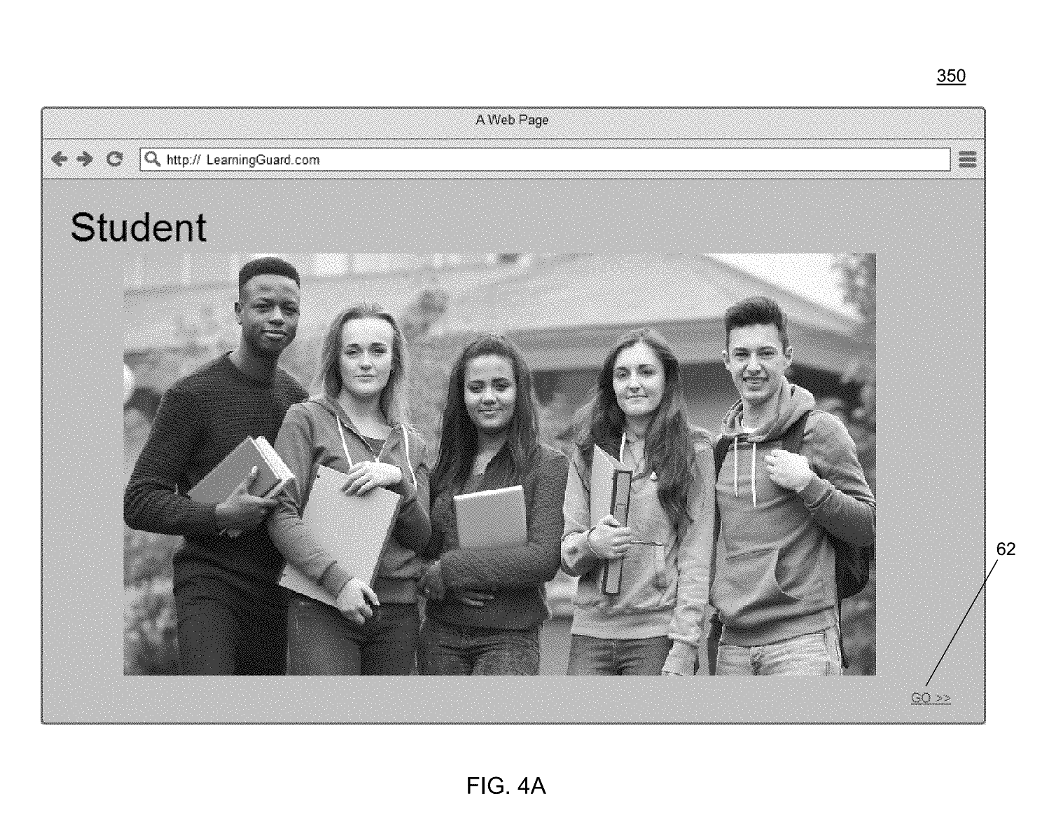

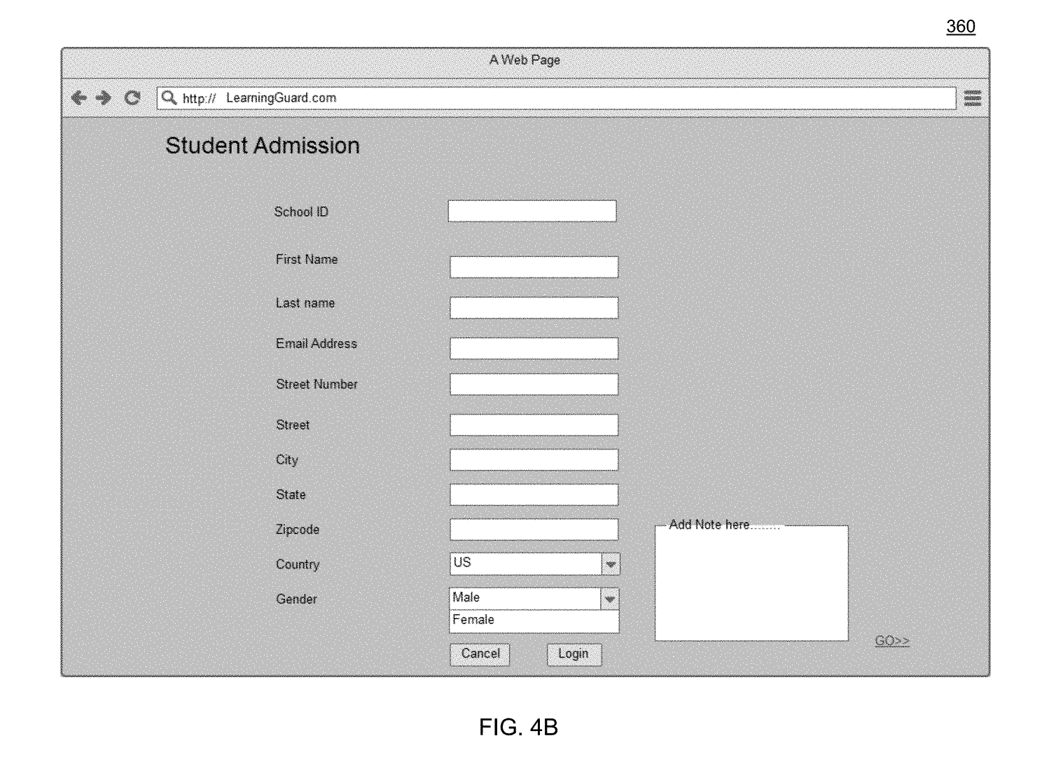

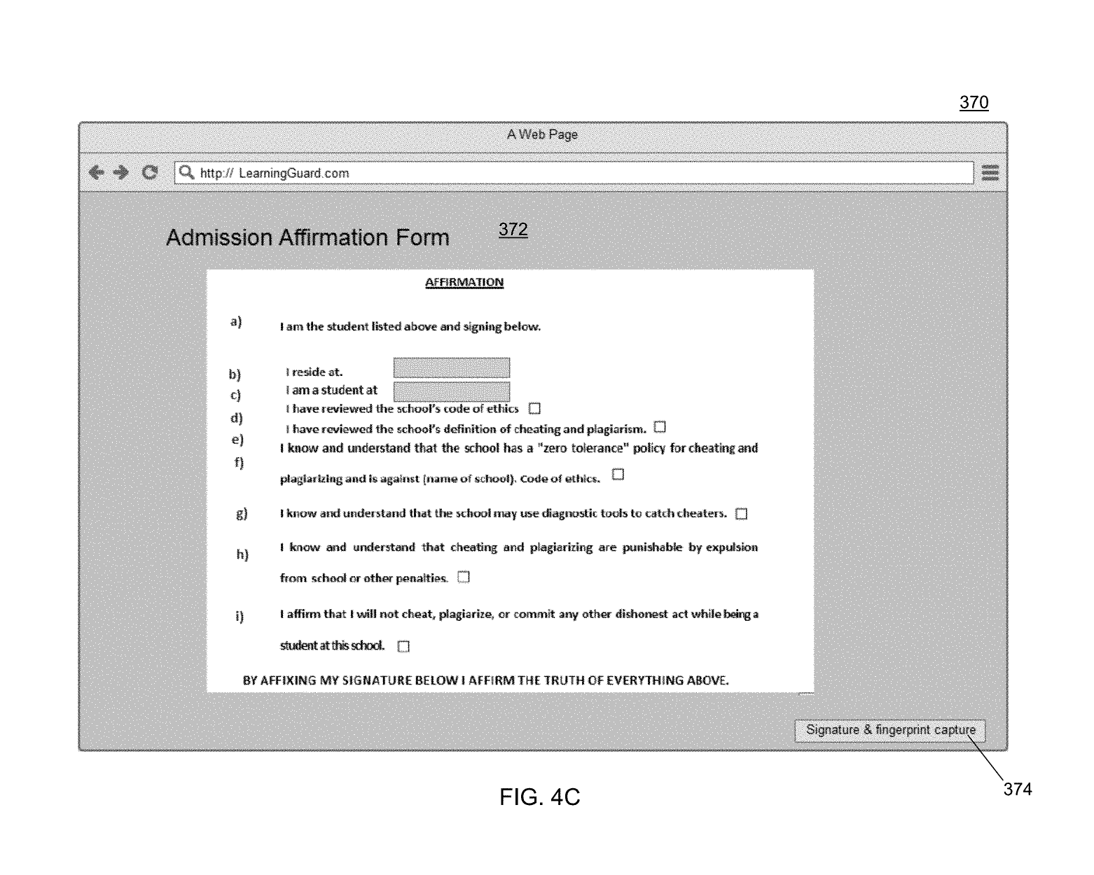

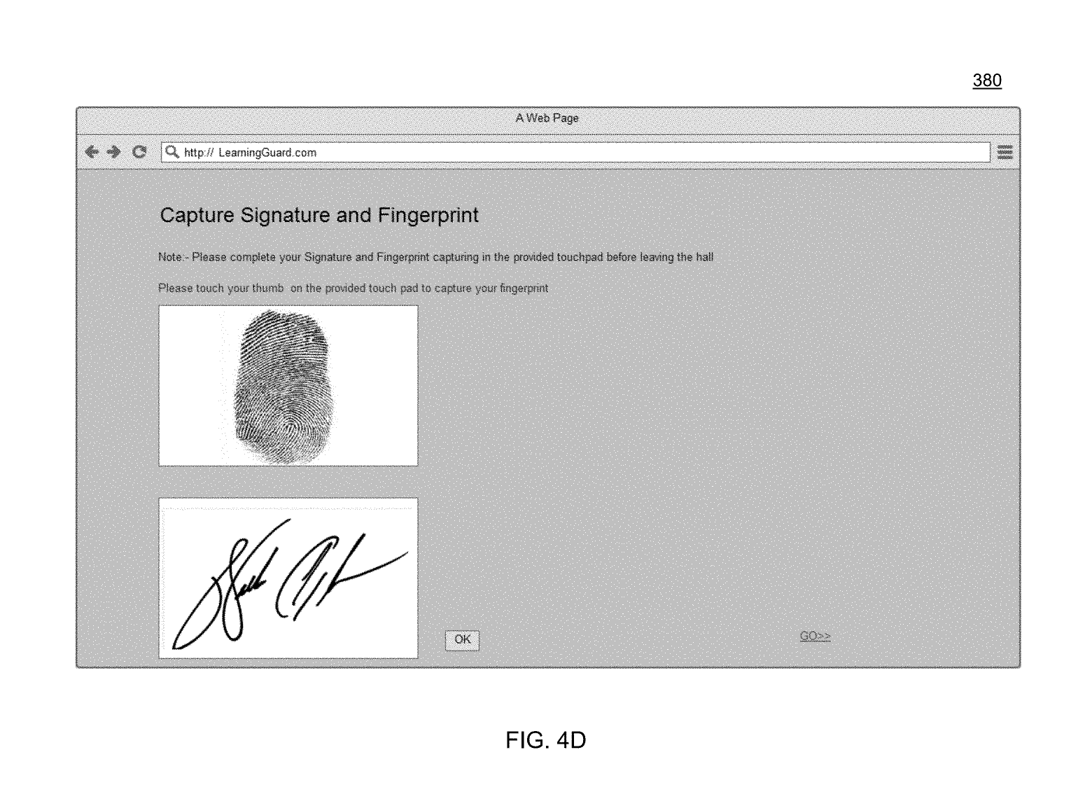

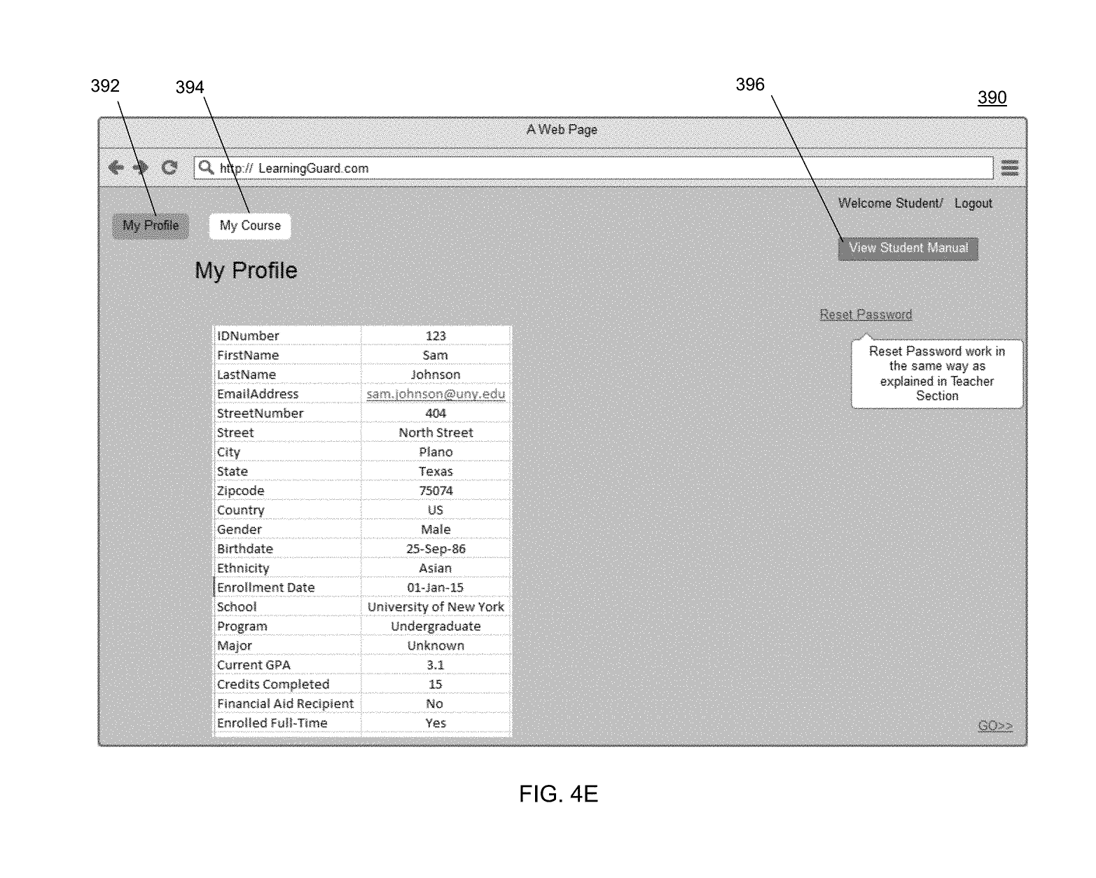

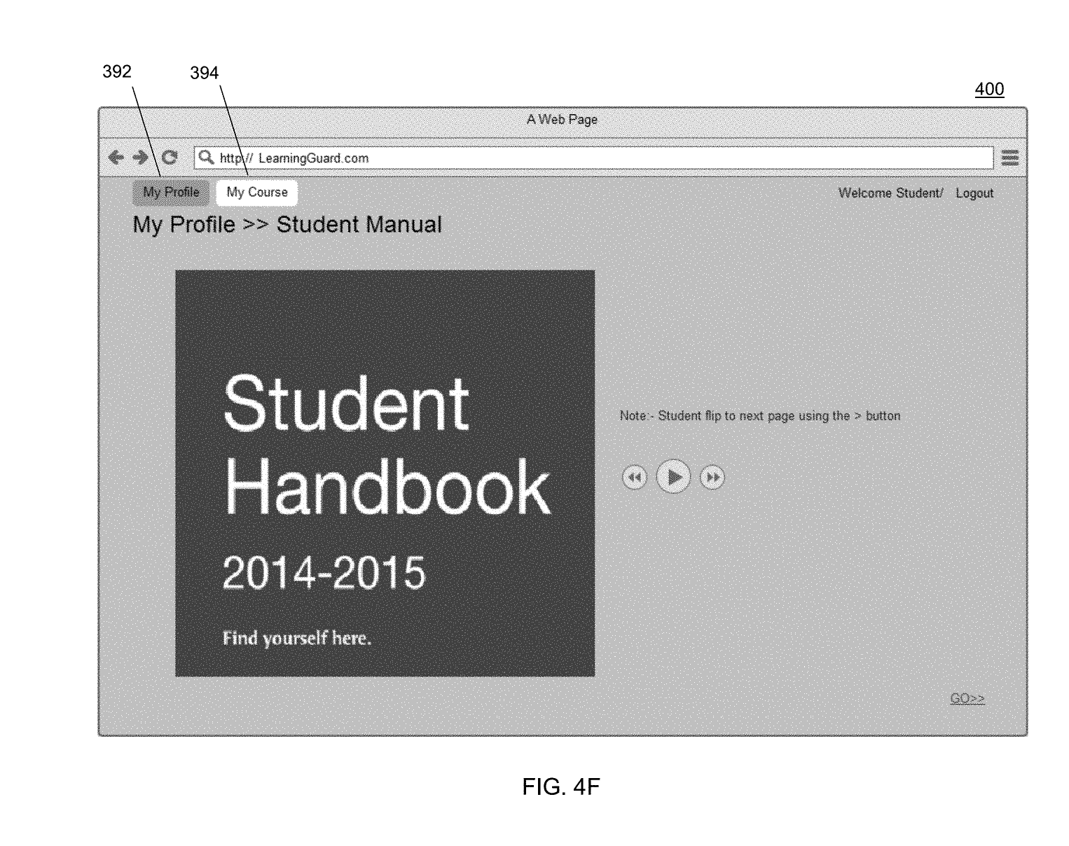

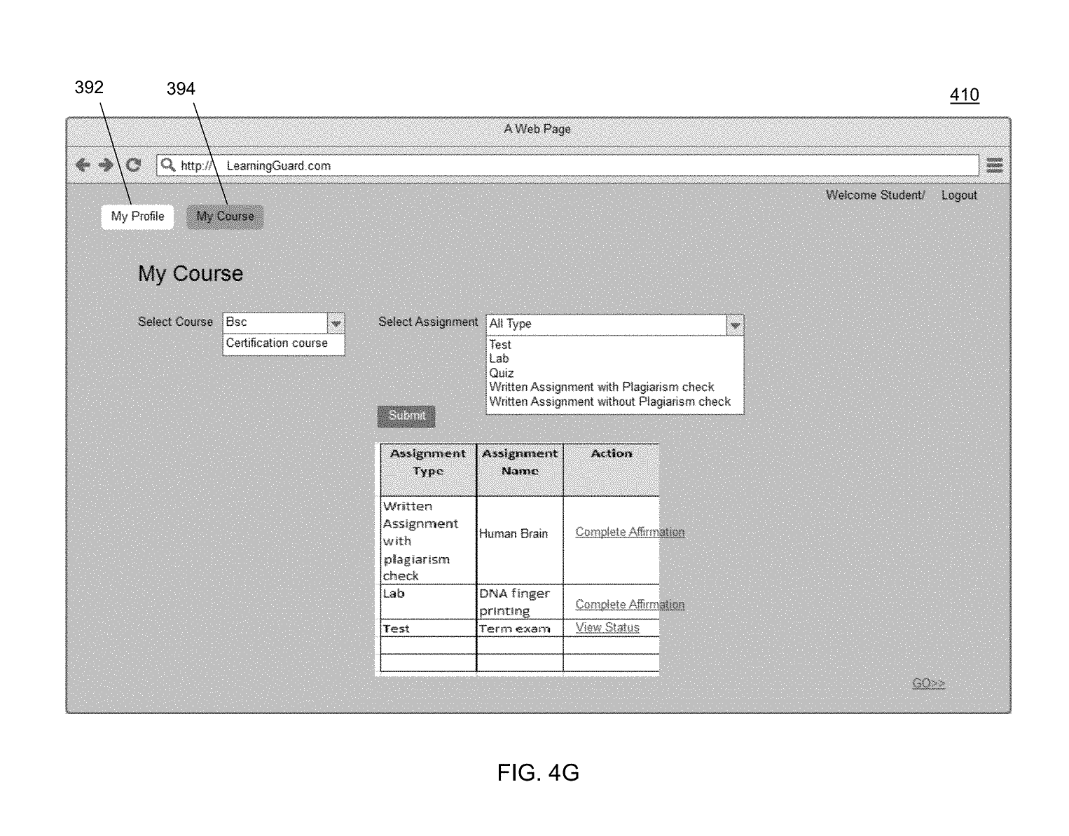

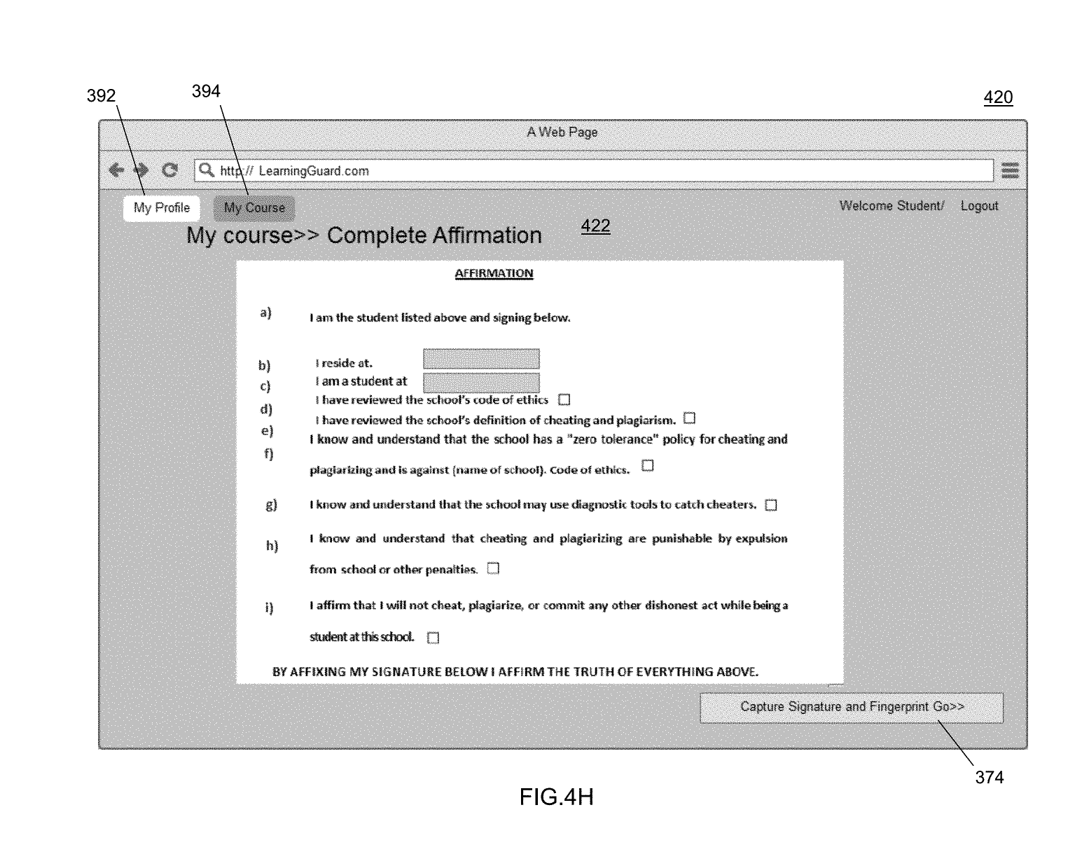

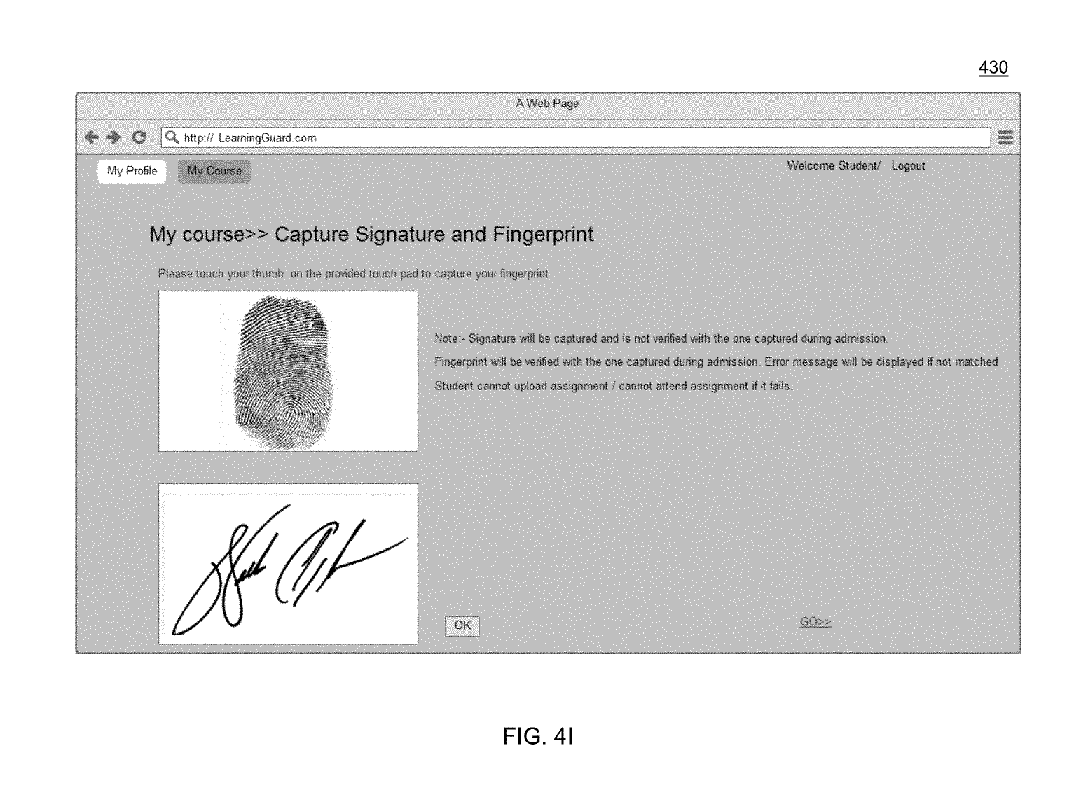

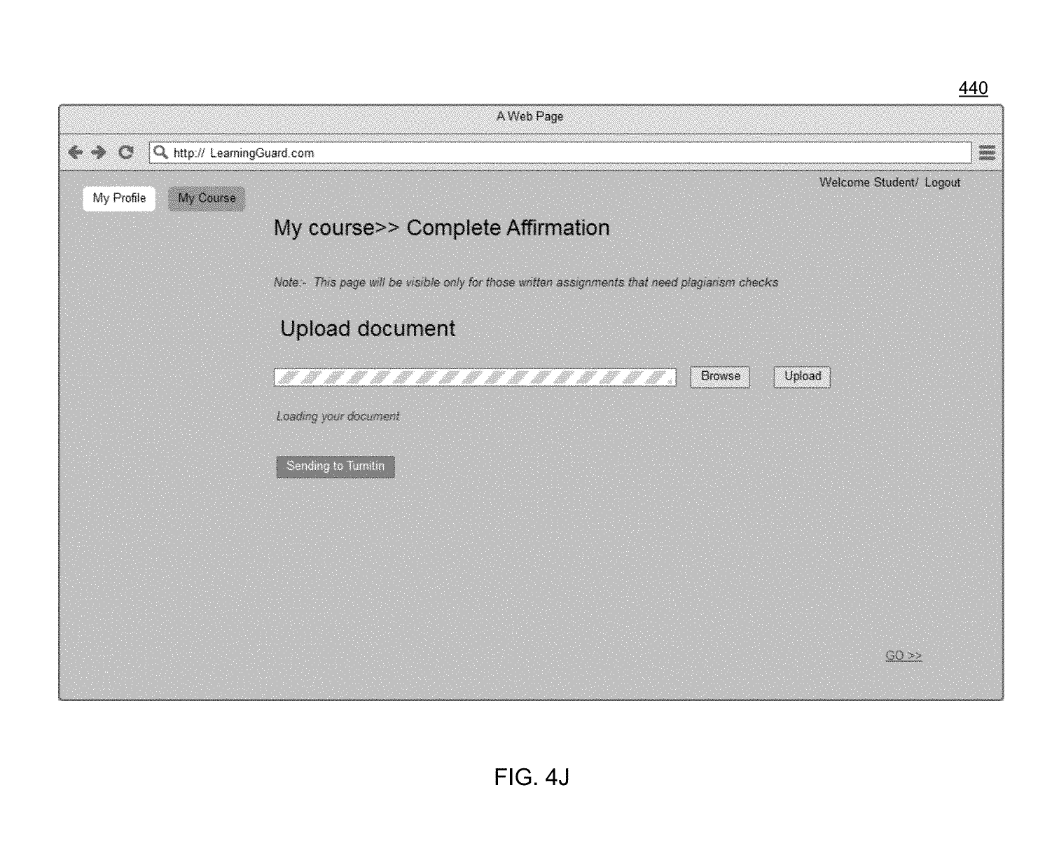

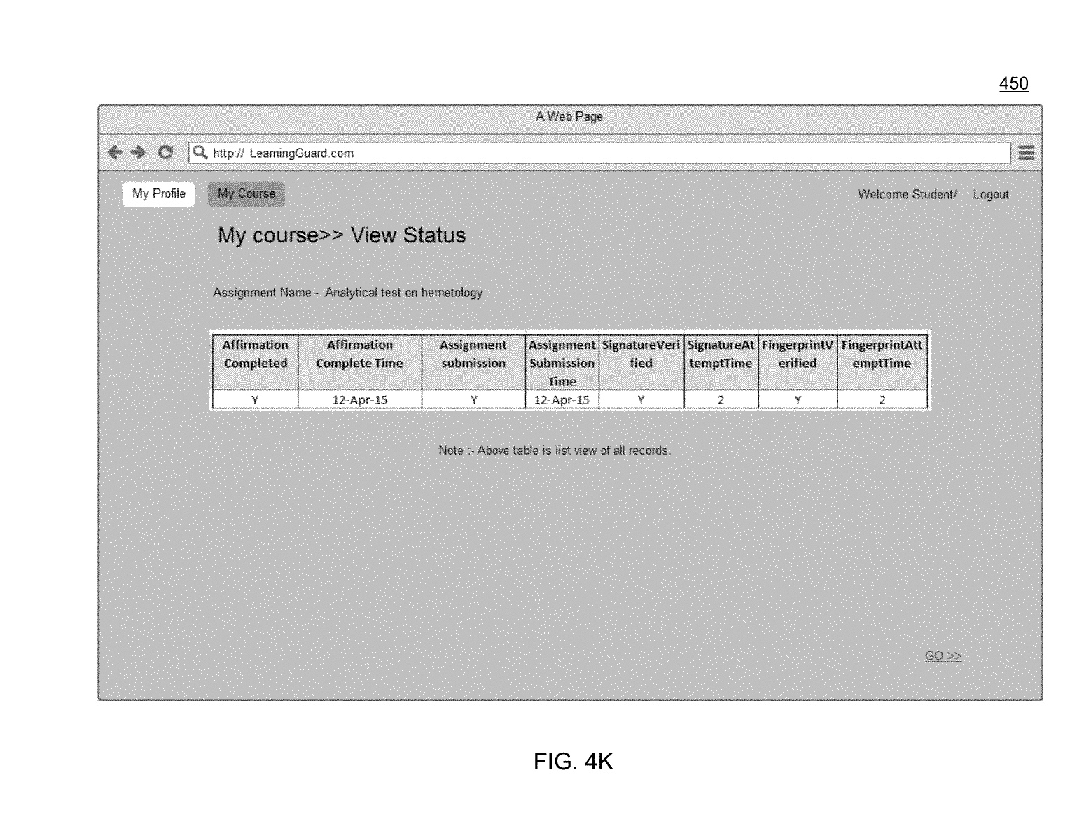

FIGS. 4A-4K are a series of screenshots available to a student to execute the affirmations and verifications required by the academic institution or organization they attend or are a member of FIG. 4A is the welcome screen 350 for teachers. Clicking on the go link 62 brings up a student login screen and process which is similar to that shown in FIG. 1A. Upon a successful login the student is directed to fill out the admission form on student admission page 360 of FIG. 4B. FIG. 4C shows page 370 with the admission affirmation form 372 that a student must read, complete, and acknowledge with their signature capture 374 and possibly also a fingerprint capture. It is noted that specific embodiment used by certain schools may or may not require a fingerprint. FIG. 4D shows screenshot 380 with the captured fingerprint and signature. It is noted that the student may be asked to complete the signature and fingerprint capturing on a provided touchpad before leaving the hall where the student is being admitted. FIG. 4E shows the student profile page 390. Selection of the view student manual button 396 sends the student to the student manual page 400 in FIG. 4F where the student can read the student manual online. FIG. 4G shows the my course page 410, and details what courses that the student is taking and what assignments require affirmations and the status of actions taking by the student. FIG. 4H shows page 420 with a complete affirmation 422 that the student acknowledges with signature and fingerprint capture. As shown in FIG. 4I the student is instructed to touch their thumb to the reader, and the student is advised that the finger print will be verified with the fingerprint scan obtained during admission on screenshot page 430. An error message will be displayed if the prints do not match, and the student will not be allowed to upload an assignment or can not attend an assignment. FIG. 4J shows upload screen 440 for a completed student affirmation. FIG. 4K provides a status page 450 so that a student may confirm that the proper affirmations have been completed for a specific assignment.

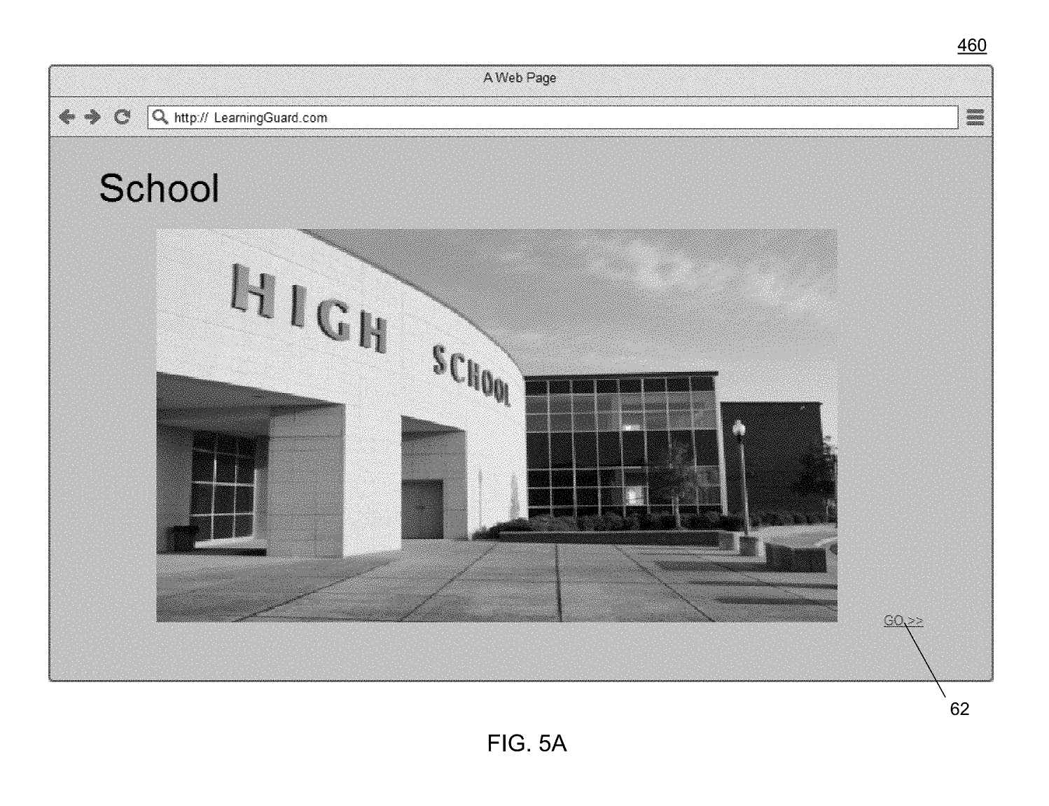

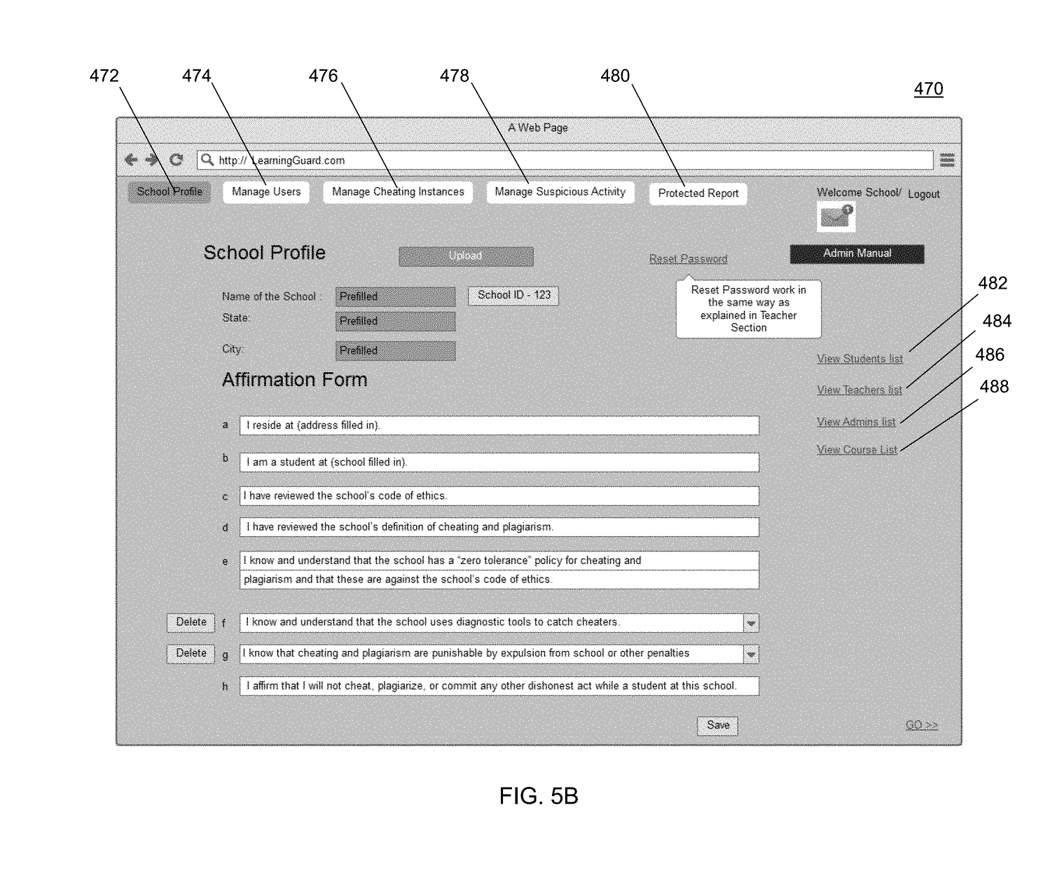

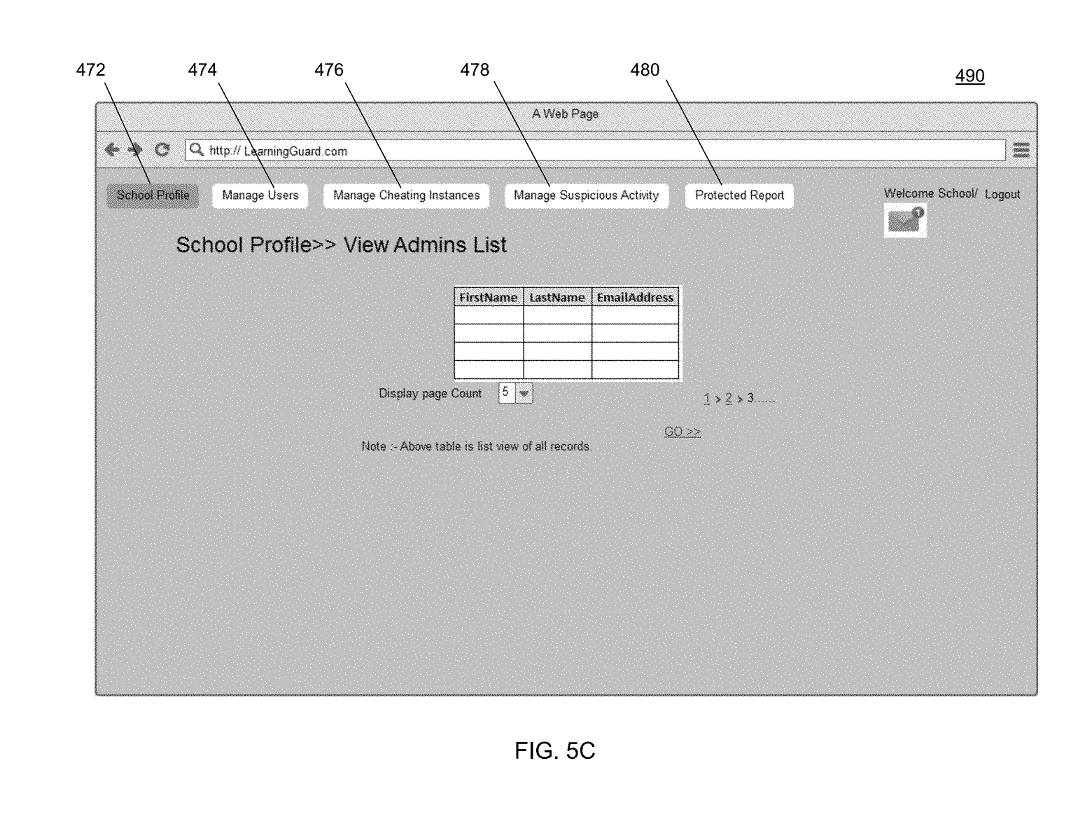

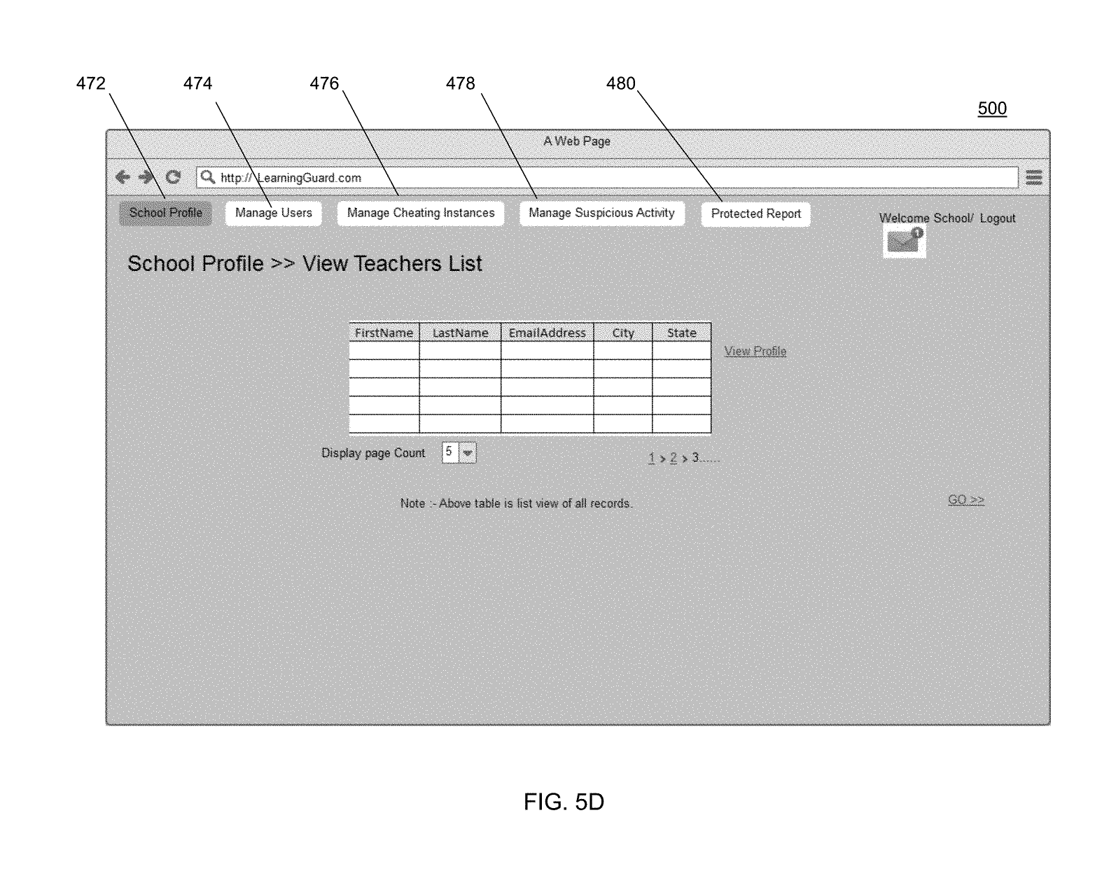

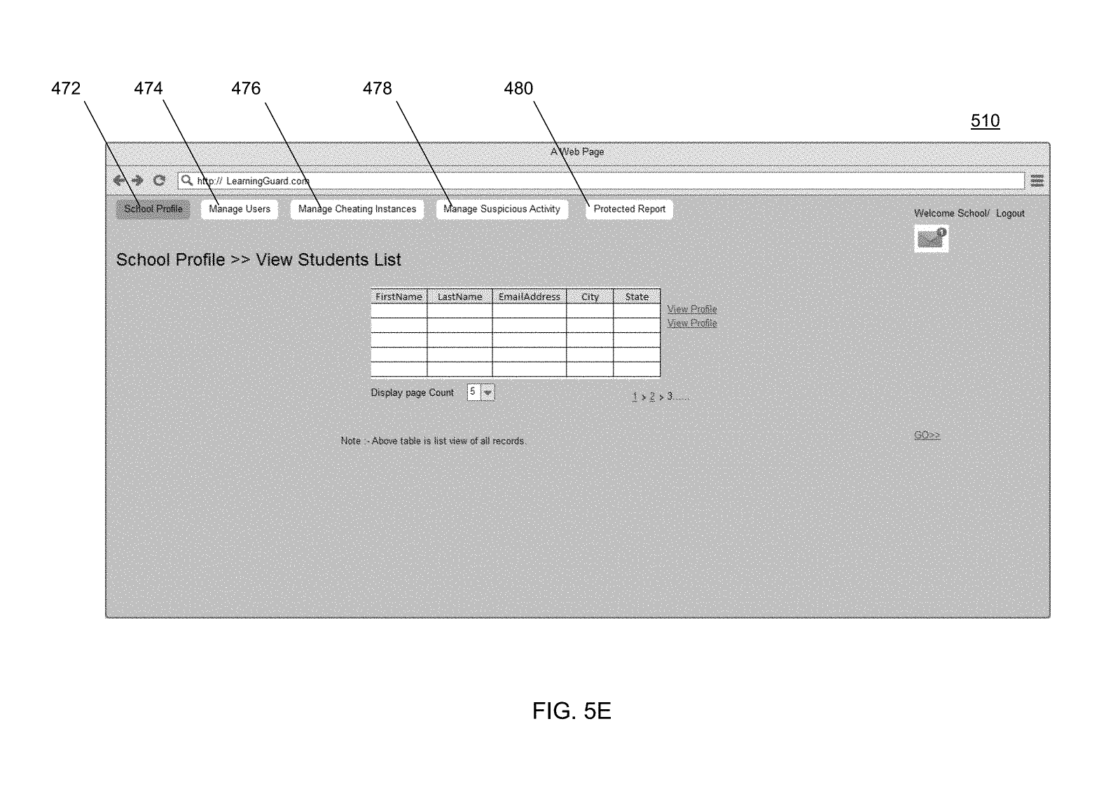

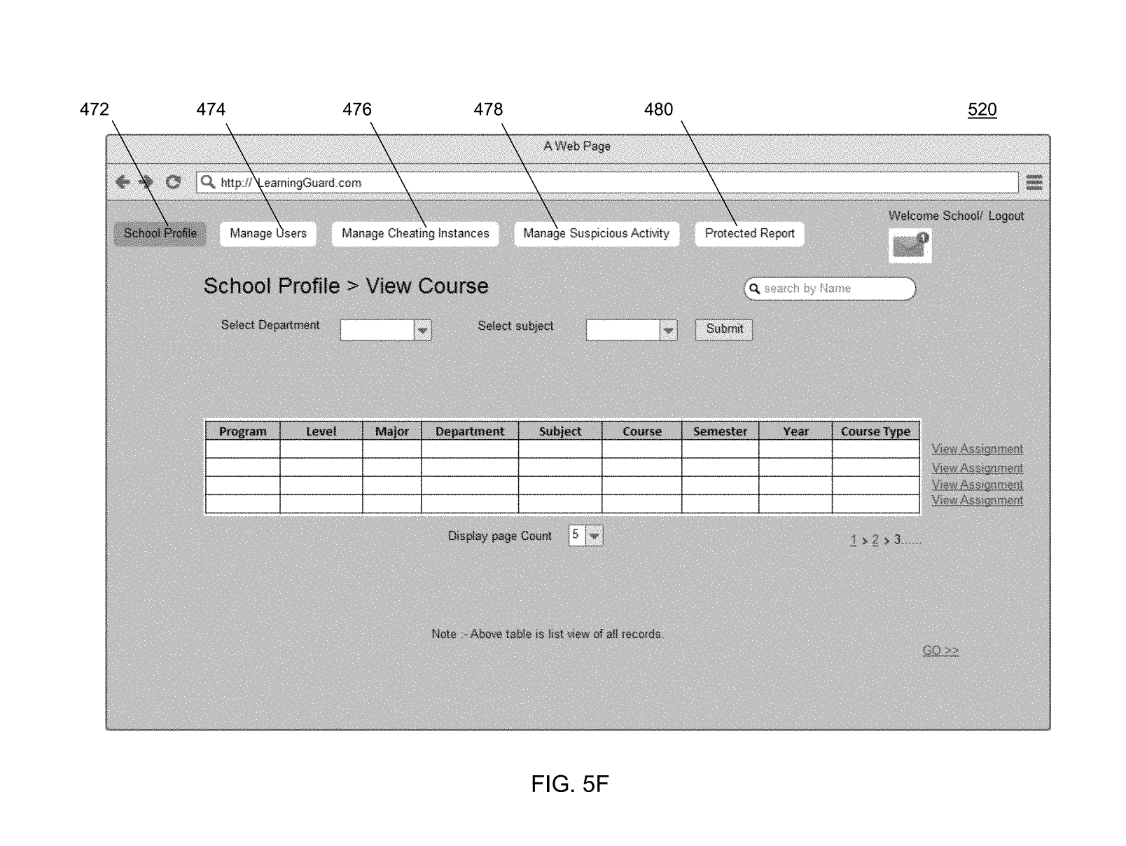

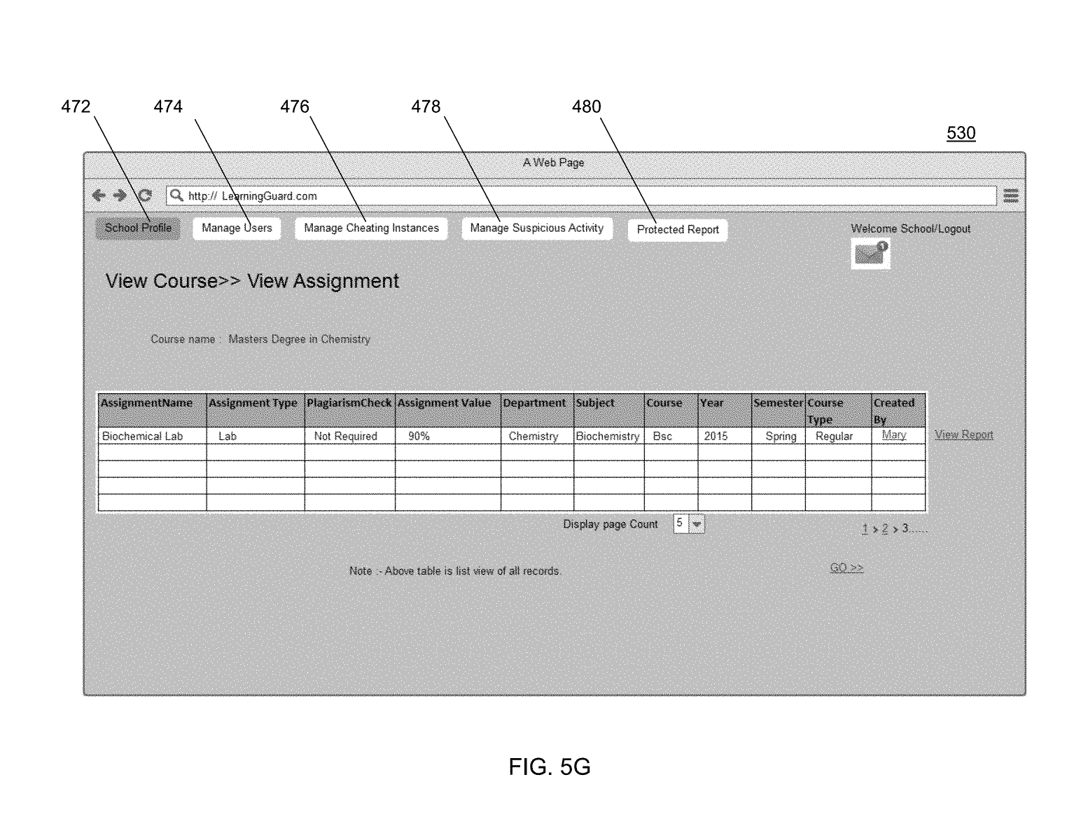

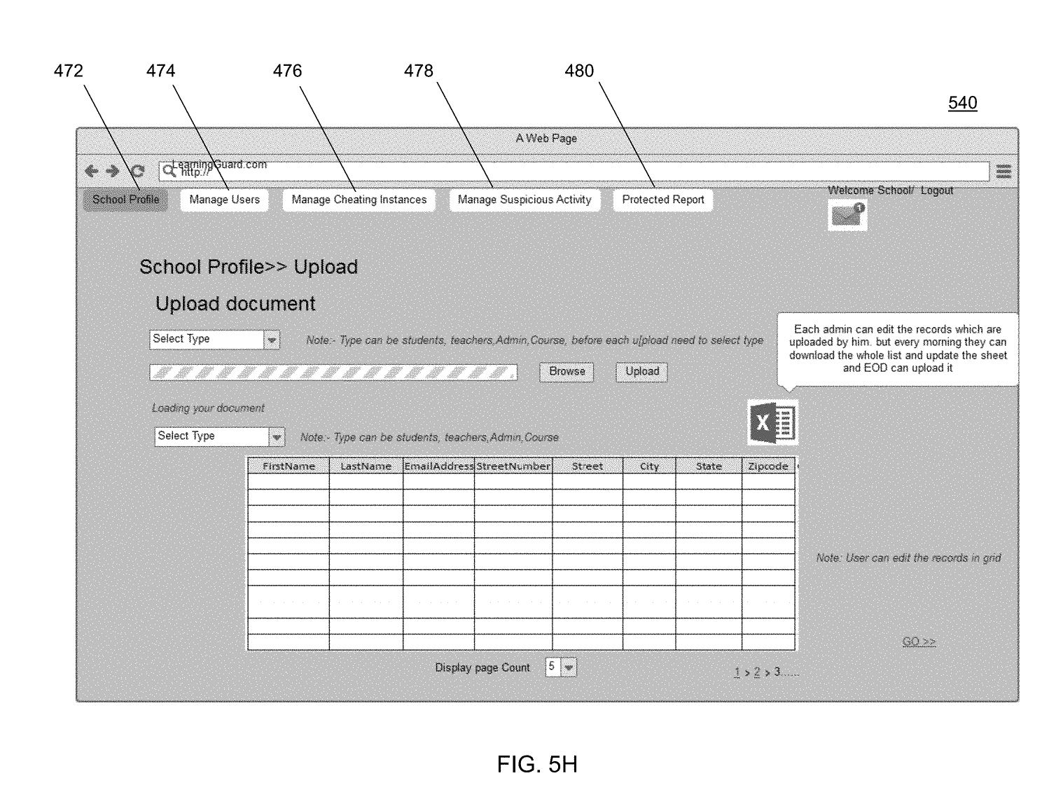

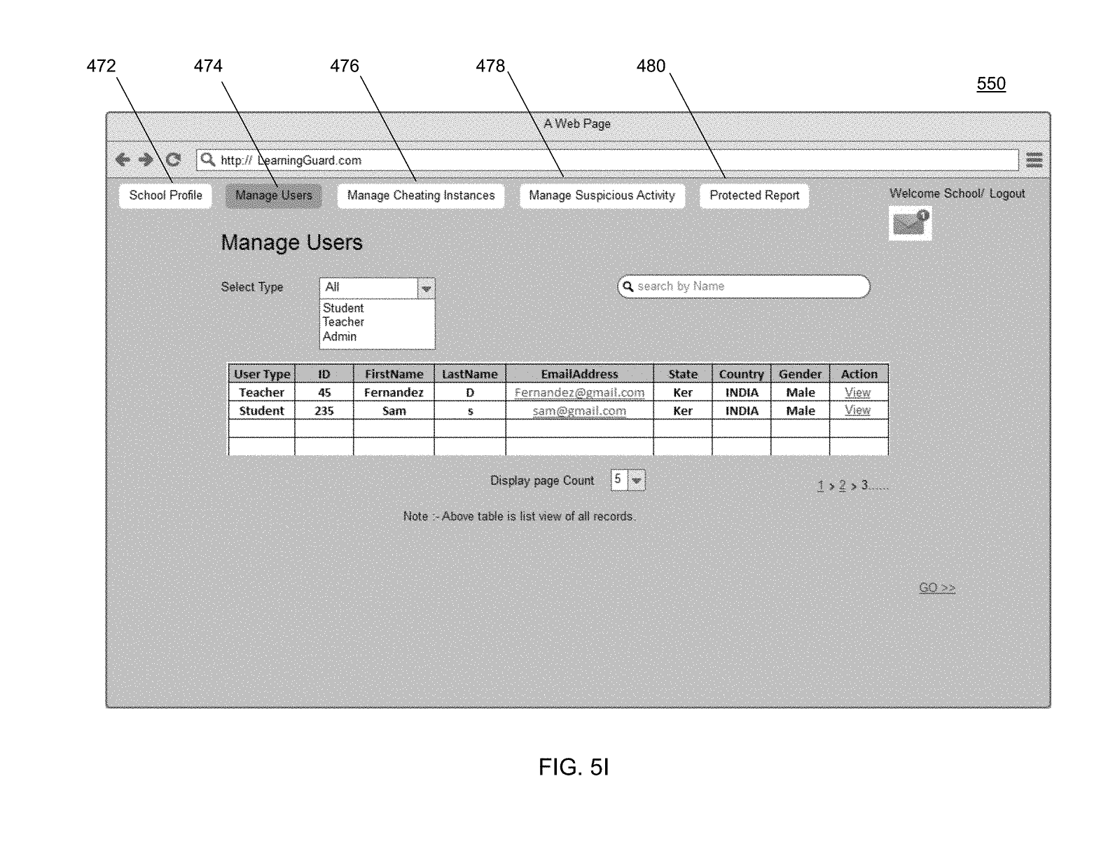

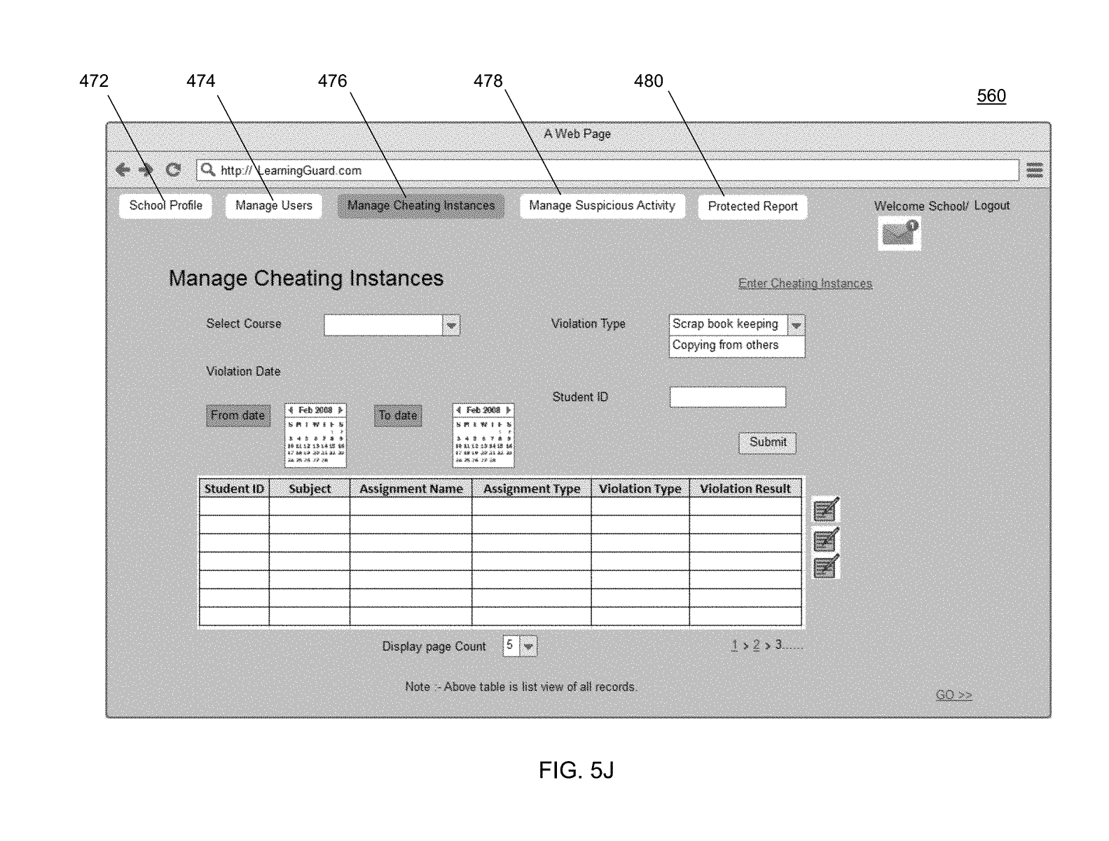

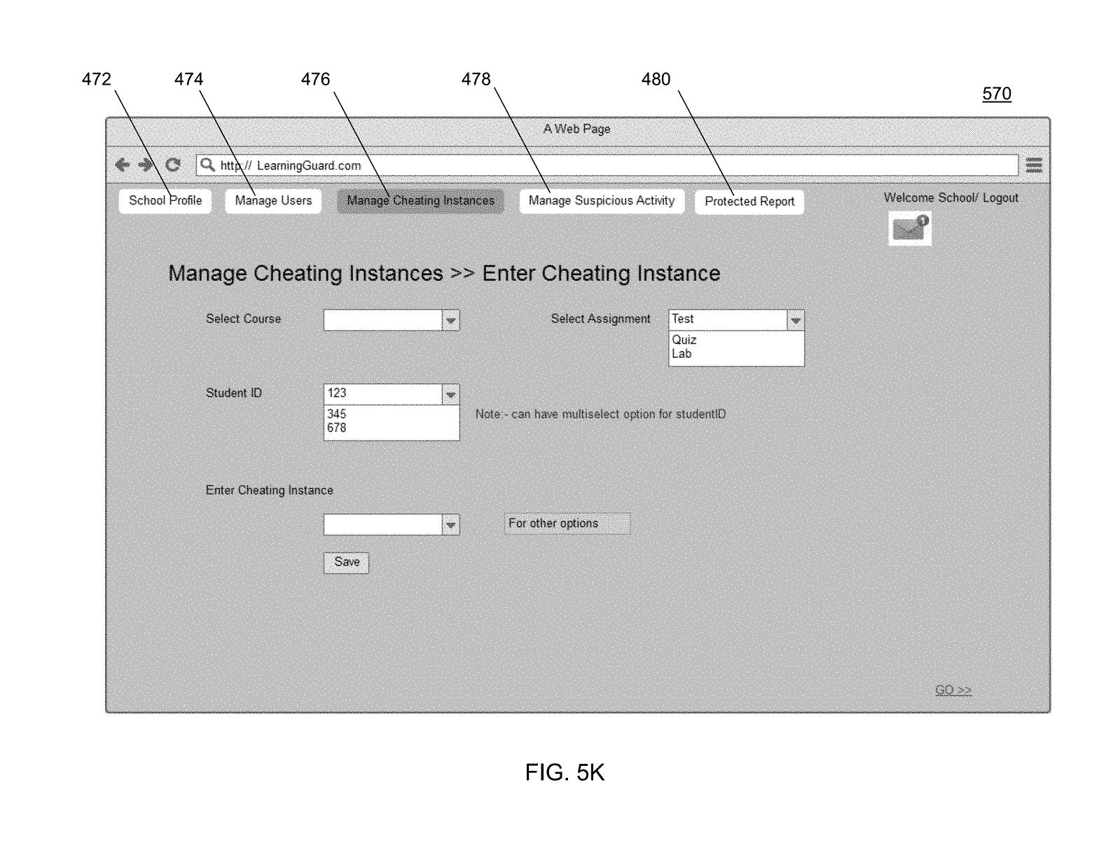

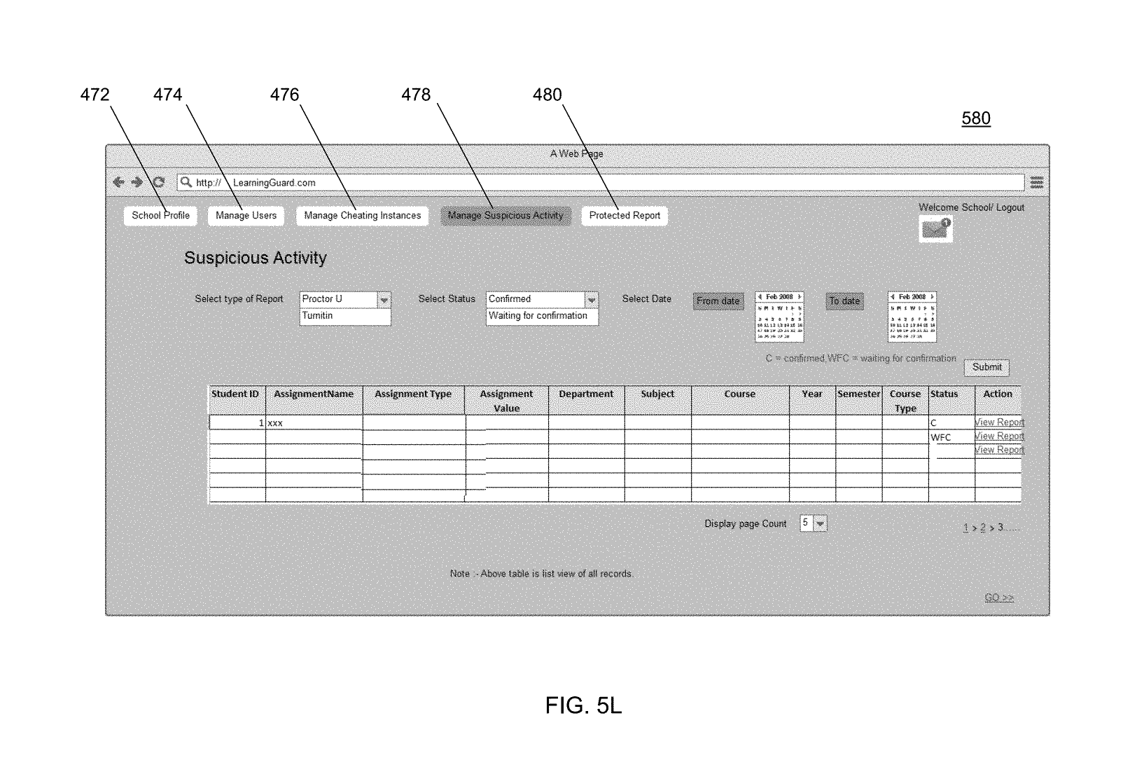

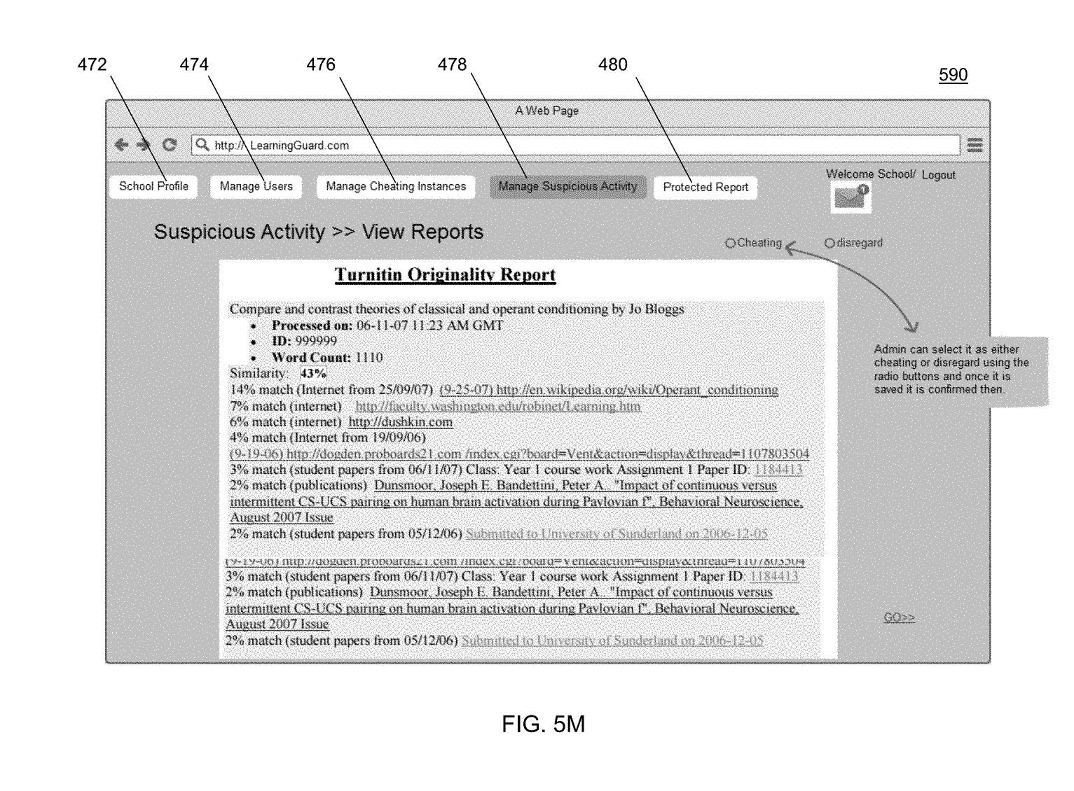

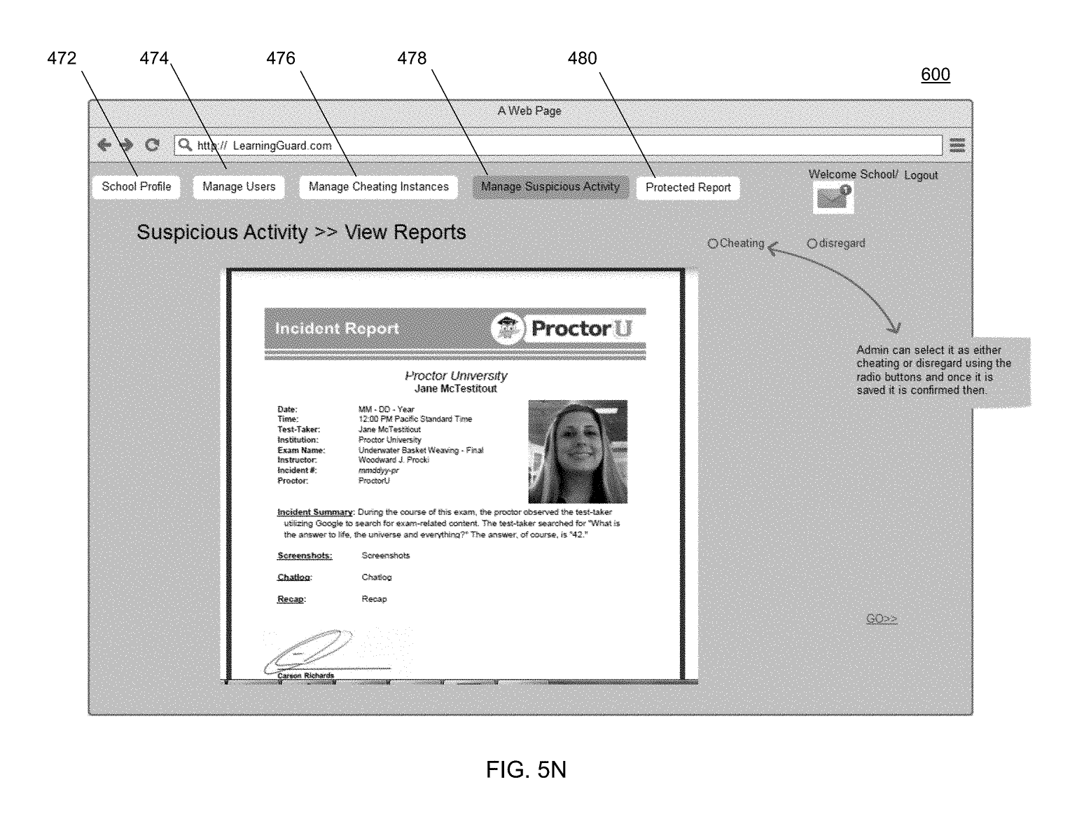

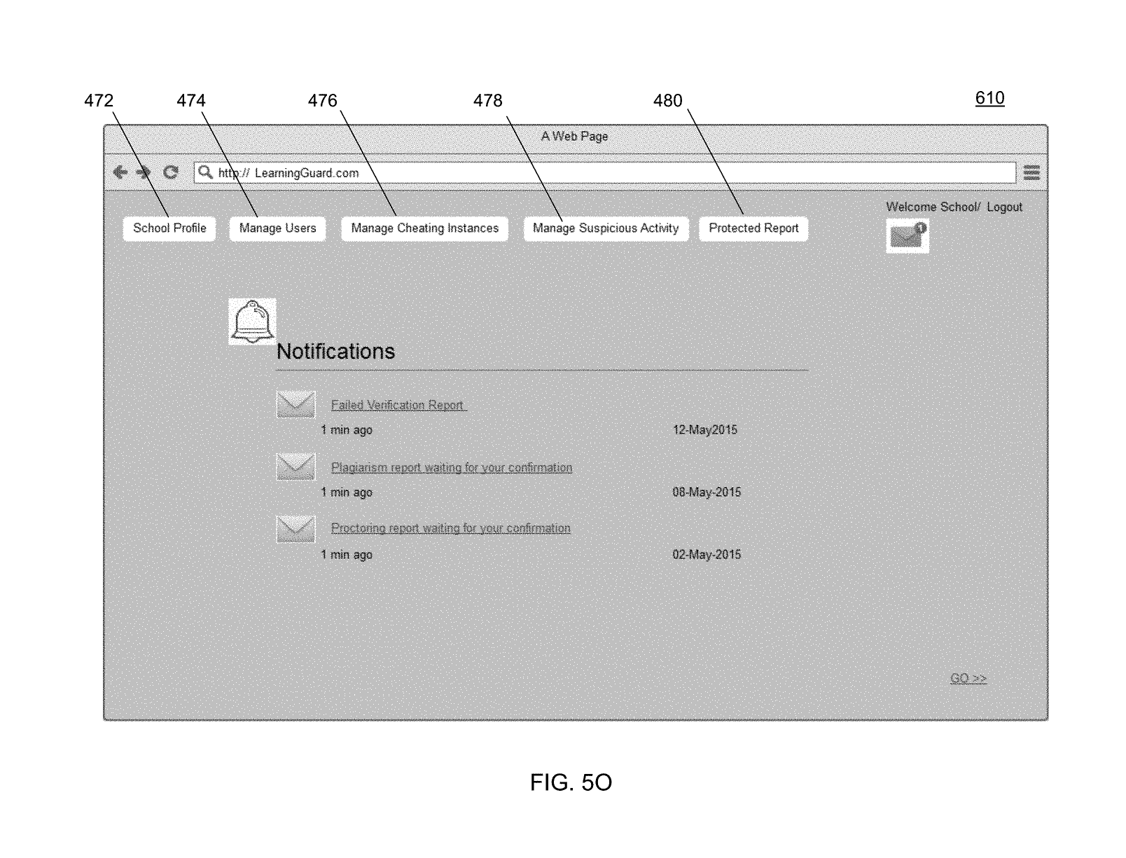

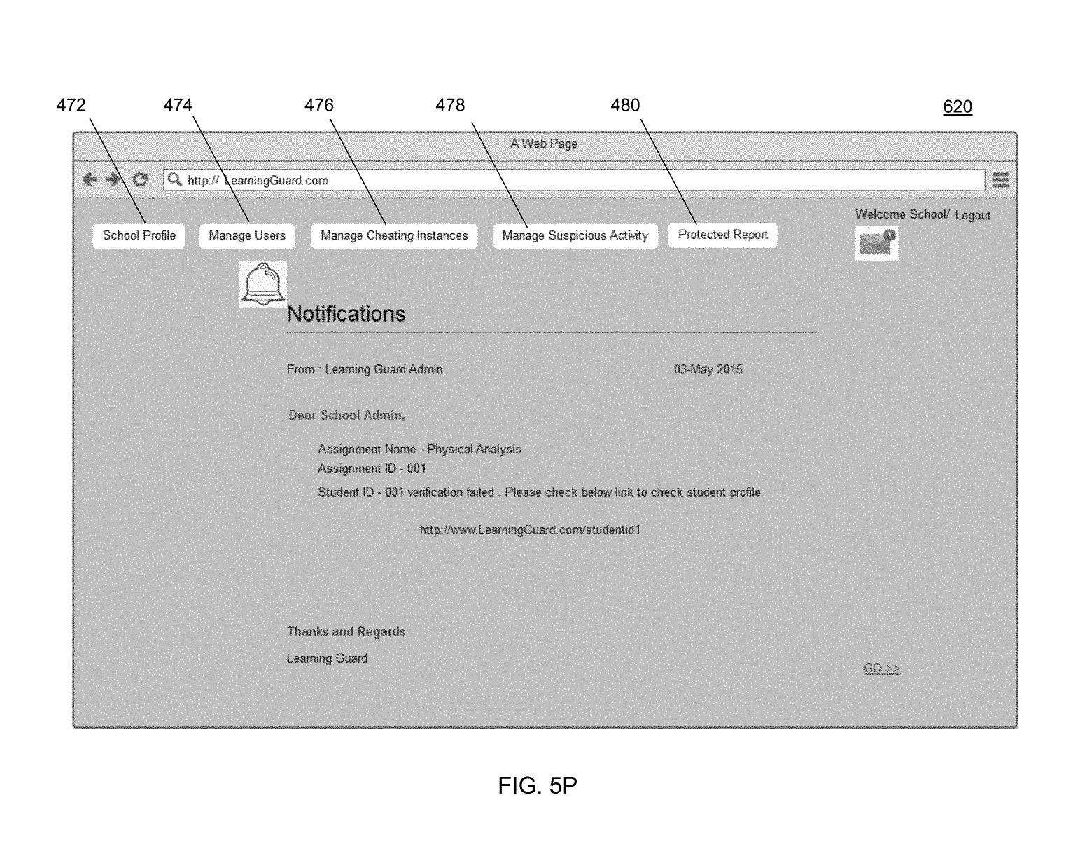

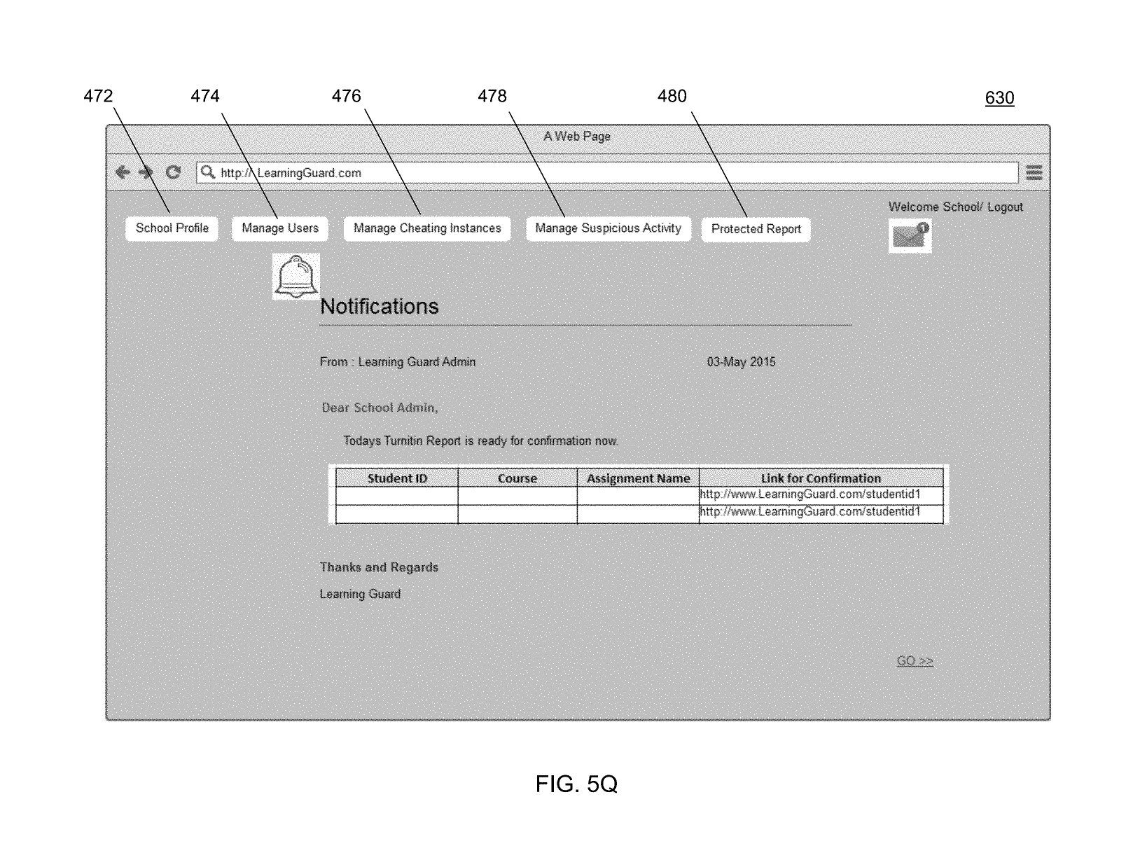

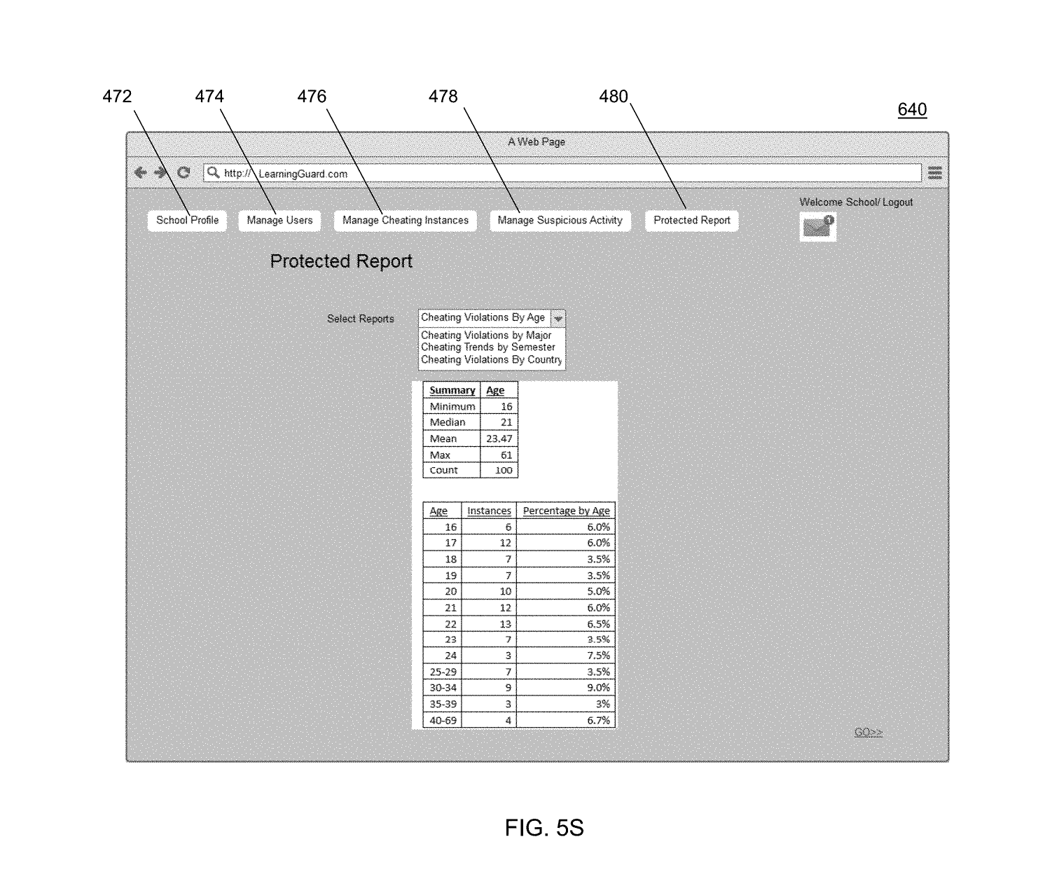

FIGS. 5A-5S are a series of screenshots for a school or organization that subscribes and uses the cheating and fraud prevention system software. As similar figures with similar functions are described above the explanations for FIGS. 5B-5S are limited. FIG. 5A is the welcome screen 460 for official or administrative staff that run schools or organizations. Clicking on the go link 62 brings up a login screen and process which is similar to that shown in FIG. 1A. Upon a successful login the school administrator is directed to the school profile page 470 of FIG. 5B. The school profile includes an identification number and an affirmation form. Links (482, 484, 486, 488) are provided to view the administrator list 490 of FIG. 5C, teachers list 500 of FIG. 5D, student list 510 as shown in FIG. 5E, and course list 520 as shown in FIG. 5F. FIG. 5G shows the assignment screen 530. FIG. 5H illustrates an uploading screen 540 to update information on the system. FIG. 5I is a manage users screen 550 that lists the users of the system. FIG. 5J illustrates an embodiment of a screen for managing instances of cheating 560. FIG. 5K may be used by an administrator as an entry screen 570 to enter an occurrence of cheating or fraud into the system. FIG. 5L is a screenshot 580 for entry of suspicious activity. FIG. 5M shows a report screen 590 which in this example is for a plagiarism program that is ported to the inventive software. FIG. 5N shows a filed incident report 600 initiated by a proctor who observed an infraction during an exam. FIGS. 5O-5Q are various notification screens (610, 620, 630) for the administrators about events in the system. FIG. 5S shows a protected report 640 screen.

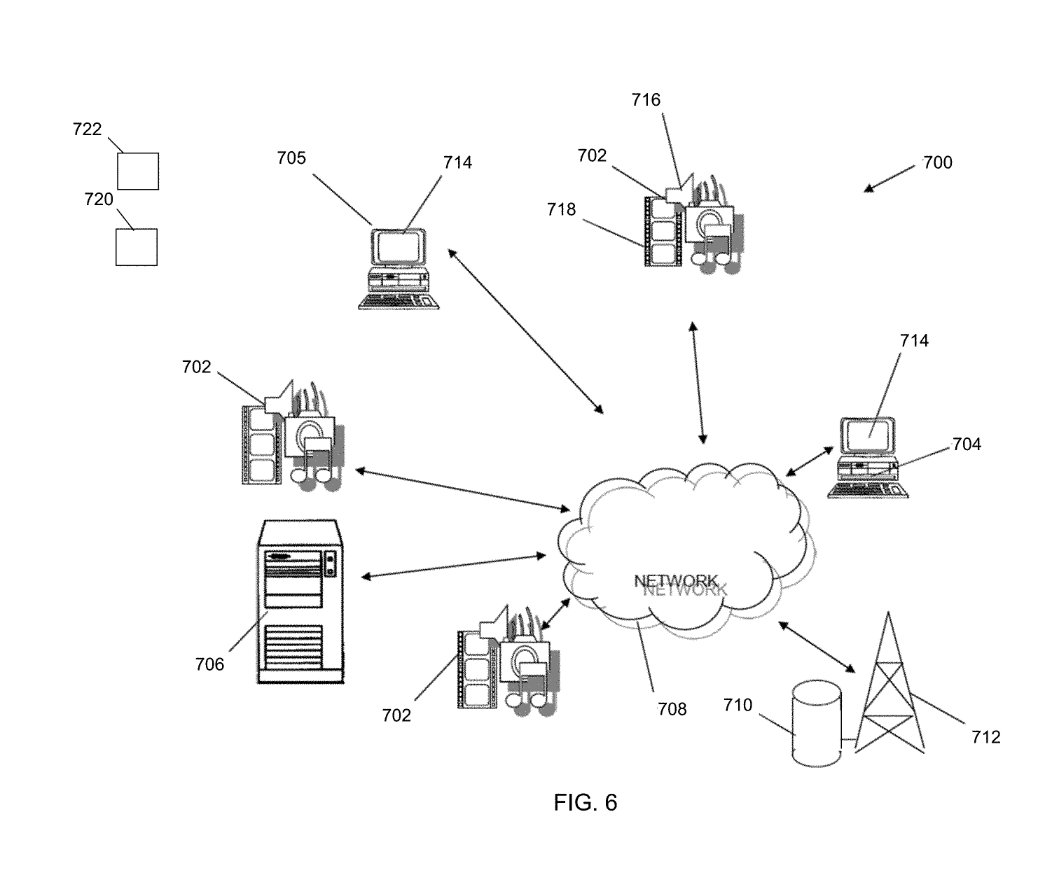

FIG. 6 is a schematic diagram illustrating an overall view of communication devices, computing devices, and mediums for implementing a system and method for cheating and fraud prevention.

The system 700 includes multimedia devices 702 and desktop computer devices 704 configured with display capabilities 714 and processors for executing instructions and commands, as well as running software. The multimedia devices 702 are optionally mobile communication and entertainment devices, such as cellular phones, tablets, laptops, and mobile computing devices that in certain embodiments are wirelessly connected to a network 708. The multimedia devices 702 typically have video displays 718 and audio outputs 716. Biometric and analysis devices 720 may also be in communication with the network 708. Biometic devices 720 illustratively may include fingerprint recognition, voice recognition, handwriting recognition, and iris scans used for user verification. Document scanners 722 may also be in contact with the network to capture printed affirmation statements and for signature verification, and for written exams and assignments. The multimedia devices 702 and desktop computer devices 704 are optionally configured with internal storage, software, and a graphical user interface (GUI) for carrying out elements of the cheating and fraud prevention system and method according to embodiments of the invention. The network 708 is optionally any type of known network including a fixed wire line network, cable and fiber optics, over the air broadcasts, local area network (LAN), wide area network (WAN), global network (e.g., Internet), intranet, etc. with data/Internet capabilities as represented by server 706. Communication aspects of the network are represented by cellular base station 710 and antenna 712. In a preferred embodiment, the network 708 is a LAN and each remote device 702 and desktop device 704 executes a user interface application (e.g., Web browser) to contact the server system 706 through the network 708. Alternatively, the remote devices 702 and 704 may be implemented using a device programmed primarily for accessing network 708 such as a remote client.

The software for the system and method for cheating and fraud prevention of embodiments of the invention may be resident on tablets 702, desktop or laptop computers 704, or stored within the server 706 or cellular base station 710 for download to an end user. Server 706 may be implemented as a cloud-based service for implementing embodiments of the platform with a multi-tenant database for storage of separate client data for each independent academic institution or organization.

### EXAMPLES

### Example 1

At a defined period of time prior to taking a scheduled examination, a student may be required to log in with their personal student id to a designated school website. On the website there may be a link with the student's upcoming test, designated by date, time, name, and the unique bar code assigned to the test. Upon clicking this link the following non limiting example of a new test affirmation will appear as follows:

### TEST AFFIRMATION

1. I am the student listed above and signing below.
2. I reside at.
3. I am a student at
4. I am taking an exam (list course).
5. I have reviewed the school's code of ethics.
6. I have reviewed the school's definition of cheating and plagiarism.
7. I know and understand that the school has a “zero tolerance” policy for cheating and plagiarizing and is against (name of school). Code of ethics.
8. I know and understand that the school uses diagnostic tools to catch cheaters.
9. I know and understand that cheating and plagiarizing are punishable by expulsion from school or other penalties.
10. I affirm that I will not cheat, plagiarize, or commit any other dishonest act while completing this examination, quiz or discussion Board.

Title of Exam

Test Bar Code:
BY AFFIXING MY SIGNATURE BELOW I AFFIRM THE TRUTH OF EVERYTHING ABOVE.

DATED: Month/Day/Year

Possibility A

Signature is verified.

The test appears with its barcode and the student's barcode.

Possibility B

Signature is not verified.

The test does appear.

A notice on the screen will appear, stating that the verification failed and the test is not available.

A notice of failed verification will be reported to school's administration.

The data is sent to a designated official.

The breach will be recorded and stored on Learning Guard's database.

The school has the ability to expunge this data from our database.

### Example 2

Embodiments of the inventive method provide a process for an academic institution or organizational user to develop a detailed cheating policy as follows:

1. The user selects cheating definitions,
2. The user modifies some cheating definitions.
3. The user adds any missing cheating definitions
4. The user rates the severity of each definition from 0 to 5
5. The user assigns A, B, C, etc. to frequency of occurrence
6. User chooses their designated punishments from the master list.
7. The user modifies some punishment definitions.
8. The user adds any missing punishments.
9. The punishments are rated with the severity level of 0-5.
10. The punishments are entered into a severity—frequency table
12. The cheating definitions and the punishment table is linked to student, teacher, school administration, and the disciplinary committee.
13. A list of considerations (mitigating factors) is made available from an external link.
14. Any punishment that is not conforming to pre-chosen alignment to severity of cheating case requires an explanation on a standard form to be entered into embodiments of the inventive system software.

The cheating definitions and the punishment table needs to be read as part of the student's affirmation at time of registration.

### Example 3

Using the process of Example 2 for an academic institution or organizational user to develop a detailed cheating policy, where the development of an exemplary policy is as follows:

A compiled list of known offences and fraudulent activities is provided as a list to the user. Embodiments of the list are dynamic in that as users of the inventive system discover and/or add new offences and fraudulent activities the list may grow. Table 1 is a example list of offences and fraudulent activities available to the user.

TABLE 1
List of offences and fraudulent activities

| | |
|---|---|
| 1. | Hiding textbooks or articles from other students. |
| 2. | Submitting papers that were previously used in another course. |
| 3. | Claiming a true disastrous event that really occurred much earlier. |
| | (Please excuse me from taking the test, -My grandmother died.) |
| 4. | Claiming a false event to be excused from a test. |
| 5. | Saving notes on phone to view during test |
| 6. | Writing notes on body parts |
| 7. | Writing notes under a hat |
| 8. | Viewing notes out of the view of the monitor's camera |
| 9. | Reading an assignment in English when it is assigned in a foreign |
| | language |
| 10. | Submitting a lab report on an assignment that was never done |
| 11. | Plagiarizing by copying phrases |
| 12. | Not citing a source |
| 13. | Plagiarizing a paper in English and having it translated in |
| | another language. |
| 14. | Using thesaurus software program that masks plagiarized paragraphs |
| 15. | Inflating bibliographies with pertinent material that wasn't read |
| 16. | Texting someone outside the class for an answer |
| 17. | Someone else writes the personal statement in an application. |
| 18. | Someone else writes the essay in an application |
| 19. | Resume padding, whereby one lists a degree that was not earned. |
| 20. | Resume padding by faking recommendations or work experience. |
| 21. | Falsely insisting that a paper was handed in |
| 22. | In collaboration assignment, having others do most of the work. |
| 23. | Erasing the name of a student in a collaborative assignment. |
| 24. | Saving notes on phone to view during test |
| 25. | Writing notes on body parts |
| 26. | Hiding notes under a hat |
| 27. | Hiding notes in a desk, computer, or lap |
| 28. | Cheating on a collaborative assignment. |
| 29. | A movie or an abridged text is used instead of reading the book |
| 30. | Collaboration on an assignment, supposed to be taken by an |
| | individual student. |
| 31. | Forging a parent or teacher's signature |
| 32. | Stealing a test from an academic office |
| 33. | Changing an answer on a test that was found in office |
| 34. | Having some office personnel change an answer |
| 35. | Hacking a professor's computer |
| 36. | Finding a test associated with a textbook |
| 37. | Having someone else take a test for them |
| 38. | Having someone else take course for them |
| 39. | Threats of blackmail or extortion of teachers or office staff |
| 40. | Offering rewards or seduction to teachers or office staff for grade |
| | changes |
| 41. | Having someone help on a home written assignment including one's |
| | parents |
| 42. | Falsifying lab data |
| 43. | Claiming falsely that they handed the assignment in. |
| 44. | Changing an answer after it was graded and claimed it was a scoring |
| | era |
| 45. | Falsifying quotations |
| 46. | Having notes outside the view of an online proctor |
| 47. | In an online proctoring test, shutting down Internet and claiming |
| | it was a lost connection |
| 48. | Having someone in the room lookup answers during an online |
| | proctoring test |
| 49. | Wireless earphones and microphones to whisper questions and |
| | answers |
| 50. | Attaching a paper as a corrupted file to have extra time to write |
| | the assignment |
| 51. | Downloading information on a cheating watch. |
| 52. | Cameo -copying answers from multiple existences online. |

The user then defines a set of severity levels to categorize the cheating cases numbered 1 through 52 as shown above, or a subset of cheating cases or fraudulent occurrences that apply to their organization. The severity levels are then assigned to the selected cheating cases or fraudulent occurrences for example as follows in table 2:

TABLE 2
Severity Level 0

| | |
|---|---|
| 4. | Claiming a false event to be excused from a test. |
| 5. | Saving notes on phone to view during test |
| 6. | Writing notes on body parts |
| 7. | Writing notes under a hat |
| 8. | Viewing notes out of the view of the monitor's camera |
| 9. | Reading an assignment in English when it is assigned in a foreign |
| | language |

Severity Level 1

| | |
|---|---|
| 13. | Plagiarizing a paper in English and having it translated in another |
| | language. |
| 14. | Using thesaurus software program that masks plagiarized paragraphs |
| 15. | Inflating bibliographies with pertinent material that wasn't read |
| 16. | Texting someone outside the class for an answer |
| 17. | Someone else writes the personal statement in an application. |
| 18. | Someone else writes the essay in an application |

Severity Level 2

| | |
|---|---|
| 22. | In collaboration assignment, having others do most of the work. |
| 23. | Erasing the name of a student in a collaborative assignment. |
| 24. | Saving notes on phone to view during test |
| 25. | Writing notes on body parts |
| 26. | Hiding notes under a hat |
| 27. | Hiding notes in a desk, computer, or lap |

Severity Level 3

| | |
|---|---|
| 31. | Collaboration on an assignment, supposed to be taken by an |
| | individual student. |
| 32. | Forging a parent or teacher's signature |
| 33. | Stealing a test from an academic office |
| 34. | Changing an answer on a test that was found in office |
| 35. | Having some office personnel change an answer |
| 36. | Hacking a professor's computer |

Severity Level 4

| | |
|---|---|
| 40. | Threats of blackmail or extortion of teachers or office staff |
| 41. | Offering rewards or seduction to teachers or office staff for |
| | grade changes |
| 42. | Having someone help on a home written assignment including one's |
| | parents |
| 43. | Falsifying lab data |
| 44. | Claiming falsely that they handed the assignment in. |
| 45. | Changing an answer after it was graded and claimed it was a |
| | scoring era |

Severity Level 5

| | |
|---|---|
| 47. | Having notes outside the view of an online proctor |
| 48. | In an online proctored test, shutting down Internet and claiming |
| | it was a lost connection |
| 49. | Having someone in the room lookup answers during an online |
| | proctoring test |
| 50. | Wireless earphones and microphones to whisper questions and |
| | answers |
| 51. | Attaching a paper as a corrupted file to have extra time to write |
| | the assignment |
| 51. | Downloading information on a cheating watch |

A list of selected cases with assigned severity and frequency of occurrences is then generated by embodiments of the inventive software as follows in table 3:

TABLE 3

| Punishment List | | User Matrix Assignment |
|---|---|---|
| 1. | Expulsion from school | C5 |
| 2. | Suspension for a certain period of time | B5 |
| 3. | Denial of a degree | A5 |
| 4. | Assignment makeup | |
| 5. | Required counseling | C4 |
| 6. | Community service | B4 |
| 7. | Warning letter in student file | A4 |
| 8. | Warning letter only to student | |
| 9. | Probation | C3 |
| 10. | Loss of privileges | B3 |
| 11. | Lowering of grade | A3 |
| 12. | Failing grade | |
| 13. | Zero on assignment | C2 |
| 14. | Honors or awards withheld | B2 |
| 15. | Withdrawal of credit | A2 |
| 16. | Revocation of degree previously awarded | |
| 17. | Loss of scholarship | C1 |
| 18. | Repayment of scholarship | B1 |
| 19. | Loss of financial aid | A1 |
| 20. | International student-revocation of visa | |
| 21. | Apology letter | C0 |
| 22. | Dismissal from school's residence | B0 |
| 23. | Educational extra assignments | A0 |

Table 4 is a matrix that ties severity to frequency that may be used as a look up table in the inventive software to determine a recommended punishment to be administered.

TABLE 4

| | First | Second | Habitual |
|---|---|---|---|
| | Offence A | Offense B | Offender C |
| Severity Level 0 | Educational extra | Dismissal from | Apology |
| | assignments | school's residence | letter |
| Severity Level 1 | Loss of financial | Repayment of | Loss of |
| | Aid | scholarship | scholarship |
| Severity Level 2 | Withdrawal of | Honors or awards | Score of zero |
| | credit | withheld | on assignment |
| Severity Level 3 | Lowering of | Loss of | Probation |
| | grade | privileges | |
| Severity Level 4 | Warning letter in | Community | Required |
| | student's file | service | counseling |
| Severity Level 5 | Denial of | Suspension for | Expulsion |
| | a degree | a week | from school |

As a person skilled in the art will recognize from the previous detailed description and from the figures and claims, modifications and changes can be made to the preferred embodiments of the invention without departing from the scope of this invention defined in the following claims.

1. A non-transitory computer-readable medium for the prevention of cheating and fraudulent activity in an institutional setting, comprising instructions stored thereon, that when executed on a processor, perform the steps of:
compiling a stored list of user inputted cheating definitions via a graphical user interface;
associating a user-defined severity rating to each of the cheating definitions;
assigning a frequency of occurrence to the cheating definitions;
compiling a stored list of user inputted punishments;
associating a user-defined severity rating to each of the punishments;
assigning a user-defined frequency rating to each of the punishments;
creating a matrix based look up table;
receiving a report of a cheating infraction;
generating a notification of the infraction and sending the notification to a subscribing official;
receiving a recommended punishment assigned by the subscribing official in response to the notification; and
comparing the recommended punishment to the matrix based look up table, when the recommended punishment does not conform to the punishment of the matrix that the severity of the cheating infraction requires, a request to the subscribing official is generated requesting an explanation of the recommended punishment on a standard form input for the prevention of cheating and fraudulent activity in the institutional setting.

2. The non-transitory computer-readable medium of claim 1 wherein the institutional setting is a university or college and the steps are ordered.

3. The non-transitory computer-readable medium of claim 1 wherein the received cheating infraction is recorded in a database with searchable variables.

4. The non-transitory computer-readable medium of claim 1 further comprising a report generator and a statistical analysis module to generate reports.

5. The non-transitory computer-readable medium of claim 4 wherein the generated reports are password protected and only available to authorized personnel.

6. The non-transitory computer-readable medium of claim 4 wherein the generated reports are FERPA (Family Educational Rights and Privacy Act) compliant and do not identify individual students.

7. The non-transitory computer-readable medium of claim 1 further comprising the steps of;
generating affirmation forms in response to receiving notification of an assignment or examination; and
sending the affirmation form to one or more individuals designated to take the examination or complete the assignment.

8. The non-transitory computer-readable medium of claim 7 wherein the one or more individual are sent the assignment or allowed to take the examination once the affirmation is completed by the one or more individuals and is received and has been verified by the non-transitory computer-readable medium.

9. The non-transitory computer-readable medium of claim 8 wherein the verifying compares a signature on the received and completed affirmation of the student to a stored signature of the student.

10. The non-transitory computer-readable medium of claim 8 wherein the verifying compares a fingerprint of the one or more individuals obtained via a fingerprint reader to a stored fingerprint.

11. The non-transitory computer-readable medium of claim 2 wherein the non-transitory computer-readable medium is Learning Tools Interoperability (LTI) compliant and interfaces to forms of the Learning Management System (LMS) and other academic integrity systems.

12. The non-transitory computer-readable medium of claim 11 wherein the non-transitory computer-readable medium interfaces with browser lock down features in a testing environment or during an assignment within the Learning Management System.

13. The non-transitory computer-readable medium of claim 1 wherein the non-transitory computer-readable medium is offered as an on-demand service in the cloud.

14. The non-transitory computer-readable medium of claim 1 wherein the non-transitory computer-readable medium generates and assigns a unique barcode to each of the one or more individuals and to each of one or more proctors.

15. The non-transitory computer-readable medium of claim 14 assigns a barcode to an assignment form or an examination form and places the unique barcode of any of the one or more individuals taking the examination and any of the one of the one or more proctors that administered the assignment or the examination.

16. The non-transitory computer-readable medium of claim 1 further comprising submission analysis of an assignment or an examination submitted by the one or more individuals.

17. A method of prevention of cheating and fraudulent activity in an institutional setting comprising: compiling a stored list of user inputted cheating definitions via a graphical user interface;
associating a user-defined severity rating to each of the cheating definitions;
assigning a frequency of occurrence to the cheating definitions;
compiling a stored list of user inputted punishments;
associating a user-defined severity rating to each of the punishments;
assigning a user-defined frequency rating to each of the punishments;
creating a matrix based look up table;
receiving a report of a cheating infraction;
generating a notification of the infraction and sending the notification to a subscribing official;
receiving a recommended punishment assigned by the subscribing official in response to the notification; and
comparing the recommended punishment to the matrix based look up table, when the recommended punishment does not conform to the punishment of the matrix that the severity of the cheating infraction requires, a request to the subscribing official is generated requesting an explanation of the recommended punishment on a standard form input.

18. The method of claim 17 further comprising a report generator and a statistical analysis module to generate reports.

19. The method of claim 17 further comprising the steps of;
generating affirmation forms in response to receiving notification of an assignment or examination; and
sending the affirmation form to one or more individuals designated to take the examination or complete the assignment.

20. The method of claim 17 further comprising submission analysis of an assignment or an examination submitted by the one or more individuals.
